(19) United States
(12) Patent Application Publication
(10) Pub. No.: US 2026/0175514 A1
(43) Pub. Date: Jun. 25, 2026

(54) Construction 3D Printer for Printing Structures Without Utilizing a Gantry and Systems Including the Same

(71) Applicant: VeruStruct, P.B.C., New Haven, CT (US)

(72) Inventors: Nicholas Paul CALLEGARI, New Haven, CT (US); Konstantinos MARKOPOULOS, New Haven, CT (US)

(21) Appl. No.: 19/541,744

(22) Filed: Feb. 17, 2026

Related U.S. Application Data
(63) Continuation-in-part of application No. 19/184,732, filed on Apr. 21, 2025.
(60) Provisional application No. 63/637,141, filed on Apr. 22, 2024.

(51) Int. Cl. B29C 64/118; B29C 64/20; B29C 64/227; B29C 64/245; B29C 64/255; B33Y 30/00; B33Y 40/00

(52) U.S. Cl. CPC B29C 64/118; B29C 64/20; B29C 64/227; B29C 64/245; B29C 64/255; B33Y 40/00; B33Y 30/00

(57) ABSTRACT

A 3D printing apparatus can include an extruder including at least one chamber in communication with a print material reservoir via at least one feed line to receive a print material from the reservoir. Each chamber can include at least one door configured to transition between a closed position and an open position. The 3D printing apparatus can be configured to print at least one layer of the print material from the at least one chamber to form a printed wall. The at least one door can be configured to be maintained in the closed position for transferring the print material from the reservoir to the at least one chamber, and the at least one door can be configured to be maintained in the open position for printing a portion of the at least one layer of the print material. The 3D printing apparatus can include a locomotion device to cause the apparatus to move along a path while printing a wall. A cornering mechanism is provided to allow the device to change direction while printing a corner of the wall.

### CROSS REFERENCE TO RELATED APPLICATIONS

This application is a Continuation-in-Part of U.S. application Ser. No. 19/184,732 filed on Apr. 21, 2025 which claims priority to U.S. Provisional Application No. 63/637,141 filed on Apr. 22, 2024, the contents of which are incorporated herein by reference in their entirety.

### FIELD

The present disclosure relates to 3D printers and, more particularly, to larger-scale 3D printers for construction applications.

### BACKGROUND

In recent years, 3D printing technology has become a field of great interest, with a variety of potential applications being explored across a variety of industries. One implementation of this technology involves printing large structures for use in residential and commercial building applications. The first 3D printers to garner widespread adoption were small-scale, extrusion-based desktop 3D printers that printed with plastic filaments, such as polylactic acid (PLA), acrylonitrile butadiene styrene (ABS), and polyethylene terephthalate (PET). As these printers were refined and the benefits became more tangible, other applications for 3D printing methods were explored, including larger-scale printing of structures. Filaments for these structures were not plastic-based but were more akin to concrete and pozzolanic in nature. These printers were modeled after the extrusion-based 3D printers, utilizing a Cartesian-XYZ-head gantry system that allowed the extruder head to move along the X-axis of the gantry while moving the upper portion of the gantry frame along the Y-axis and the entire gantry along the Z-axis.

Other variations of gantry-based construction printers have emerged with various methods of positioning the extruder via the gantry system, and even decoupling of the printer nozzle and the extruder (the extruder is disposed separate from the printer nozzle, with the printer nozzle being disposed on the gantry), but these printers are still gantry-based. Additionally, these printers also employ filament-based printhead nozzles, extruding a tubular stream of filament in layers via the gantry system, and resulting in a print with rotund features and uneven surface profiles (e.g., not a flat surface for finished walls of the printed structure). In these printers, accessory components necessary for the printed structure, including electrical harnessing, plumbing, HVAC ducting, insulation foam, fenestration items such as doors, windows, etc., need to be installed after the print is completed, with additional measures being necessary to appropriately hide many of these components for safety and aesthetic considerations.

### SUMMARY

In one general aspect, a 3D printing apparatus includes an extruder including at least one form chamber in communication with a print material reservoir via at least one feed line to receive a print material from the reservoir. Each chamber among the at least one chamber can include at least one door configured to transition between a closed position and an open position. The 3D printing apparatus can be configured to print at least one layer of the print material from the at least one chamber to form a printed wall. The at least one door can be configured to be maintained in the closed position for transferring the print material from the reservoir to the at least one chamber. The at least one door can be configured to be maintained in the open position for printing a portion of the at least one layer of the print material.

In some embodiments, the 3D printing apparatus can further include at least one translational mechanism configured to translate at least the extruder along a printing path to print the at least one layer of the print material in sections along the printing path.

In some embodiments, the 3D printing apparatus can be further configured to continuously print the at least one layer of the print material as the at least one translational mechanism translates the at least one extruder along the printing path.

In some embodiments, the at least one layer of the print material can include multiple layers of the print material that are vertically stacked one on top of another.

In some embodiments, the 3D printing apparatus can further include a lift mechanism configured to vertically lift at least the extruder to print a subsequent layer among the multiple layers of the print material on a previously printed layer among the multiple layers of the print material.

In some embodiments, the at least one layer of print material can include multiple layers of print material. The extruder can further include a wall channel embossment configured to form a wall channel in each layer of the multiple layers of the print material, the wall channel extending in a direction of the printing path. The 3D printing apparatus can be further configured to: insert the at least one translational mechanism in the wall channel of a previously printed layer among the multiple layers of the print material; and move within the wall channel of the previously printed layer when printing, on the previously printed layer, a current layer among the multiple layers of the print material.

In some embodiments, the 3D printing apparatus can further include a lift assembly configured to vertically lift the at least one translational mechanism and insert the at least one translational mechanism in the wall channel of the previously printed layer.

In some embodiments, the 3D printing apparatus can further include at least one armature configured to route any one or more of electrical harnessing, flexible plumbing, conduit, and associated hardware within the wall channel.

In some embodiments, the previously printed layer can be disposed two or more layers below the current layer.

In some embodiments, the 3D printing apparatus can further include at least one armature or truss device configured to stabilize the printer during the printing of the current layer, wherein the at least one armature is configured to follow a profile of the printed wall formed and correct an orientation of the printing apparatus based on signals from one or more on-board sensors.

In some embodiments, the 3D printing apparatus can be further configured to have sections of the chambers extend past the length of a singular printed layer, allowing for orientation of the printing apparatus based on moment reactions from the chamber walls on the previously disposed layer.

In some embodiments, the at least one translational mechanism can be further configured to move at least the extruder along a ground surface when printing a ground layer among the at least one layer of the print material.

In some embodiments, the at least one translational mechanism can include at least one set of wheels.

In some embodiments, the 3D printing apparatus can further include a curing device configured to cure at least a portion of the print material within the at least one chamber.

In some embodiments, the curing device can be further configured to at least partially cure the at least a portion of the print material while printing the at least one layer of the print material.

In some embodiments, the curing device can include any one or any combination of any two or more of a UV curing device, a dehydration or drying device, a pressurizing device, and a chemical insertion device configured to harden the print material within the at least one chamber.

In some embodiments, the 3D printing apparatus can further include any one or any combination of any two or more vibration mechanisms, including pivotal rotational and oscillating devices and lineal vertical and uniform devices, operating, e.g., via eccentric rotating mass motors, piezoelectric actuators, or other mechanical transmission devices to agitate and help the material disposed within the form chambers settle.

In some embodiments, the 3D printing apparatus can further include any one or any combination of any two or more pressure application mechanisms, including pneumatic, hydraulic, or mechanical systems to translate force over an area within the form chambers to compress the disposed material within the chambers.

In some embodiments, the 3D printing apparatus can further include at least one tension rod installation mechanism configured to install at least one vertically extending tension rod member in the at least one layer of the print material or in the cavity formed between at least two sections of the printed material disposed from two separate chambers.

In some embodiments, the 3D printing apparatus can further include at least one tension rod installation mechanism configured to place a vertically extending tension rod member in an uncured portion of the print material being filled in the at least one chamber. The at least one tension rod installation mechanism can include either one of an armature mechanism and an insertion mechanism including a gear assembly and a threaded rod driven by the gear assembly.

In some embodiments, the vertically extending tension rod member can be disposed in one layer among the at least one layer of the print material. The at least one armature mechanism can be further configured to interlock the vertically extending tension rod member with another vertically extending tension rod member disposed in another layer, among the at least one layer of the print material, that is below the one layer.

In some embodiments, the 3D printing apparatus can further include at least one tension rod installation mechanism. The at least one tension rod installation mechanism can include: a drilling mechanism configured to drill a vertically extending hole through the at least one layer of material; an armature mechanism configured to insert a vertically extending tension rod member in the vertically extending hole; and a filling mechanism configured to fill a space around the vertically extending tension rod member in the vertically extending hole with a filler material to set the vertically extending tension rod member in the vertically extending hole.

In some embodiments, the 3D printing apparatus can be configured to translate at least the extruder along a printing path to print the at least one layer of the print material in sections along the printing path. The at least one door can include a front door and a rear door. When in the closed position, the front and rear doors can create a sealed volume that prevents leakage of the print material outside of the chamber when the chamber is in communication with a ground surface or a previously printed layer beneath the chamber, among the at least one layer. The front and rear doors can be configured to open at an angle sufficient to allow the 3D printing apparatus to move along the previously printed layer without the previously printed layer contacting the front and rear doors. The 3D printing apparatus can be further configured to maintain the front and rear doors in the closed position during printing initiation for a given layer, among the at least one layer of the print material. The 3D printing apparatus can be further configured to open the rear door when the at least one extruder starts translating and printing the at least one layer along the printing path in a forward direction, and to maintain the rear door in the open position while printing the at least one layer along the printing path in the forward direction.

In some embodiments, the 3D printing apparatus can be further configured to open the front door when the at least one extruder starts translating and printing the at least one layer along the printing path in a rearward direction, and to maintain the front door in the open position while printing the at least one layer along the printing path in the rearward direction.

In some embodiments, the at least one chamber can include at least one inner chamber and at least one outer chamber laterally spaced apart from the at least one inner chamber. The 3D printing apparatus can be further configured to print at least one laterally inner wall layer, in the at least one layer of the print material, from the at least one inner chamber. The 3D printing apparatus can be further configured to print at least one laterally outer wall layer, in the at least one layer of the print material, from the at least one outer chamber. The at least one laterally outer wall layer can be laterally spaced apart from the at least one laterally inner wall layer. The at least one laterally inner wall layer can form an inner wall and the at least one laterally outer wall layer can form an outer wall.

In some embodiments, the at least one chamber can further include at least one middle chamber disposed between and laterally spaced apart from the at least one inner chamber and the at least one outer chamber. The 3D printing apparatus can be further configured to print at least one laterally central wall layer, in the at least one layer of the print material, from the at least one middle chamber. The central wall layer can be disposed between and laterally spaced apart from the laterally inner wall layer and the laterally outer wall layer. The at least one laterally central wall layer can form a central wall.

In some embodiments, the 3D printing apparatus can further include an insulation installation mechanism configured to spray, pump, or mechanically insert an insulation material within a space formed between the inner wall and the outer wall.

In some embodiments, the 3D printing apparatus can further include at least one tension rod installation mechanism configured to install a horizontal tension rod member between a section of the at least one inner wall layer and a section of the at least one outer wall layer.

In some embodiments, the at least one tension rod installation mechanism can include an armature mechanism configured to install the horizontal tension rod member between an uncured portion of the print material formed by the at least one inner chamber and an uncured portion of the print material formed by the at least one outer chamber.

In some embodiments, the at least one tension rod installation mechanism can include an armature mechanism configured to install a horizontal tension rod member between a partially cured section of the at least one inner wall layer and a partially cured section of the at least one outer wall layer while the extruder is moving along a path to print a next section of the at least one inner wall layer and a next section of the at least one outer wall layer.

In some embodiments, the at least one chamber can include flexible chamber walls formed of at least a shape-memory material, a silicone material, or an elastomer material, and the 3D printing apparatus can further include a chamber shaping device configured to shape the flexible chamber walls to radius a section of the at least one layer of print material.

In some embodiments, the chamber shaping device can include any one or more of a heating device configured to heat the flexible chamber walls, a cooling device configured to cool the flexible chamber walls, and an electromagnetic device configured to apply an electromagnetic field to the flexible chamber walls.

In some embodiments, the 3D printing apparatus can further include shaping arm members and any one of pneumatic actuators, hydraulic actuators, and electric actuators configured to actuate the shaping arm members to apply mechanical pressure to bend a section of the at least one layer of print material to a specified radius.

In some embodiments, the 3D printing apparatus can further include a routing assembly configured to route the print material to the at least one chamber and control a flow rate of the print material to the at least one chamber.

In some embodiments, the 3D printing apparatus can further include at least one controller configured to control the receipt of the print material from the reservoir, the printing of the at least one layer of the print material, the transitioning of the door between the closed position and the open position.

In some embodiments, the 3D printing apparatus can further include a power supply configured to supply power to the extruder, wherein the power supply is configured to be recharged via connection to either one or both of an AC current supply and photovoltaic cells.

In some embodiments, the 3D printing apparatus can further include: at least one sensor configured to sense a quality of the print material; and at least one controller configured to control the printing of the at least one layer based on the sensed quality of the print material.

In some embodiments, the 3D printing apparatus can further include: at least one sensor configured to sense the position of the 3D printing apparatus in space; and at least one controller configured to control the printing dynamics of the at least one layer and the position of the 3D printing apparatus based on the sensed position.

In other embodiments, the a translational slipform device for three-dimensional (3D) printing of a structure comprises an extruder comprising at least one chamber for receiving a print material, a material supply in communication with the at least one chamber via at least one feed line, a translational mechanism configured to translate the extruder along a printing path, an outer formwork structure defining an outer perimeter of a wall section to be printed, an inner formwork structure coupled to the rigid outer formwork structure, the inner formwork structure being configured to move relative to the outer formwork structure between a proximal state, wherein the inner framework structure defines a cross section of a wall element in combination with the outer formwork structure, and a remote state for creating clearance between the inner formwork structure and the cross section of a wall element and a plurality of internal doors disposed within the at least one chamber, each internal door configured to transition between an engaged position to direct a flow of the print material and a disengaged position to permit unobstructed flow of the print material.

In some implementations, the inner formwork structure comprises at least one set of inner formwork structures extending in an X-orientation and at least one set of inner formwork structures extending in a Y-orientation, each set of inner formwork structures being movable between the proximal state and the remote states and wherein the device is configured to selectively activate the plurality of internal doors to define at least two distinct channels for the print material within the at least one chamber, thereby defining at least two wythes as wall elements of the structure when 3D printing is accomplished.

Other features and aspects will be apparent from the following detailed description, the drawings, and the claims.

### BRIEF DESCRIPTION OF THE DRAWINGS

FIG. 1 depicts a printing system including a 3D printing apparatus for printing a structure formed of a print material, a material supply for supplying the print material to the 3D printing apparatus, and a feed line connecting the material supply to the 3D printing apparatus.

FIG. 2 depicts a profile view of the 3D printing apparatus of FIG. 1, illustrating a dual-section extruder configuration, with an outer extruder section and inner extruder section respectively printing sections of an inner wall and an outer wall of the structure in parallel, according to an embodiment.

FIG. 3 depicts a profile view of the 3D printing apparatus of FIG. 1, with wheels of a wheel articulator apparatus disposed on a ground surface, according to an embodiment.

FIG. 4 depicts cross-sections of the 3D printing apparatus of FIG. 1, showing a print material flow routing assembly configured to selectively route print material to each of front and rear extruder chambers, according to an embodiment.

FIGS. 5A and 5B depict profile views of the 3D printing apparatus of FIG. 1, illustrating internal volumes of the extruder chambers, according to an embodiment.

FIG. 6 depicts a cross-section of two volumes in an extruder chamber, according to an embodiment.

FIGS. 7A to 7E depict a process for extruder chamber actuation during forward-direction printing operations, including first-layer printing, according to an embodiment.

FIG. 8 depicts an accessory routing mechanism including armatures for routing accessory components within a wall channel, according to an embodiment.

FIGS. 9A and 9B depict accessory component clamps for clamping a routed accessory component in a wall channel, according to embodiments.

FIG. 10 depicts a printing system including the 3D printing apparatus and the material supply of FIG. 1, a spool holding one or more routed accessory components, and a main feed line connecting the material supply to the 3D printing apparatus and configured to feed the one or more routed accessory components to the 3D printing apparatus, according to an embodiment.

FIGS. 11 and 12 depict profile views of triple-section extruders, according to embodiments.

FIG. 13 depicts a configuration of the 3D printing apparatus of FIG. 1 in which a wheel articulator apparatus includes six total wheel articulators each having a respective set of wheels that are attached thereto and disposed in the wall channels of previously printed layers of the inner and outer walls to print current layers of the inner and outer walls, according to an embodiment.

FIG. 14A to and 14B depict a process for moving the 3D printing apparatus of FIG. 1 upward to print respective next layers on top of most recently printed layers of the inner and outer walls using the wheel articulator apparatus, according to an embodiment.

FIGS. 15A and 15B depict profile views of a wheel articulator apparatus including eight wheel articulators, according to an embodiment.

FIGS. 16A and 16B depict profile views of a wheel articulator apparatus including four wheel articulators, according to an embodiment.

FIG. 17 depicts a profile view of a fenestration being printed, with limiting dimensional parameters of the 3D printer apparatus of FIG. 1 labeled to show a relationship between these dimensional parameters and a size of a fenestration to be included in a printed wall, according to an embodiment.

FIG. 18 depicts example curved walls, along with limiting extruder chamber parameters to illustrate the relationship between the extruder chamber parameters and a radius of wall sections, according to an embodiment.

FIGS. 19-47 depict a process of printing corners of first and second walls, according to an embodiment.

FIG. 48 depicts a base plate and the wheel articulators, and movement vectors for the base plate and the wheel articulator bases, according to an embodiment.

FIG. 49 depicts a profile view of a 3D printing system configured to form flexible vertical tension rods in a printed structure, according to an embodiment.

FIG. 50 depicts an example process flow for a method of inserting a flexible vertical tension rod into a wall of a printed structure, according to an embodiment.

FIG. 51 depicts an example process flow for a method of inserting a flexible vertical tension rod that does not require insertion of substrate into a drilled interstitial volume, according to an embodiment.

FIGS. 52A and 52B depict a rigid vertical tension rod formed of rigid vertical tension rod segments connected by interlocking elements, according to an embodiment.

FIG. 53 depicts a tension rod sorting and funneling mechanism, according to an embodiment.

FIG. 54 depicts a cross-section view of a method for inserting a rigid vertical tension rod segment into an uncured layer of a wall and interlocking the inserted rigid vertical tension rod segment with another rigid vertical tension rod segment below, according to an embodiment.

FIG. 55 depicts rigid horizontal tension rods being inserted into an outer wall and an inner wall of a structure, according to an embodiment.

FIG. 56 depicts a profile view of a 3D printing apparatus including a power supply, according to an embodiment.

FIG. 57 is a profile view of a printing system including two alternative locations for a power supply for a 3D printing apparatus, according to embodiments.

FIG. 58 depicts a printing system including a 3D printing apparatus configured to print windows in addition to a main structural body of a structure, a window material mixing chamber, and a window material feed line, according to an embodiment.

FIG. 59 depicts a partial view of a printing assembly of the printing apparatus of FIG. 58, illustrating structural filament extruder chambers and dedicated window extruder chambers, according to an embodiment.

FIGS. 60A and 60B depict an extruder chamber and an angle adjustment mechanism configured to adjust an angle of incline of sidewalls of the extruder chamber with respect to a vertical direction, according to an embodiment.

FIG. 61A depicts a profile view of a door of the extruder chamber of FIGS. 60A and 60B in open and closed position, when the side walls of the extruder chamber are substantially vertical.

FIG. 61B depicts a profile view of the door of the extruder chamber of FIGS. 60A and 60B in open position and a closed position, when the sidewalls of the extruder chamber are inclined with respect to the vertical direction.

FIG. 62 depicts a profile view of an extruder chamber having flexible sidewalls formed of a shape-memory material, and a chamber shaping device configured to shape the flexible sidewalls.

FIG. 63 depicts a view of wall bending or shaping device for bending or shaping a layer of a print structure, according to an embodiment.

FIGS. 64A to 64H depict a printing assembly of a 3D printing apparatus printing a corner portion of a structure, according to an embodiment.

FIG. 65A schematically depicts an embodiment of a 3D printing apparatus,

FIGS. 65B-65H schematically depict various stages of operation of the apparatus depicted in FIG. 65A,

FIGS. 66A and 66B are schematic drawings depicting controllers in communication with various mechanisms and components of a 3D printing apparatus, according to an embodiment.

FIG. 67A is a perspective view of a 3D printing apparatus in accordance with another disclosed implementation.

FIG. 67B is a top view of the 3D printing apparatus shown in FIG. 67A

FIG. 68A is a partial view of a chamber defined by a form in accordance with disclosed implementations.

FIG. 68B is a cross sectional view of a form in an engaged/printing position.

FIG. 68C is a cross-sectional view of a form in a disengaged position.

FIG. 68D is a cross sectional view of a pair of two layer wythes printed in accordance with disclosed implementations.

FIG. 69 is a schematic diagram of a 2D printer in accordance with disclosed implementations showing a specific printing state.

FIG. 70 is a schematic diagram of a 2D printer in accordance with disclosed implementations showing a specific printing state.

FIG. 71 is a schematic diagram of a 2D printer in accordance with disclosed implementations showing a specific printing state.

FIG. 72 is a schematic diagram of a 2D printer in accordance with disclosed implementations showing a specific printing state.

FIG. 73 is a schematic diagram of a 2D printer in accordance with disclosed implementations showing a specific printing state.

FIG. 74 is a schematic diagram of a 2D printer in accordance with disclosed implementations showing a specific printing state.

FIG. 75 illustrates a wheel arrangement in accordance with disclosed implementations.

FIG. 76A illustrates a cantilever track extension mechanism, in a retracted position, for printing fenestrations in accordance with disclosed implementations.

FIG. 76B illustrates a cantilever track extension mechanism, in an extended position, for printing fenestrations in accordance with disclosed implementations.

FIG. 77 illustrates a movable mass mechanism for changing the center of mass of a printer in accordance with disclosed implementations.

FIG. 78 illustrates use of a filler material for printing fenestrations in accordance with disclosed implementations.

FIG. 79 78 illustrates another example of use of a filler material for printing fenestrations in accordance with disclosed implementations.

FIG. 80 illustrates a mechanism for providing changeable forms in accordance with disclosed implementations.

### DETAILED DESCRIPTION

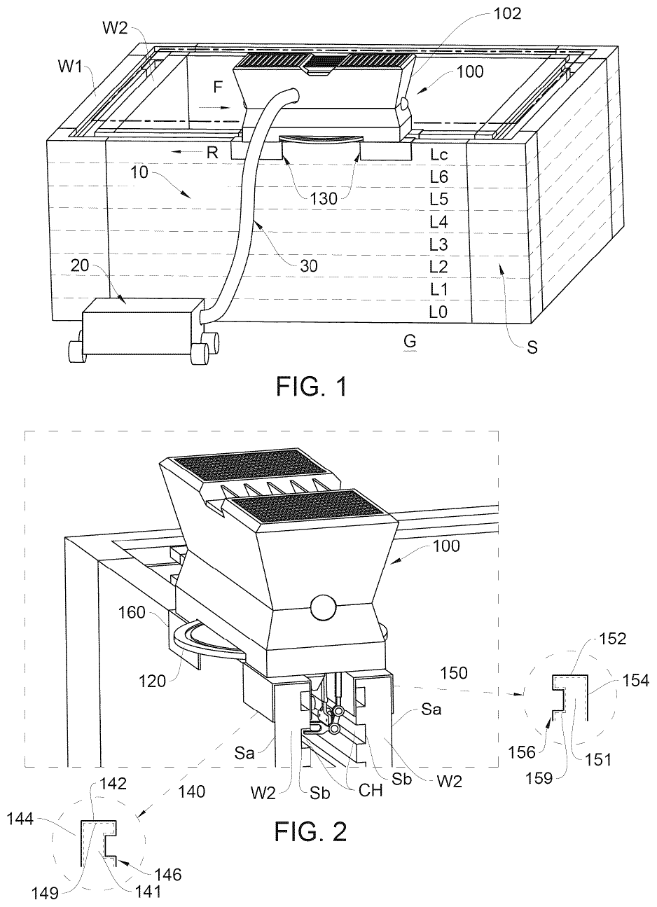

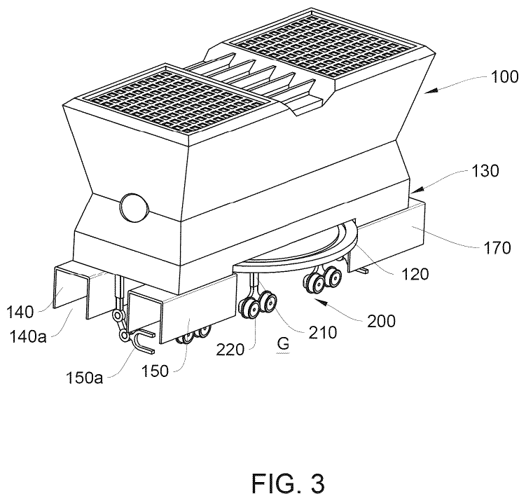

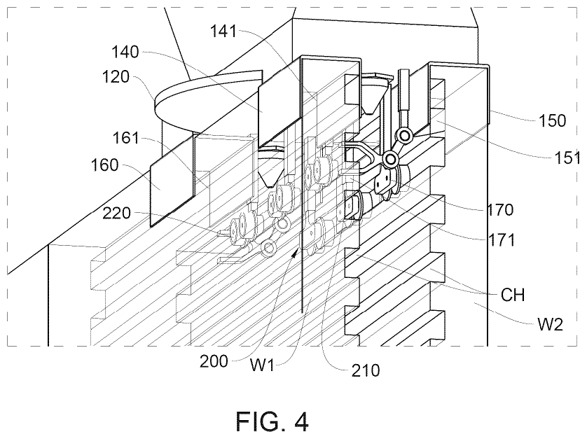

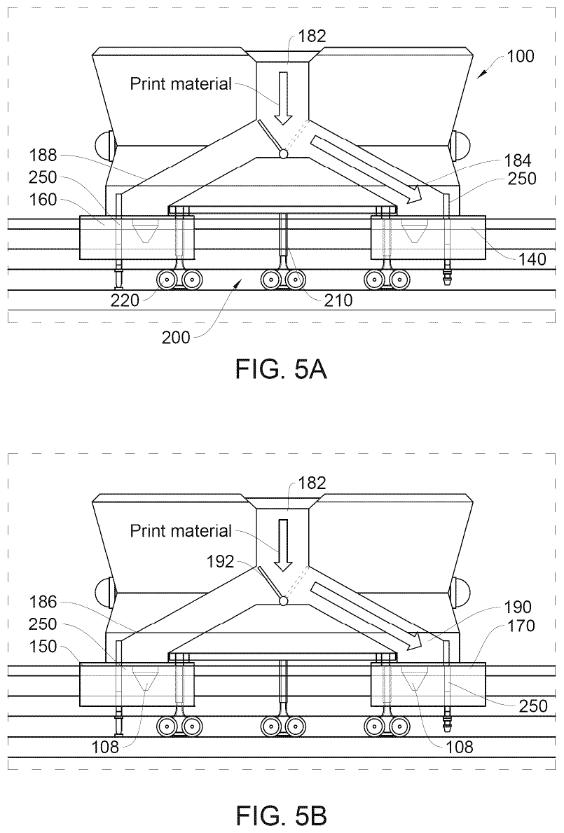

FIG. 1 depicts a printing system 10 including a 3D printing apparatus 100 for printing a structure S formed of a print material, a material supply 20 for supplying the print material to the 3D printing apparatus 100, and a feed line 30 connecting the material supply 20 to the 3D printing apparatus 100. FIG. 2 depicts a profile view of the 3D printing apparatus 100, illustrating a dual-section extruder configuration, with an outer extruder section E1 and an inner extruder section E2 respectively printing sections of an outer wall W1 and an inner wall W2 of the structure S in parallel, according to an embodiment. FIG. 3 depicts a profile view of the 3D printing apparatus 100, with wheels of a wheel articulator apparatus 200 disposed on a ground surface G, according to an embodiment. FIG. 4 depicts cross-sections of the 3D printing apparatus 100, showing a print material flow routing assembly (“routing assembly”) 110 configured to selectively route print material from the feed line 30 to an outer front extruder chamber 140, an inner front extruder chamber 150, an outer rear extruder chamber 160, and an inner rear extruder chamber 170. FIG. 5 depicts a profile view of the 3D printing apparatus 100, illustrating internal volumes 148, 158, 168, and 178 of the extruder chambers 140, 150, 160, and 170, according to an embodiment.

Referring to FIG. 1, the material supply 20 includes a reservoir storing a volume of the print material (e.g., structural filament). The print material can be, for example, a concrete material or a pozzolanic material, which may include a variety of admixtures, including water-reducing admixtures, accelerating admixtures, retarding admixtures, air-entraining admixtures, superplasticizers, binding admixtures, and other admixtures, and a variety of aggregates, including calcined clay, limestone, basalt rock, sand, crushed rocks of various forms, olivine sand, and other granular materials. However, the print material is not limited to these materials and can be, for example, plastic materials, such as polylactic acid (PLA), acrylonitrile butadiene styrene (ABS), and polyethylene terephthalate (PET), hemp plant materials, soil and earth-based materials, steel and iron dust deposit waste materials, mycelium mushroom materials, epoxy resin materials, wax materials, and clay materials including natural clays, oil-based clays, epoxy clays, and polymer clays. In some embodiments, as illustrated in FIG. 1, the material supply 20 can be a follower cart configured to follow the 3D printing apparatus 100, by rolling or otherwise translating along the ground surface G, as the 3D printing apparatus 100 moves to print the structure S. However, the material supply 20 is not limited to a follower cart. In some embodiments, the material supply 20 can be a stationary device, and in other embodiments, the material supply 20 can be mounted on or incorporated in the 3D printing apparatus 100.

The material supply 20 can include a pump configured to pump the print material to the 3D printing apparatus 100 through the feed line 30. Alternatively, the material supply 20 can be positioned at a higher elevation than the 3D printing apparatus 100 and can be configured to flow the print material to the 3D printing apparatus 100 through the feed line 30 by a gravity feed.

As shown in FIGS. 1-3, 5A, and 5B, the 3D printing apparatus (“printing apparatus”) 100 includes a housing 102 having an internal volume, and to which the extruder 130 is attached. Referring to FIGS. 1-6, the extruder 130 is configured to receive the print material from the material supply 20/feed line 30 and print the print material to form the structure S. In the example illustrated in FIG. 1, the structure S includes the outer wall W1 and the inner wall W2 extending substantially parallel to each other. Each wall W1, W2 can be formed of multiple layers L0-Lc of print material. The layers L0 to Lc are stacked vertically in sequence, with a next layer among the layers L0 to Lc being formed on top of a previously printed layer among the layers L0 to Lc. L0 is a first, or ground layer, and Lc is a top, or current layer.

In the example illustrated in FIGS. 1 and 2, the walls W1, W2 are laterally spaced apart and each extends along a rectangular path corresponding to a printing path P of the extruder 130/printing apparatus 100, and thus forms the structure S to have a substantially rectangular perimeter shape. As will be described later in more detail, the extruder 130 can be mounted on a rotatable base plate 120, as shown in FIG. 2, to enable the extruder 130 to rotate with respect to the housing 102 for printing corner regions of the walls W1, W2. Although the example walls W1, W2 and structure S are formed in a rectangular pattern, the apparatus 100 is not limited to forming walls and structures of any particular shape. For example, the apparatus 100 can print walls and structures along a circular or oval path, or a path having serpentine or stepped sections. Printing of various wall/structure shapes are facilitated by the extruder 130 being rotatably mounted on the base plate 120.

Although FIG. 1 shows each wall W1, W2 including eight layers or printed material, any number of layers is possible. Further, in FIG. 1, L0 is a ground layer printed directly on a ground surface. However, in some embodiments, the first layer L0 can be printed on top of a base or a platform that is supported on the ground surface G.

As shown in FIG. 1, the extruder 130 can be configured to move along the printing path P in a forward direction F or a rearward direction R, driven by a translational mechanism, to print each layer L0 to Lc, one layer at a time, and can print a layer of each wall W1, W2 in a same operation (e.g., at approximately the same time). That is, as will be described later in more detail, the extruder 130 can print one layer of the print material, among the layers layer L0 to Lc, of each wall W1, W2 and, after completing the one layer, the extruder 130 can rise up and print a subsequent layer, among the layers layer L0 to Lc, of each wall W1, W2 on top of the previously printed one layer. A more specific description of the extruder 130 is provided below with reference to FIGS. 2 to 5B.

Referring to FIGS. 2 to 5B, the extruder 130 can include the outer front extruder chamber 140, the inner front extruder chamber 150, the outer rear extruder chamber 160, and the inner rear extruder chamber 170. The outer front extruder chamber 140 and the outer rear extruder chamber 160 are included in the outer extruder section E1 and are configured to print the layers L0 to Lc of the outer wall W1. The inner front extruder chamber 150 and the inner rear extruder chamber 170 are included in the inner extruder section E2 and are configured to print the layers L0 to Lc of the inner wall W2. The outer front extruder chamber 140 and the outer rear extruder chamber 160 are laterally spaced apart from the inner front extruder chamber 150 and the inner rear extruder chamber 170. The extruder chambers 140, 150, 160, 170 receive the print material from the material supply 20/feed line 30 and form a respective section of a layer (e.g., one of layers L0 to Lc) of the respective wall W1, W2 in an inner volume 141, 151, 161, 171 (see FIG. 4) of each extruder chamber 140, 150, 160, 170. After one or more extruder chambers 140, 150, 160, 170 print the respective section(s) of a layer of the respective wall W1, W2, the extruder 130/printing apparatus 100 can move a predetermined distance along the path P.

Each extruder chamber 140, 150, 160, 170 can be configured to print a respective section of a layer of the respective wall W1, W2 having a shape corresponding to the shape of the respective inner volume 141, 151, 161, 171. In the illustrated embodiments, the inner volumes 141, 151, 161, 171 have a generally rectangular prism shape, and thus the printed sections also have a generally rectangular prism shape. FIG. 2 shows example configurations of the outer front extruder chamber 140 and the inner front extruder chamber 150. As shown in FIG. 2, the outer front extruder chamber 140 includes a top wall 142, an outer side wall 144, and an inner side wall 146 that define the inner volume 141. Similarly, the inner front extruder chamber 150 includes a top wall 152, an outer side wall 154, and an inner side wall 156 that define the inner volume 151. The outer front extruder chamber 140 has an open bottom 140a and the inner front extruder chamber 150 has an open bottom 150a. The inner side walls 146, 156 can have an inwardly projecting embossment or protrusion 147, 157. The embossment or protrusion forms a rectangular wall channel section in each printed section that, in combination with the wall channel sections of a remainder of the printed sections in a layer of the respective wall W1, W2, forms a continuous rectangular-shaped wall channel CH in the inner side surface SB of the layer of the respective wall W1, W2 (see FIGS. 2 and 4-5B). As will be described later in more detail, the wall channel CH can be engaged by the translational mechanism of the extruder 130/printing apparatus 100 to support the extruder 130/3D printing apparatus 100 while the extruder 130/printing apparatus 100 moves along the path P and prints a subsequent layer of each wall W1, W2 on top of the layer including the wall channel CH that is engaged by the translational mechanism. The outer side surface SA of the layer of each wall W1, W2 can be substantially flat.

Although the embodiments of FIGS. 2 and 4-5B are shown and described as providing wall channels CH in the inner side surfaces SB of the layers of the walls W1, W2, the extruder chambers 140, 150, 160, 170 can be configured in any number of ways to provide different configurations of the wall channels CH. For example, the extruder chambers 140, 150, 160, 170 can be configured to form the wall channels on the outer side surfaces SA of the walls W1, W2 in addition to or instead of the inner side surfaces SB. Additionally or alternatively, the extruder chambers 140, 150, 160, 170 can be configured to form decorative features on the outer side surfaces SA.

While FIG. 2 only illustrates the detailed configurations of the outer front extruder chamber 140 and the inner front extruder chamber 150, it is to be understood that the outer rear extruder chamber 160 and the inner rear extruder chamber 170 can have the same or similar configurations.

The extruder chambers 140, 150, 160, 170 can selectively and repeatedly print respective sections of a layer (e.g., one of layers LO to Lc) as the extruder 130/printing apparatus 100 moves along the path P in increments, until the layer is completed. In some embodiments, the 3D printing apparatus can partially or fully cure printed sections of a layer before moving itself/the extruder 130 to print subsequent sections. FIG. 2 illustrates curing devices 149, 159 installed in the outer front and inner front extruder chambers 140, 150. The curing devices 149, 159 can be substantially flat devices shaped to conform to the inner surfaces of the outer front and inner front extruder chambers 140, 150, respectively, and thus can form part of the structure for shaping the sections of printed material. For example, the curing devices 149, 159 can be UV curing devices, dehydration or drying devices, pressurizing devices, and chemical insertion devices.

As shown in FIGS. 5A and 5B, the printing apparatus 100 can include a print material routing assembly 180 configured to selectively route the print material to the extruder chambers 140, 150, 160, 170 and control a flow rate of the print material to the extruder chambers 140, 150, 160, 170. The material routing assembly 180 includes an inlet path 182 configured to receive the print material from the feed line 30, a first extruder feed path 184 configured to flow the print material to the outer front extruder 140, a second extruder feed path 186 configured to flow the print material to the inner front extruder 140, a third extruder feed path 188 configured to flow the print material to the outer rear extruder 160, and a fourth extruder feed path 190 configured to flow the print material to the inner rear extruder chamber 170. The print material routing assembly 180 can further include a flow control apparatus 192 configured to selectively place the inlet path 182 in communication with any one or more of the first, second, third, and fourth extruder feed paths 184, 186, 188, thereby controlling which one(s) of the first, second, third, and fourth extruders 140, 150, 160, 170 print a section of a layer of print material in a respective wall W1, W2. The flow control apparatus 192 can include a multi-way valve or door, or multiple valves or doors. Operation of the flow control apparatus 192 to determine one or more specific extruder chambers 140, 150, 160, 170 to print a respective section of a layer of print material can be based on desired configuration of a portion of the layer.

While the embodiment of FIGS. 5A and 5B includes four extruder feed paths, any number of extruder feed paths can be provided, and the number of extruder feed paths can correspond to the number of extruder chambers such that each extruder feed path is in communication with a respective extruder chamber.

The inner front extruder chamber 150, the outer rear extruder chamber 160, and the outer rear extruder chamber 170 can each be configured to selectively receive the print material from the material supply 20/feed line 30 and form (e.g., print) respective sections of the respective wall (the outer wall W1 or the inner wall W2).

The structure S can be a large-scale structure, such as a portion of a residential or commercial building. However, the structure S can be any type of structure, including a small-scale structure. In the example of FIG. 1, the structure S is a double-wall rectangular structure. However, a structure printed by the printing system 10 is not limited to such a rectangular structure. Any shape is possible for the printed structure, including circular structures, oval structures, and other structures with non-linear wall shapes.

Referring to FIGS. 1-5, the 3D printing apparatus 100 can include the routing assembly 110, which is configured to receive the print material from the material supply 20, and an extruder 130 including the outer front extruder chamber 140, the inner front extruder chamber 150, the outer front extruder chamber 160, and the outer rear extruder chamber 170, each of which is in communication with the reservoir via the feed line 30 to receive the print material from the material supply 20.

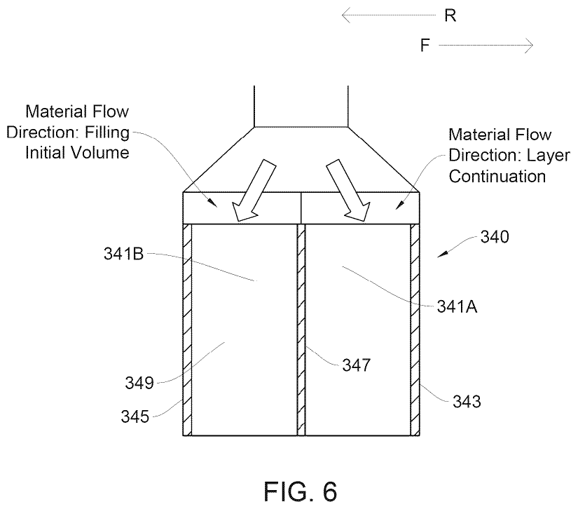

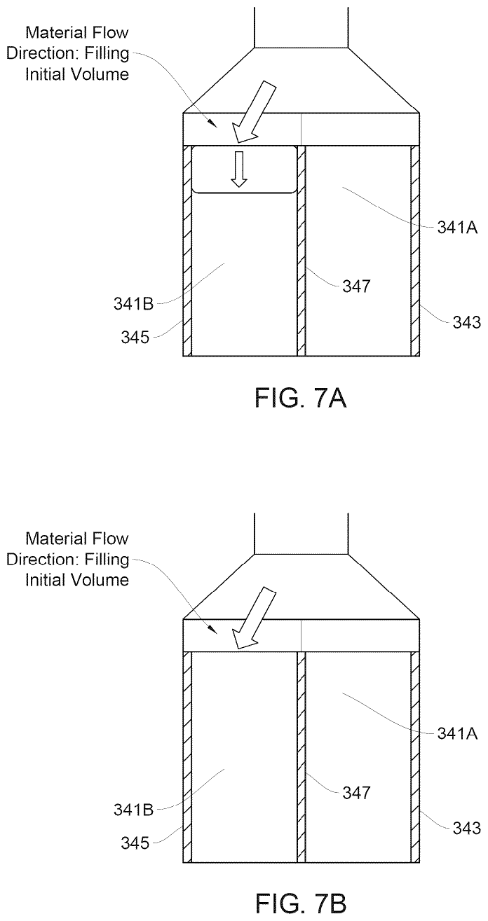

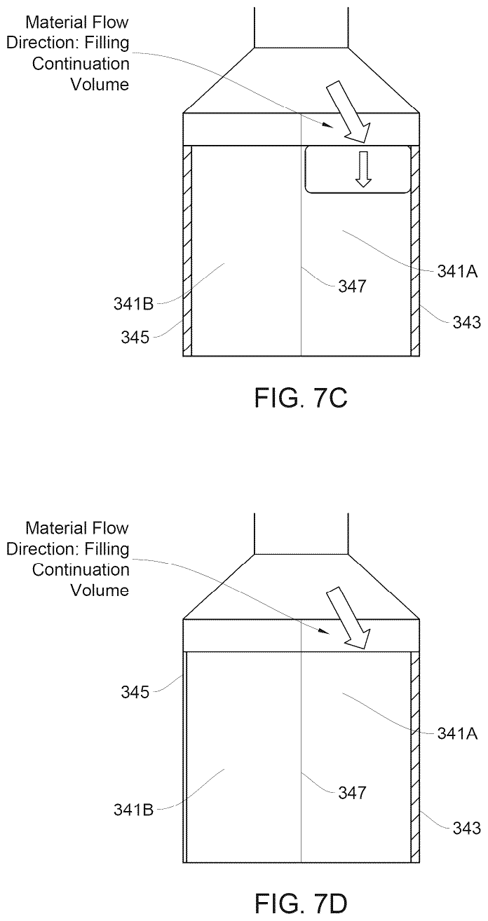

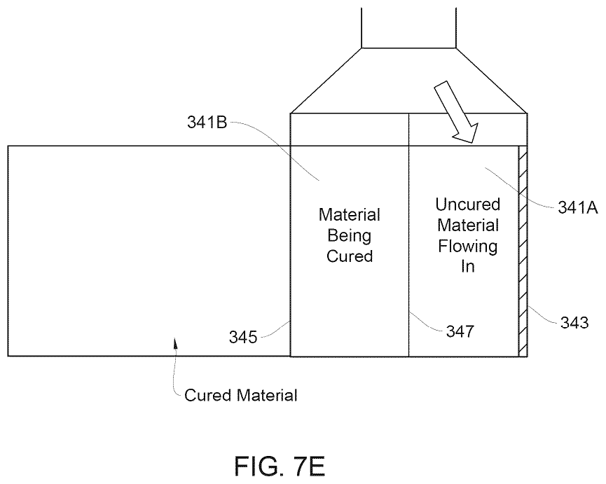

FIG. 6 depicts a cross-section of two volumes in an extruder chamber 340, according to an embodiment. The extruder chamber 340 is configured for printing a layer of a wall (e.g., the outer wall W1 or the inner wall W2), with the extruder (e.g., the extruder 130) moving in increments in the forward direction F (“forward-direction printing”). The extruder chamber 340 may correspond to any of the extruder chambers 140, 150, 160, 170 previously described herein. Referring to FIG. 6, the extruder chamber 340 can include a first door 343 disposed at one end of the extruder chamber 340, a second door 345 disposed at another end of the extruder chamber 340 opposite the one end of the extruder chamber 340, and a third, inner door 347 disposed in a middle region of the inner volume of the extruder chamber 340. In FIG. 6, the front door 343, the rear door 345, and the inner door 347 are illustrated in a closed position. As will be described later in more detail with respect to FIGS. 7A-7E, each of the doors 343, 345, 347 can be selectively configured in an open position or the closed position (e.g., by actuation of a motorized assembly to slide or pivot the doors 343, 345, 347 open or closed).

The interior volume of the extruder chamber 340 includes a first sub-volume 341A and a second sub-volume 341B that are disposed adjacent to each other in the forward direction F and the rearward direction R. The third door 347, when closed as shown in FIG. 6, separates the first sub-volume 341A and the second sub-volume 341B from each other. When the extruder is performing forward direction printing, the first door 343 is a front door, the second door 345 is a rear door, the first sub-volume 341A is a front sub-volume, and the second sub-volume 341B is a rear sub-volume. At least the rear sub-volume 341B includes a curing device 349 therein that conforms to a shape of the inner surface of the extruder chamber 340 and is configured to cure print material in the rear sub-volume 341B. The curing device 349 can be similar to the curing devices 149, 159 described above with respect to FIG. 2.

Still referring to FIG. 6, the rear sub-volume 341B can be a new layer print volume that is filled with a first flow of the print material. The curing device 349 can at least partially cure the print material in the rear sub-volume 341B to form a section of cured print material. The front sub-volume 341A can be a layer continuation print volume that is filled with a second flow of the print material. After the section of at least partially cured print material is formed or during curing of the print material in the rear sub-volume 341B, the front sub-volume 341A can be filled with the second flow of the print material to form a section of uncured print material adjacent to the section of cured material, which can be cured by the curing device 349 as the extruder chamber 340 moves forward and the rear sub-volume 341B passes over the section of uncured material. An example process of printing a layer in a forward-direction printing operation will be described below with respect to FIGS. 7A-7E.

FIGS. 7A-7E depict a process for actuation of the extruder chamber 340 during forward-direction printing, including first-layer printing, according to an embodiment. Referring to FIGS. 7A and 7B, when the printing apparatus (e.g., the 3D printing apparatus 100) begins printing a layer of a wall or other part of a structure, the extruder chamber 340 is configured such that all three doors 343, 345, 347 are in the closed position. First, the rear sub-volume 341B can be filled with a first flow of the print material, thereby printing a section of print material (e.g., forming a rectangular prism with a wall channel CH formed on the inside surface thereof). This section of print material can be at least partially cured by the curing device 349.

As shown in FIGS. 7C and 7D, once the section of print material is printed and at least partially cured, the inner door 347 can be moved to the open position and the front sub-volume 341A can be filled with uncured print material to print a section of uncured print material adjacent to and in front of the at least partially cured section of print material, and the rear door 345 can be moved to the open position, exposing a flat, finished rear face of the at least partially cured section of print material, and thus allowing the extruder chamber 340 to begin printing the rest of the layer. Thereafter, as shown in FIG. 7E, the extruder chamber 340 can continue printing the rest of the layer by moving in the forward direction F by a distance substantially equal to a length of the at least partially cured section of print material, such that rear sub-volume 341B at least partially cures the uncured print material previously printed in the front sub-volume 341A as the front sub-volume 341A is again filled with uncured print material to print a next section of uncured print material. The extruder chamber 340 can repeat this process to complete printing of the layer.

For printing a layer in a reverse printing process in which the extruder is to move in the rearward direction R, the configurations and actuations of the front sub-volume 341A and the rear sub-volume 341B can be swapped. Additionally, for a reverse printing process, the rear door 345 can operate according to the described operation of the front door 343 in the forward printing process. It is noted that, the operations of FIGS. 7A-7E described above apply when the extruder chamber 340 is configured as a front extruder chamber in the printing apparatus such as the printing apparatus 100 of FIGS. 1 to 5B, However, when the extruder chamber 340 is configured as a rear extruder chamber, both the front door 343 and the rear door 345 must be in the open position to permit movement of the extruder chamber 340 in the forward direction F or the rearward direction R.

Additionally, in some embodiments, the inner door 347 can be omitted from the extruder chamber 340 and the curing device can be disposed substantially throughout the inner volume of the extruder chamber 340. In such embodiments, the extruder chamber 340 can print a section of print material by filling the entire inner volume of the extruder chamber 340 with uncured print material and at least partially curing the printed section of print material, before moving forward or rearward by a distance substantially equal to a length of the at least partially cured section of print material. When the printing apparatus is moving in the forward direction, the rearward door is open, allowing disposed material to pass through, while the forward door is closed, creating a cavity within the chamber. This cavity is filled with uncured material that is then cured partially or fully as the printer continues to move forward. For rearward direction printing, the flow of the material is redirected towards the rear door, the forward door remains open, and the cavity is filled with uncured material as the printing apparatus moves in the rearward direction, where the uncured material is then partially or completely cured as the printer translates in the rearward direction.

Referring back to FIGS. 3-5B, the extruder 130/printing apparatus 100 includes a translational mechanism for supporting the extruder 130/printing apparatus 100 on the ground surface or previously printed layers of the walls W1, W2. As shown in FIGS. 3-5B, the translational mechanism can include a wheel articulator apparatus 200 including a plurality of wheel articulators 210 (e.g., legs) and a set of motorized wheels 220 attached to each wheel articulator 210. Each set of motorized wheels 220 can include one or more motorized wheels.

Referring to FIG. 3, when the extruder 130 is printing the first layers L0 (FIG. 1) of the walls W1, W2 of the structure S on the ground surface G, the wheel articulators 210 are configured such that the sets of wheels 220 support the extruder 130/printing apparatus 100 on the ground for translational (e.g., rolling) movement on the ground surface G along the printing path P. As will be described later in more detail, in some embodiments, the wheel articulators 210 can also be configured such that the sets of wheels 220 support the extruder 130/printing apparatus 100 on the ground surface G when the extruder 130 is printing the second layers L1 (FIG. 1) of the walls W1, W2.

Referring to FIGS. 4-5B, when the extruder 130 is printing layers (e.g., second or higher layers in some embodiments, or third or higher layers in some embodiments) of the walls W1, W2 on top of respective one or more previously printed layers, the wheel articulators 210 can be configured such that the sets of wheels 220 engage the wall channel CH of the one or more previously printed layers. Thus, the wheel articulators 210 and sets of wheels 220 support the extruder 130/printing apparatus 100 in the wall channel CH of one of the previously printed layers in each wall W1 and the sets of wheels 220 can roll in the respective wall channel CH to enable the extruder 130/printing apparatus 100 to roll along the printing path P.

Additionally, as shown in FIGS. 5A and 5B, the translational mechanism can include one or more armature devices or truss devices 250 configured to stabilize the extruder 130/printing apparatus 100 during the printing of a current layer. The armature devices or the truss devices 250 can be configured to follow profiles of respective printed portions of the walls W1, W2 and correct an orientation extruder 130/printing apparatus 100 based on signals from one or more on-board sensors.

While this disclosure provides specific examples of a translational mechanism including the wheel articulators 210 and the sets of wheels 220, the disclosure is not limited to these examples. In some implementations, a translational mechanism for the printing apparatus can include roller-driven rotating belts, instead of the sets of wheels 220, that are connected to articulating legs and configured to be inserted in the wall channels CH or engage the ground surface G. In some embodiments, instead of including the wheel articulators 210 and the sets of wheels 220, a translational mechanism can include a plurality of articulating legs having feet that are configured to be inserted in the wall channels CH or engage the ground surface G. In such embodiments, the articulating legs and the feet can be configured to move in walking motions to enable the printing apparatus to “walk” along the printing path P.

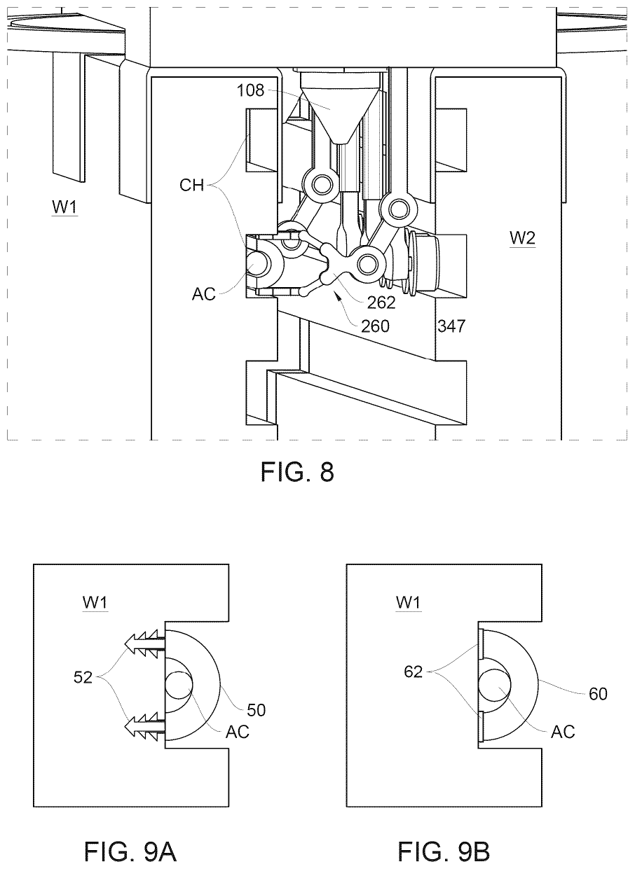

FIG. 8 depicts an accessory routing mechanism 260 including armatures 262 for routing accessory components AC within a wall channel CH, according to an embodiment. FIGS. 9A and 9B depict accessory component clamps 50 and 60 for clamping a routed accessory component AC in a wall channel CH, according to embodiments.

Referring to FIG. 8, the accessory routing mechanism 260 can be configured to receive the one or more routed accessory components AC that are fed into the housing 102 of the printing apparatus 100. The armatures 262 can be motorized and can be in the form of clamp arms. The armatures 262 can be configured to grip the routed accessory components and insert the routed accessory components AC into a wall channel CH in a wall W1 or W2. Thus, the wall channels CH can function to provide efficient and tidy installation of the routed accessory components AC in the structure S.

Referring to FIGS. 9A and 9B, the armature 262 can secure the routed accessory components AC in the wall channel CH by attaching a barbed clamp 50 or a an adhesively attachable clamp 60 to the wall W1/W2. The armature 262 can be operated to wrap the barbed clamp 50 around a portion of the routed accessory components AC and insert barbs 52 on the ends of the barbed clamp 50 into the wall W1/W2. Alternatively, the armature 262 can be operated to wrap the adhesively attachable clamp 60 around a portion of the routed accessory components AC and attach adhesive portions 62 on the ends of the adhesively attached clamp 60 to the wall W1/W2. Alternatively, the armature 262 can be operated to insert conduit directly into the uncured or partially cured substrate, which will then be cured via the printer or over time via natural processes related to the material being utilized, to hold the conduit in place. Alternative embodiments have armatures 262 outfitted with pressurized, either hydraulically or pneumatically, devices that either insert staples, clamps or the conduit itself directly into the uncured or partially cured disposed material.

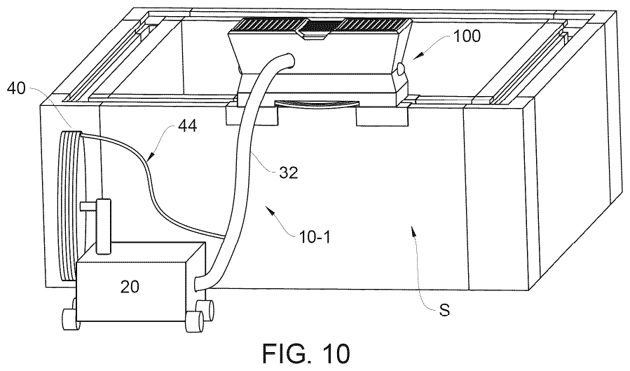

FIG. 10 depicts a printing system 10-1 including the printing apparatus 100, the material supply 20, a spool 40 holding one or more routed accessory components AC, and a main feed line 32 connecting the material supply 20 to the 3D printing apparatus 100 and configured to feed the one or more routed accessory components AC to the 3D printing apparatus 100. In the system of FIG. 10, the spool 40 can supply the accessory mounted components AC to the accessory routing mechanism 260 through a routed components feed line 44 that feeds the accessory mounted components AC through the main feed line 32.

In some embodiments, the printing apparatus 100 can be configured to install insulation material in the structure S. In some implementations, the printing apparatus 100 can include an insulation installation mechanism 108 configured to spray, pump, or mechanically insert an insulation material within a space formed between the inner wall W1 and the outer wall W2. The insulation material can include insulation foam or sheets of insulation fiber. For example, referring to FIGS. 5A, 5B, and 8, the insulation installation mechanism 108 can include at least one nozzle connected to a pressure source (e.g., a pump, a blower, or a pressurized vessel) and configured to spray or pump insulation foam within the space formed between the inner wall W1 and the outer wall W2. In other implementations, an insulation installation mechanism can include one or more armatures configured to carry insulation material and place the insulation material in the space between the inner wall W1 and the outer wall W2.

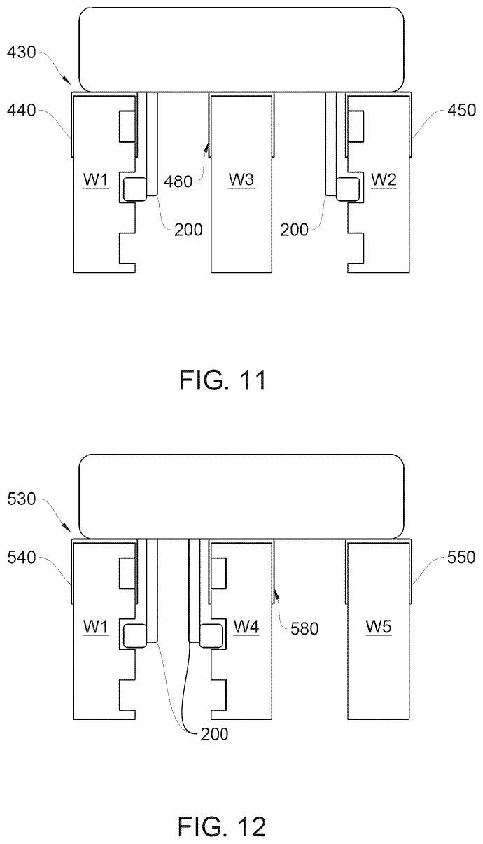

3D printing apparatuses according to the disclosure herein are not limited to an extruder including two extruder sections for printing two walls as in the embodiment of FIG. 1. Any number of extruder sections and extruder chambers are possible, and extruder chambers can be configured to print layers and walls configured differently than those previously described. FIGS. 11 and 12, described below, depict additional embodiments to provide only a few examples of additional extruder and wall configurations that are possible from the inventive concepts disclosed herein.

FIG. 11 depicts a profile view of a triple-section extruder 430, according to an embodiment. The extruder 430 includes one or more outer extruder chambers 440 and one or more inner extruder chambers 450 configured to print the outer wall W1 and the inner walls W2, respectively, including the wall channels CH for the wheel articulator apparatus 200. The extruder 430 further includes one or more middle extruder chambers 480 configured to print a middle wall W3, which is a structural reinforcement wall lacking the wall channels CH, between the outer wall W1 and the inner wall W2.

FIG. 12 depicts a profile view of a triple-section extruder 530, according to an embodiment. The extruder 530 includes one or more outer extruder chambers 540 configured to print the outer wall W1 including the wall channels CH for the wheel articulator apparatus, one or more middle extruder chambers 580 configured to print a middle wall W4 including the wall channels CH for the wheel articulator apparatus 200, and one or more inner extruder chambers 550 configured to print an inner wall W5, which is an aesthetic wall lacking the wall channels CH.

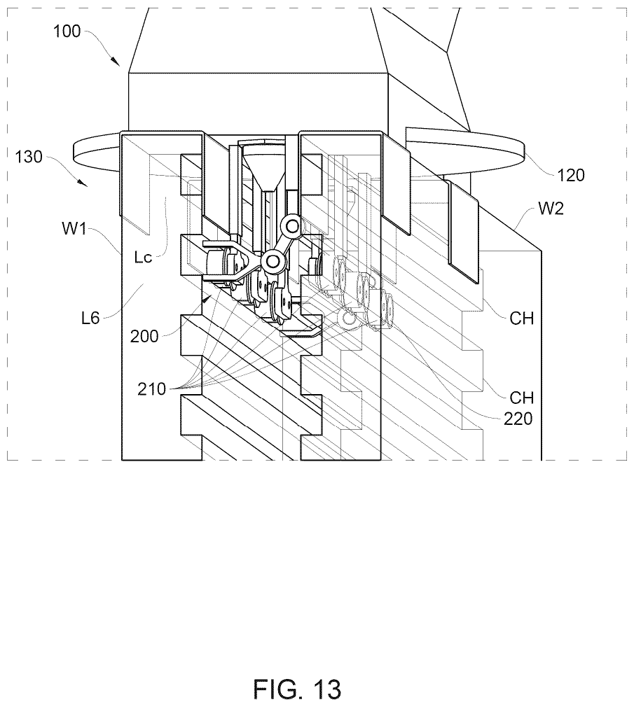

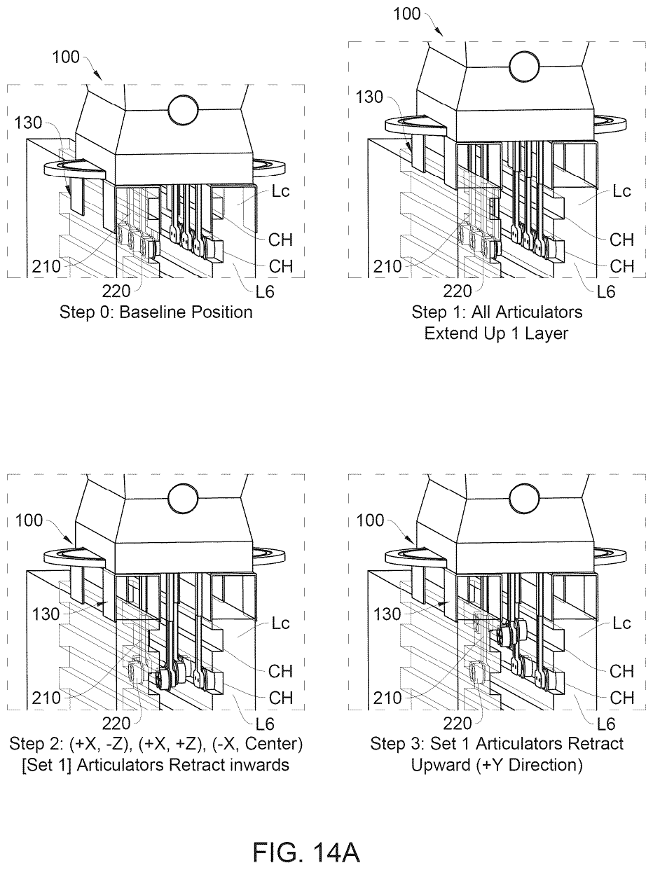

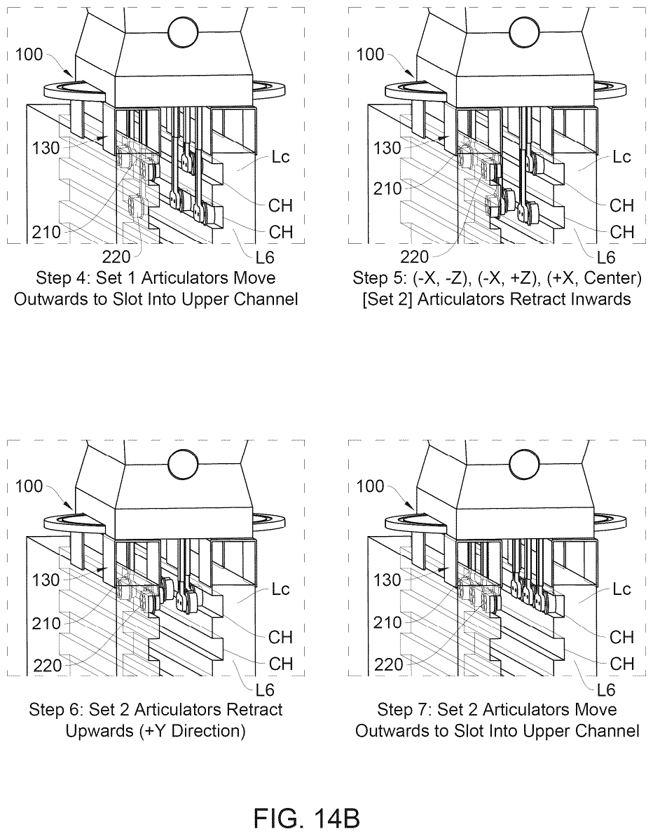

FIG. 13 depicts a configuration of the printing apparatus 100 in which the wheel articulator apparatus 200 includes six total wheel articulators 210 having respective sets of wheels 220 that are attached thereto and disposed in the wall channels of previously printed layers of the inner and outer walls W1, W2 to print current layers of the inner and outer walls W1, W2. FIGS. 14A and 14B depict a process for moving the printing apparatus 100 upward to print respective next layers on top of most recently printed layers of the inner and outer walls W1, W2 using the wheel articulator apparatus 200, according to an embodiment.

Referring to FIG. 13, when the printing apparatus 100 is printing current layers of the walls W1, W2, the printing apparatus 100 is configured to maintain the sets of wheels 220 of the wheel articulators 210 inserted in the wall channels CH of respective previously printed layers (“previously printed wall channels”) of the walls W1, W2, and move the sets of wheels 220 within these previously printed wall channels CH as previously described. When the current layers are first layers L0 (see FIG. 1) printed on the ground surface, the printing apparatus 100 is configured to maintain the sets of wheels 220 of the wheel articulators 210 engaged with the ground surface, and move the sets of wheels on the ground surface G. By way of example only, FIG. 13 illustrates an example in which the current layers are layers Lc and the sets of wheels 220 are inserted into the wall channels CH of previously printed layers L6, which are the most recently printed layers. The process described below with respect to FIGS. 14A and 14B can generally apply to other layers of the walls W1, W2.

When the printing apparatus 100 has completed printing the current layers Lc, the current layers Lc become previously printed layers, and more specifically, the most recently printed layers. The printing apparatus 100 can prepare to print next layers on top of the most recently printed layers Lc. An example process for preparing to print the next layers is depicted in FIGS. 14A and 14B, which are described below.

The wheel articulator apparatus 200 can include a lift mechanism configured to move the printing apparatus 100 as illustrated in FIGS. 14A and 14B to print the next layers. More specifically, the lift mechanism can include an assembly of motorized actuators configured to selectively move any one or more of the wheel articulators 210 vertically (e.g., up and down), laterally (e.g., inward and outward), and longitudinally (e.g., forward and backward). Additionally, although it is not necessary for movement of the printing apparatus 100 to print a next layer on top of a most recently printed layer, the lift mechanism can selectively rotate any one or more of the wheel articulators 210 about their longitudinal axes (e.g., parallel to a vertical axis). The wheel articulators 210 can be selectively moved in these directions individually, collectively in groups including only selected groups of the wheel articulators 210, and collectively all together. FIG. 48 illustrates an example of movement vectors for the wheel articulators 210.

Referring to FIG. 14A, when the printing apparatus 100 has finished printing the most recently printed layer Lc, the three wheel articulators 210 on a first side of the printing apparatus 100 are positioned such that all of the sets of wheels 220 attached to these wheel articulators 210 are positioned in the wall channel CH of the previously printed layer L6 of the first wall W1, and the three wheel articulators 210 on a second side of the printing apparatus 100 are positioned such that all of the sets of wheels 220 attached to these wheel articulators 210 are positioned in the wall channel CH of the previously printed layer L6 of the second wall W2. Next, in Step 1 of FIG. 14A, the lift mechanism can extend all of the wheel articulators 210 upward by a distance approximately equal to the height of one layer to move the extruder 130 upward to a proper height for printing a next layer of each wall W1, W2.

Next, in Step 2 of FIG. 14A, the lift mechanism can move a first set of the wheel articulators 210 laterally inward such that the sets of wheels 220 attached to the first set of the wheel articulators 210 are removed from the wall channel CH of the previously printed layer L6 of the first wall W1. In some embodiments, the first set of the wheel articulators 210 can include, for example, the left, front wheel articulator 210, the left, rear wheel articulator 210, and the right middle wheel articulator 210.

Then, in Step 3 of FIG. 14A, the lift mechanism can retract the first set of wheel articulators 210 upward. Referring to FIG. 14B, in Step 4, the lift mechanism can then move the first set of the wheel articulators 210 laterally outward such that the sets of wheels 220 attached to the first set of the wheel articulators 210 are inserted into the wall channel CH of the most recently printed layer Lc of the first wall W1.

Thereafter, in Step 5 of FIG. 14B, the lift mechanism can move a second set of wheel articulators 210 laterally inward such that the sets of wheels 220 attached to the second set of the wheel articulators 210 are removed from the wall channel CH of the previously printed layer L6 of the second wall W2. In some embodiments, the second set of the wheel articulators 210 can include, for example, the right, rear wheel articulator 210, the right, front wheel articulator 210, and the left middle wheel articulator 210.

Next, in Step 6 of FIG. 14B, the lift mechanism can retract the second set of wheel articulators 210 upward. Then, in step 7 of FIG. 14B, the lift mechanism can move the second set of the wheel articulators 210 laterally outward such that the sets of wheels 220 attached to the second set of the wheel articulators 210 are inserted into the wall channel CH of the most recently printed layer Lc of the second wall W2. After completing Step 7 of FIG. 14B, the printing apparatus is ready to print the next layers of the first and second walls W1, W2.

In some embodiments, the lift apparatus is capable of extending the wheel articulators to move the extruder 130 upward by a distance equal to or greater two or more times the height of a layer. Accordingly, in some embodiments, the extruder 130 can print two or more layers of each of the first and second walls W1, W2 by moving the extruder 130 upward to perform each of two or more consecutive layer printings for the first and second walls W1, W2, before needing to move the wheel articulators 210 as described above to move the sets of wheels 210 from the wall channels CH currently engaged by the sets of wheel to wall channels CH above the currently engaged wall channels CH. Thus, in some embodiments, the printing apparatus 100 can print the first two or more layers of the first and second walls W1, W2 on the ground surface G before needing to insert the sets of wheels 220 in the wall channels CH of a previously printed layer. Further due to the ability to extend the wheel articulators upward to move the extruder 130 upward by two or more layers, depending on the desired printing operation, the sets of wheels 220 can be inserted in the wall channels CH of a most recently printed layer or the wall channels CH of a previously printed layer that is two or more layers below the layer currently being printed.

Although the description of FIGS. 14A and 14B describes a particular process for preparing the printing apparatus to print next layers of the first and second walls W1, W2, the disclosure is not limited to the described process. For example, the first and second groups of wheel articulators 210 can be reversed. Additionally, a different combination and/or number of wheel articulators 210 can be included in the first set of wheel articulators 210 and the second set of wheel articulators 210. In some embodiments, the inner and outer form chambers can support the weight of the extruder utilizing previously disposed material during wheel articulation operations, allowing for many or all wheel articulators to be towards the central axis of the printing apparatus and not contacting disposed material during articulation operations.

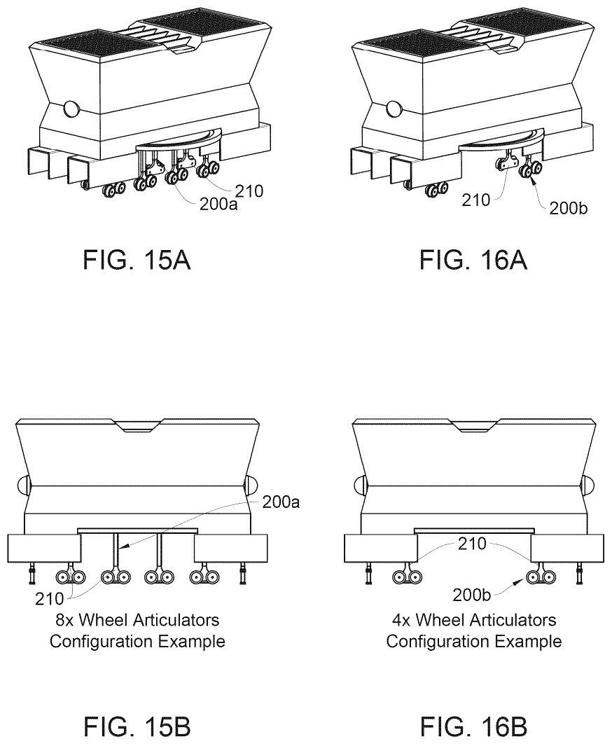

Additionally, the disclosed wheel articulator apparatus is not limited to including six wheel articulators 210, and any number of wheel articulator apparatuses is possible. For example, FIGS. 15A and 15B depict profile views of a wheel articulator apparatus 200a including eight wheel articulators 210, according to an embodiment.

Additionally, FIGS. 16A and 16B depict profile views of a wheel articulator apparatus 200b including four wheel articulators 210, according to an embodiment.

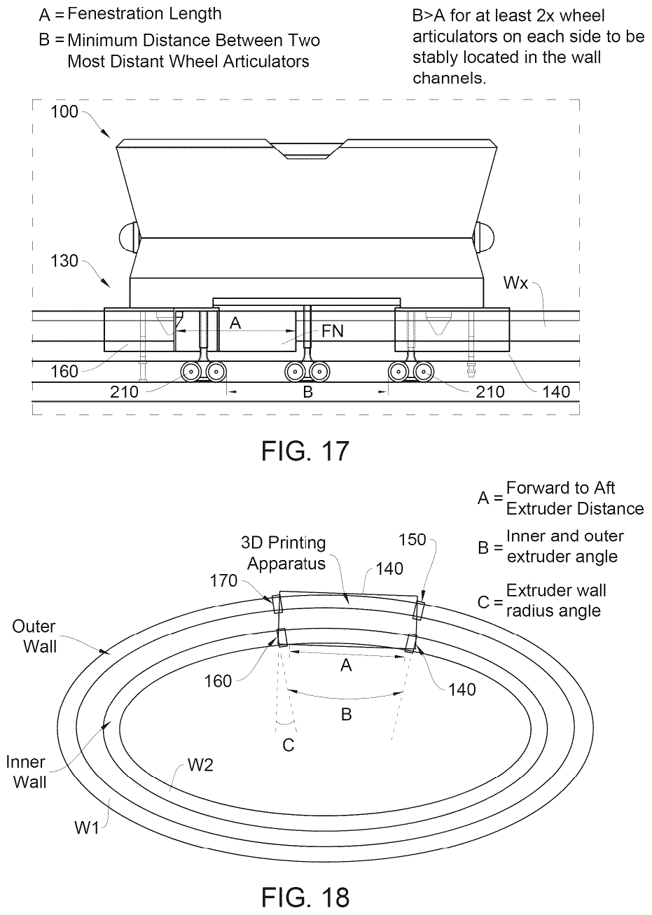

The printing apparatus 100 has the ability to print sections of wall with openings for fenestrations such as entryways, windows, and other fenestrations. This is possible given the number of wheel articulators 210 utilized coupled with the length of the extruder 130 (e.g., the extruder chambers 140, 150, 160, and 170). FIG. 17 depicts a profile view of a fenestration FN being printed, with limiting dimensional parameters of the 3D printer apparatus 100 labeled to show a relationship between these dimensional parameters and a length of a fenestration FN to be included in a printed wall Wx, according to an embodiment.

Referring to FIG. 17, the maximum fenestration length A is determined based on the requirement that at least two wheel articulators 210 on either side of the printing apparatus 100 be stably located within wall channels CH at any given time during the print of the fenestration FN. Thus, as shown in FIG. 17, the minimum distance B between the two most separated wheel articulators 210 on either side of the printing apparatus 100 sets the maximum fenestration opening print capability, with the parameters A and B being adjustable depending on the size of the print and the fenestration requirements.

The printing apparatus 100 is also capable of printing curved walls and walls of other shapes that have curved wall sections. FIG. 18 depicts example outer and inner curved walls WC1 and WC2, along with limiting extruder chamber parameters to illustrate the relationship between the extruder chamber parameters and a radius of wall sections, according to an embodiment. In some embodiments, the extruder chambers 140, 150, 160, and 170 can be rotatably mounted in the printing apparatus 100. Thus, as illustrated in FIG. 18, the extruder chambers 140, 150, 160, and 170 can be rotated about their vertical axes either manually or by a motorized assembly to change their angles of orientation with respect to the vertical axes, thereby enabling printing of the outer and inner curved walls WC1 and WC2, and various other curved walls as well as curved wall sections in partially curved walls.

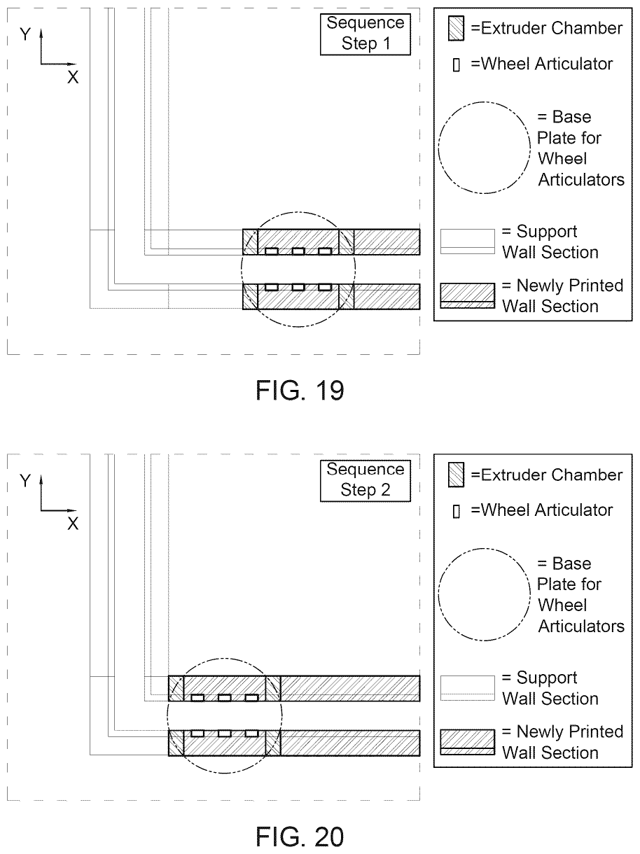

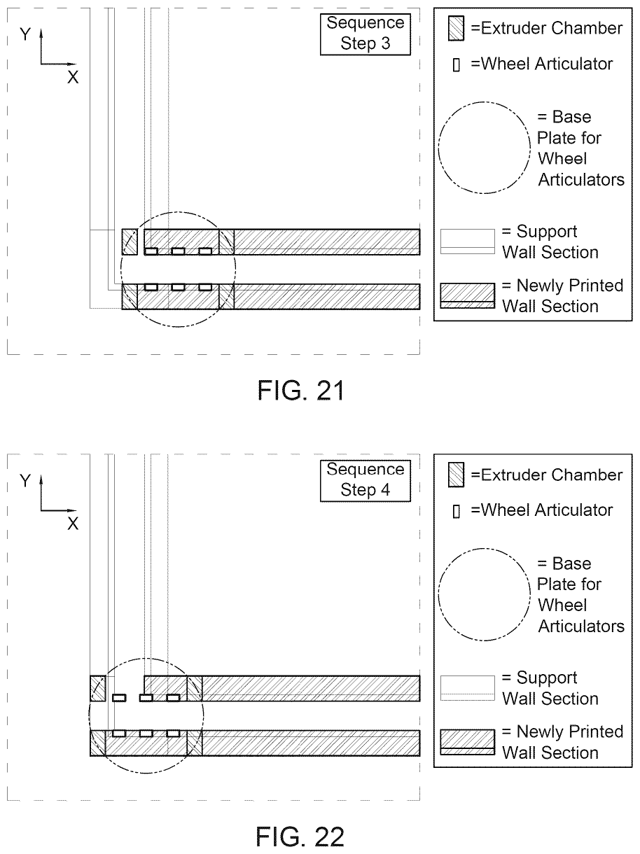

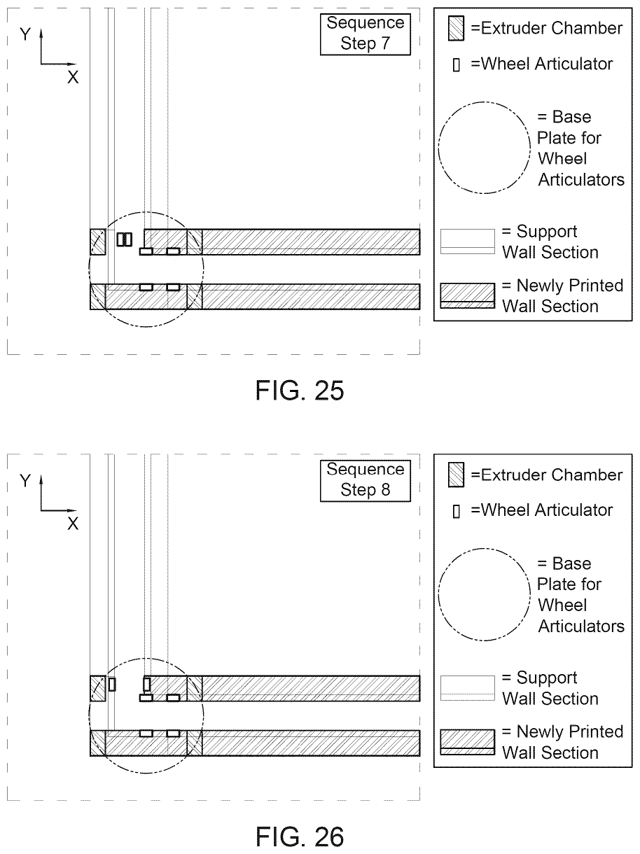

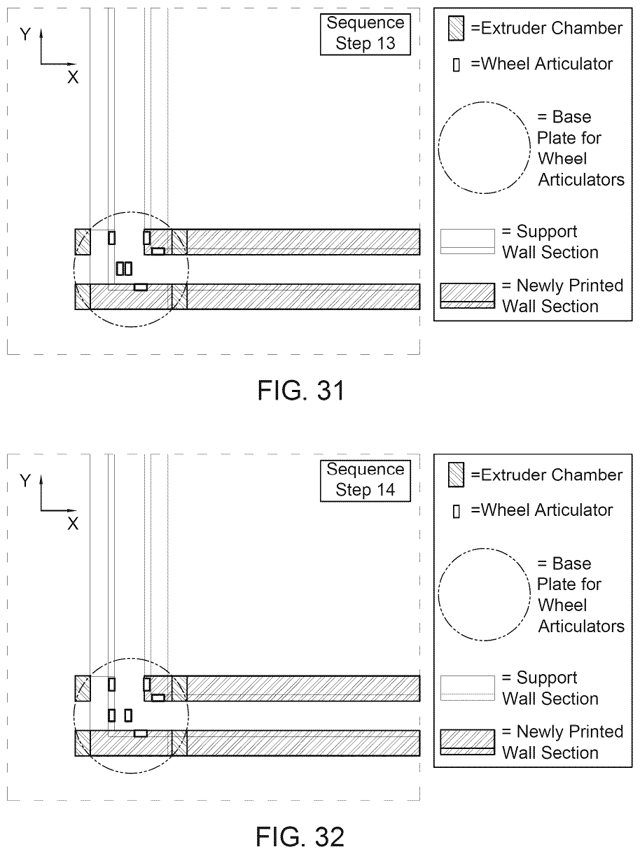

FIGS. 19-47 depict a process of printing corners of first and second walls, according to an embodiment. FIG. 48 depicts the base plate 120 and the wheel articulators 210, and movement vectors for the base plate 120 and the wheel articulators 210, according to an embodiment. The wheel articulators 210 can be moved (e.g., translated, and rotated) as shown in FIG. 48 by a motorized actuator assembly, as previously described herein, and the printing apparatus 100 is thereby able to easily print corner sections of wall layers.

As shown in FIGS. 19-21, a printing apparatus (e.g., the printing apparatus 100) is configured to print sections of a new wall layer of the outer wall from an outer front extruder chamber (e.g., the outer front extruder chamber 140) and to print sections of a new wall layer of the inner wall from an inner front extruder chamber (e.g., the inner front extruder chamber 150), while moving forward in the X direction, until the new wall layer of the inner wall reaches a corner line of the inner wall in the X direction. During this printing phase, the extruder chambers (e.g., the extruder chambers 140, 150, 160, and 170) are maintained in a first orientation and the wheel articulators (e.g. the wheel articulators 210) are configured to maintain the sets of wheels (e.g., the sets of wheels 220) in wall channels (e.g., the wall channels CH) of inner and outer support wall layers (e.g., previously printed layers) of the inner and outer walls.

Next, as illustrated in FIG. 22, the printing apparatus stops printing sections of the inner wall from the inner front extruder chamber and continues printing sections of the new wall layer of the outer wall from the outer front extruder chamber until the new wall layer of the outer wall reaches a corner point of the outer wall. When the new wall layer of the outer wall reaches a corner line of the outer support wall in the X direction, the sets of wheels attached to the outer front wheel articulator and the inner front wheel articulator are positioned past the corner line of the inner support wall in the X direction, and the sets of wheels attached to the inner front wheel articulator are therefore not inserted in the wall channel CH of the inner support wall.

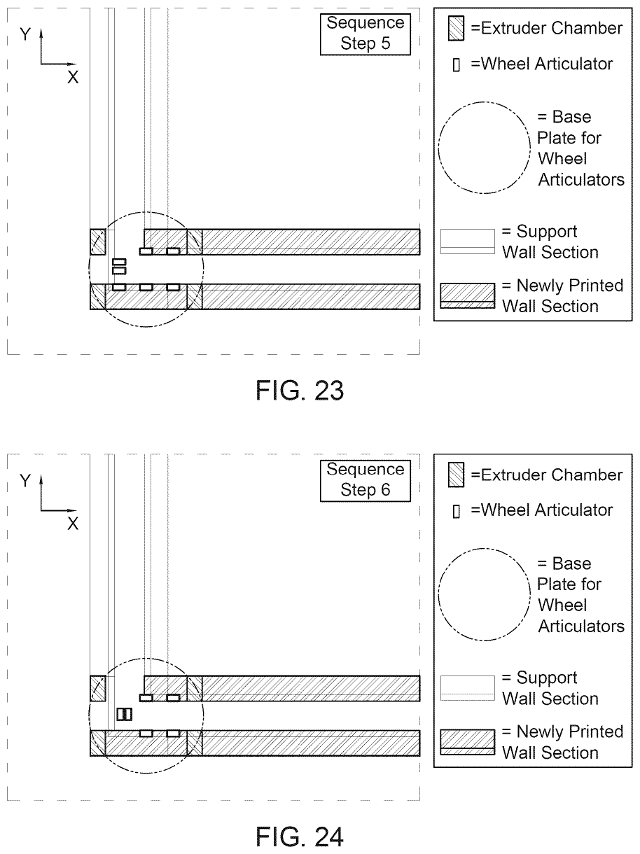

Next, as shown in FIGS. 23-26, the outer front wheel articulator and the inner front wheel articulator are: 1) moved laterally inward so that the sets of wheels attached to the outer front wheel articulator are removed from the wall channel of the outer support wall; 2) rotated approximately 90 degrees clockwise; 3) moved forward in the Y direction until the wheels attached to the outer front wheel articulator and the wheels attached to the inner front wheel articulator are positioned at a location past the corner line of the inner support wall in the Y direction; and 4) moved laterally outward so that the sets of wheels attached to the outer front wheel articulator are inserted in the wall channel of the outer support wall at the location past the corner line of the inner support wall in the Y direction, and the sets of wheels attached to the inner front wheel articulator are inserted in the wall channel of the inner support wall at the location past the corner line of the inner support wall in the Y direction.

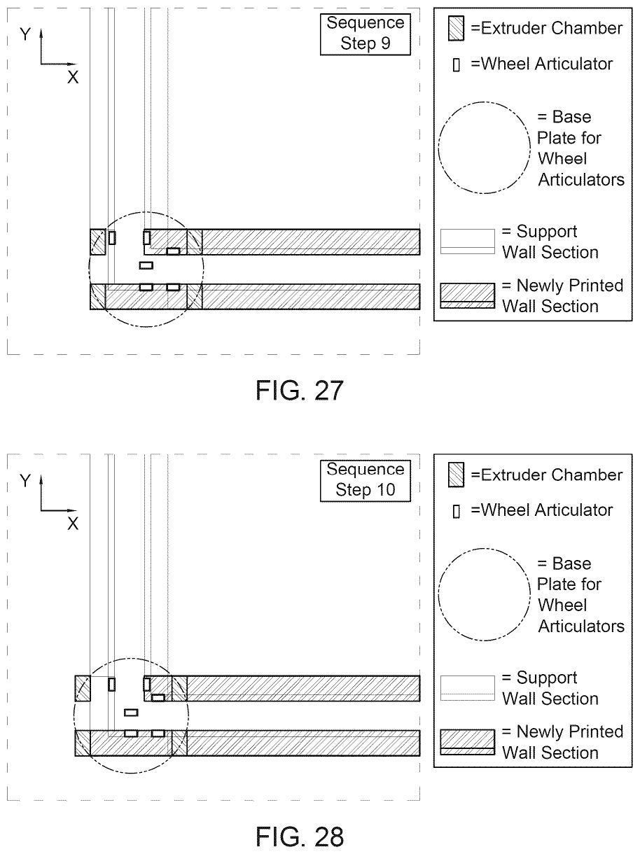

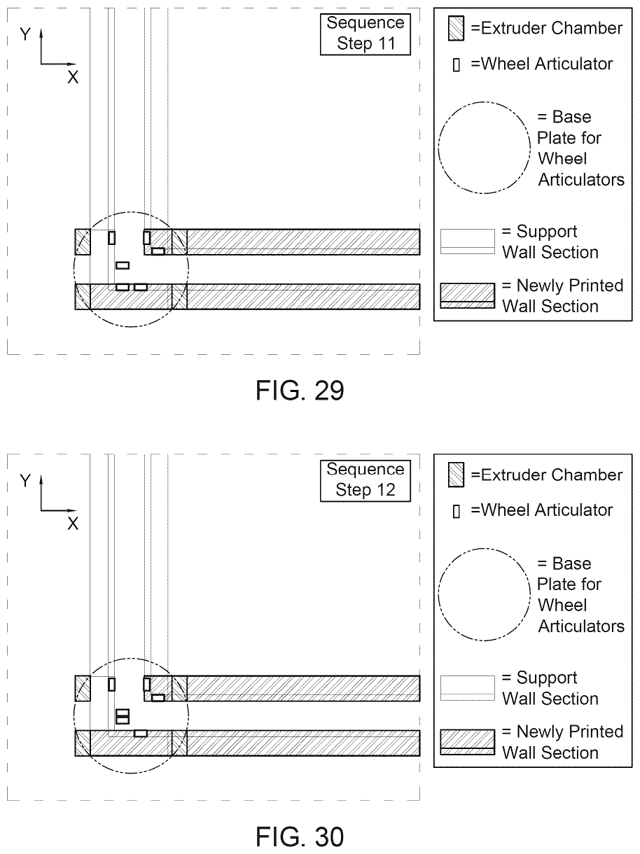

Next, as shown in FIG. 27, the inner middle wheel articulator, which is positioned at a location approximately at the corner line of the inner support wall in the X direction, is moved laterally inward such that the sets of wheels attached to the inner middle wheel articulator are removed from the wall channel of the inner support wall. Then, as shown in FIG. 28, the outer middle wheel articulator, the inner middle wheel articulator, the outer rear wheel articulator, and the inner rear wheel articulator are moved forward in the X direction. Then, as shown in FIG. 29, the outer middle wheel articulator, the inner middle wheel articulator, and the outer rear wheel articulator are moved forward in the X direction while the inner rear wheel articulator is kept stationary. In the configuration of FIG. 29, the outer middle wheel articulator, the inner middle wheel articulator, and the outer rear wheel articulator are located at positions past the corner line of the inner support wall in the X direction, and the inner rear wheel articulator is positioned approximately at the corner line of the inner support wall in the X direction.

Then, as shown in FIGS. 30-32, the outer middle wheel articulator is moved laterally inward such that the sets of wheels attached thereto are removed from the wall channel of the outer support wall, the outer middle wheel articulator and the inner middle wheel articulator are rotated approximately 90 degrees clockwise, and the outer middle wheel articulator is moved laterally outward such that the sets of wheels attached thereto are inserted in the wall channel of the outer support wall at a location past a corner line of the outer support wall in the Y direction.

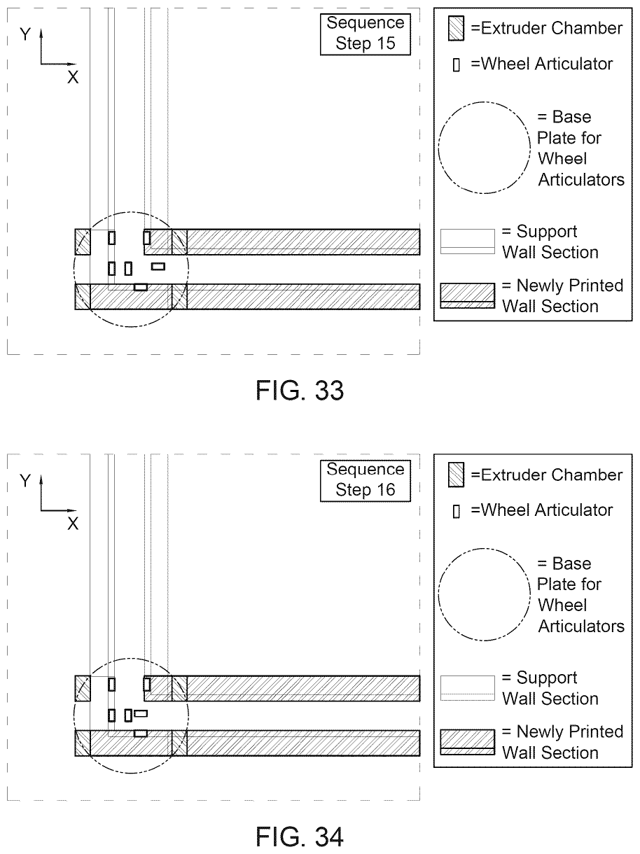

Then, as shown in FIGS. 33-34, the inner rear wheel articulator is moved laterally inward such that the sets of wheels attached thereto are removed from the wall channel of the inner support wall, and the inner rear wheel articulator is then moved forward to the location past the corner line of the inner support wall in the X direction where the outer rear wheel articulator is located.

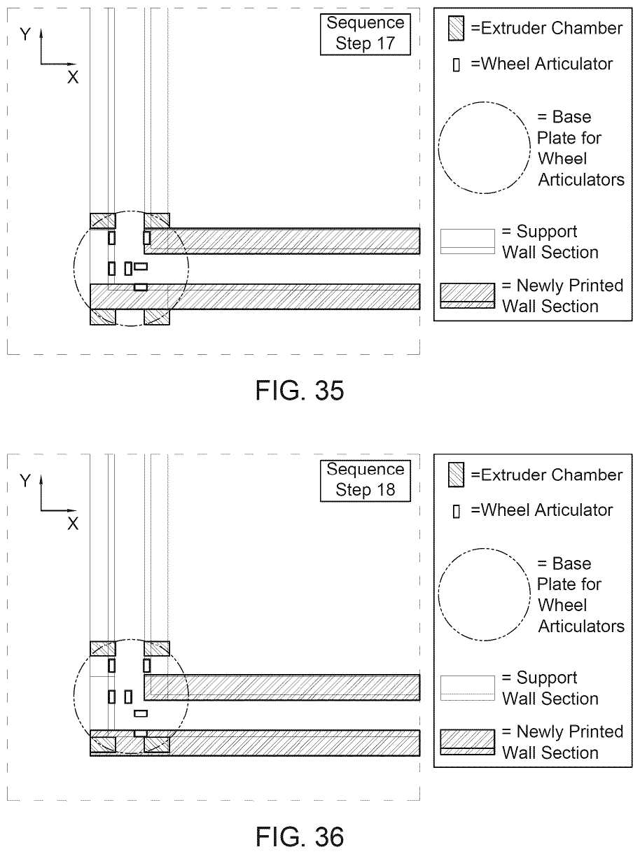

Next, as shown in FIG. 35, the entire extruder/all of the extruder chambers are rotated together approximately 90 degrees clockwise about a vertical axis of the printing apparatus.

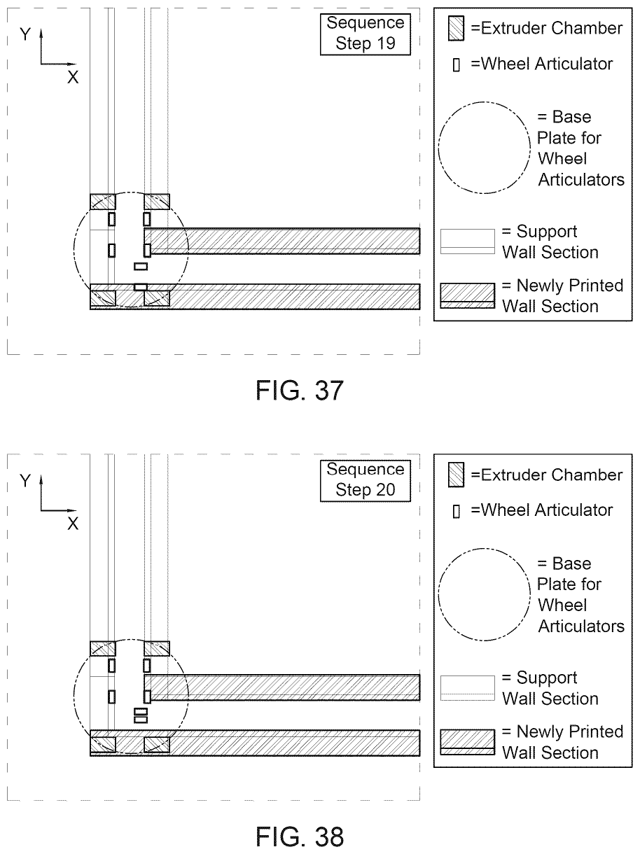

Thereafter, as shown in FIGS. 36 and 37, the outer middle wheel articulator and the inner middle wheel articulator are moved forward to a location approximately at the corner line of the inner support wall in the Y direction, and the inner middle wheel articulator is moved laterally outward such that the sets of wheels attached thereto are inserted into the wall channel of the inner support wall at the location approximately equal to the corner line of the inner support wall in the Y direction.

Next, as shown in FIGS. 38 to 40, the outer rear wheel articulator is moved laterally inward such that the sets of wheels attached thereto are removed from the wall channel of the outer support wall, then the outer rear wheel articulator and the inner rear wheel articulator are moved further forward in the X direction, and then the outer rear wheel articulator and the inner rear wheel articulator are rotated together approximately 90 degrees clockwise.

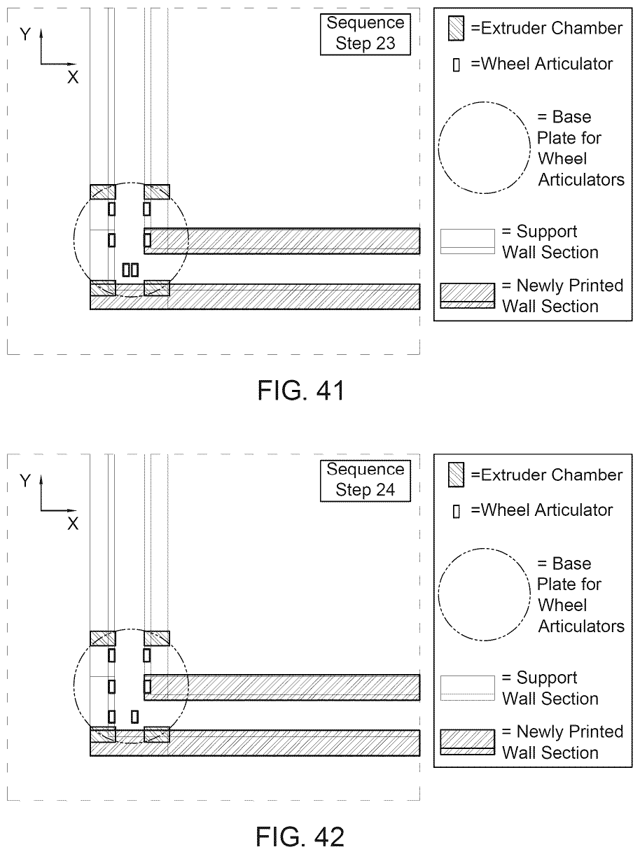

Then, as illustrated in FIG. 41, the outer front wheel articulator, the inner front wheel articulator, the outer middle wheel articulator, and the inner middle wheel articulator are moved forward in the Y direction. Thereafter, the outer rear wheel articulator is moved laterally outward such that the sets of wheels attached thereto are inserted in the wall channel of the outer support wall.

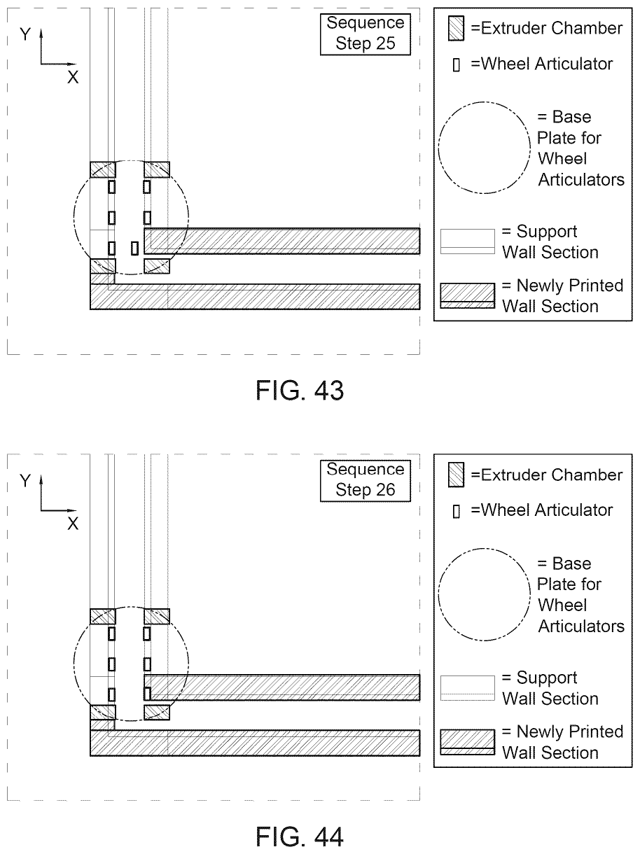

Next, as shown in FIG. 43, the printing apparatus moves forward in the Y direction while printing a section of the new wall layer of the outer wall from the outer rear extruder chamber, such that all of the wheel articulators are moved forward in the Y direction until the outer rear wheel articulator and the inner rear wheel articulator are positioned at a location approximately at the corner line of the inner support wall in the Y direction. Then, as shown in FIG. 44, the inner rear wheel articulator is moved laterally outward so that the sets of wheels attached thereto are inserted in the wall channel of the inner support wall at the location approximately at the corner line of the inner support wall in the Y direction.

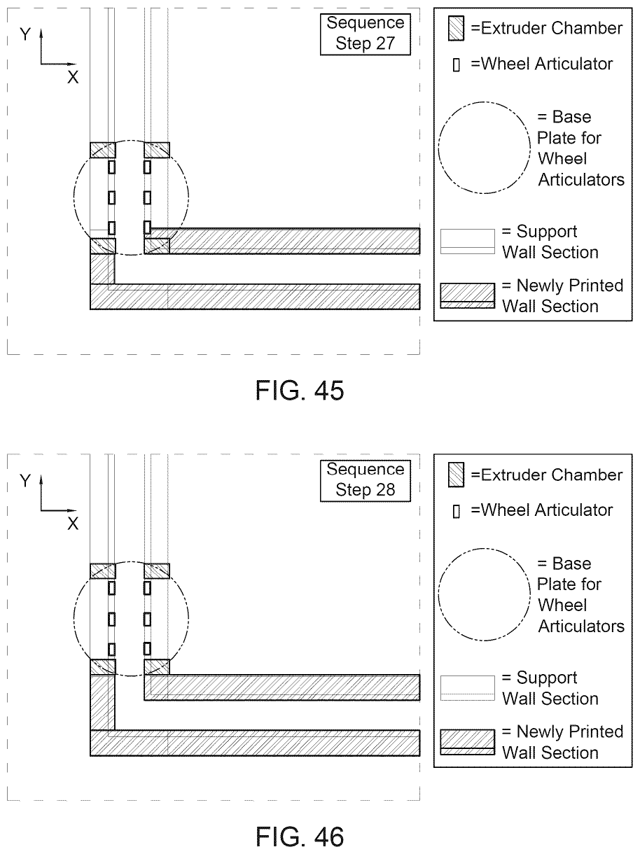

Next, as shown in FIG. 45, the printing apparatus continues moving forward in the Y direction while printing the new wall layer of the outer wall from the outer rear extruder chamber. At this point, the outer rear extruder chamber and the inner rear extruder chamber have reached a location approximately at the corner line of the inner support wall.

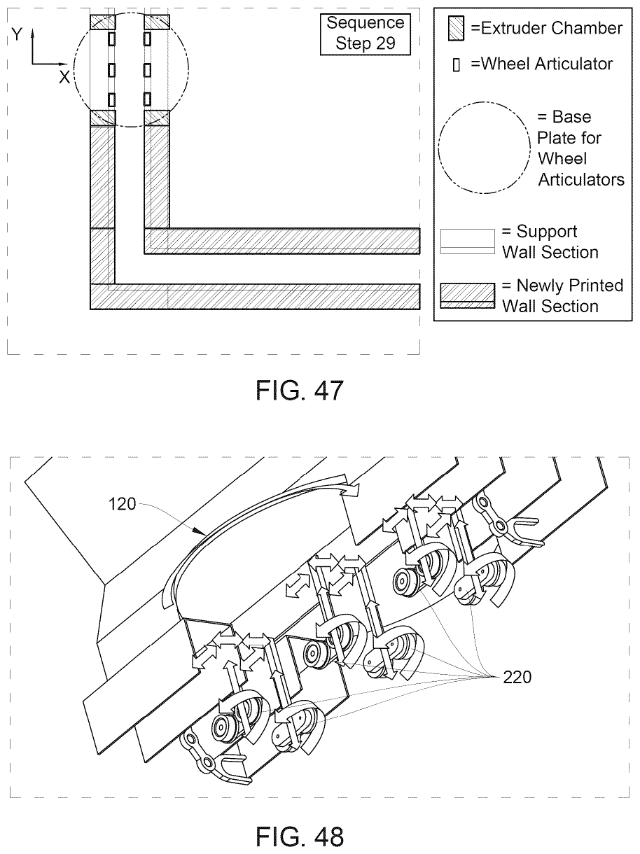

Next, as illustrated in FIG. 46, the printing apparatus continues moving forward in the Y direction while printing the new wall layer of the outer wall from the outer rear extruder chamber, until the outer rear extruder chamber and the inner rear extruder chamber are positioned at a location past the corner line of the inner support wall in the Y direction. Thereafter, as shown in FIG. 47, the printing apparatus continues moving forward in the Y direction while printing the new wall layer of the outer wall from the outer rear extruder chamber and printing the new wall layer of the inner wall from the inner rear extruder chamber.

FIGS. 19-47 and the associated description herein provide only one example of how a printing apparatus according to the disclosure can print wall corners. Accordingly, the example of FIGS. 19-47 is not limiting, but is provided only to illustrate how the printing apparatus can be operated to print various wall corners and shapes.

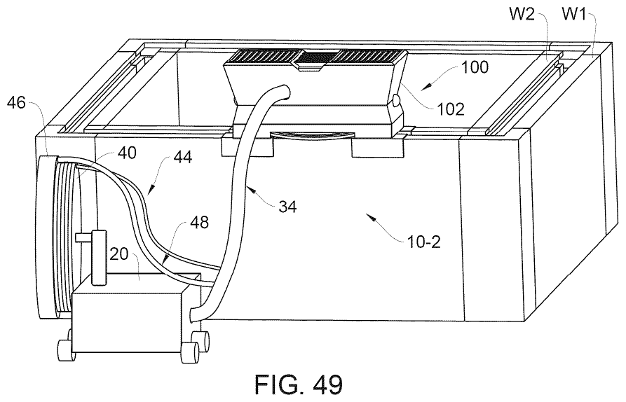

In some embodiments, a printing system can be configured to form flexible vertical tension rods in a printed structure to reinforce the printed structure. Example embodiments in which a printing system is configured to form flexible vertical tension rods into a structure are illustrated in FIGS. 49-51, which are described below.

FIG. 49 depicts an example profile view of a 3D printing system (“printing system”) 10-2 configured to form flexible vertical tension rods in a structure being printed. The printing system 10-2 can include the printing apparatus 100, the material supply 20, a main feed line 34, the spool 40 holding one or more routed accessory components AC, the routed components feed line 44 configured to feed the routed accessory components AC from the spool 40 to the main feed line 34, a spool 46 holding a flexible rod material, and a tension rod feed line 48 configured to feed the flexible rod material from the spool 46 to the main feed line 34. The main feed line 34 can include internal sub-feed lines configured to feed the print material from the material supply to the printing apparatus 100, feed the one or more routed accessory components AC from the routed components feed line 44 to the 3D printing apparatus 100, and feed the flexible rod material from tension rod feed line 48 to the printing apparatus 100. The flexible rod material can be, for example a variety of fiber-reinforced polymers, such as glass fiber reinforced polymer, carbon fiber reinforced polymer, basalt fiber reinforced polymer, as well as alternative versions of these materials with polymer substitutes and other materials such as wire meshes and bamboo.

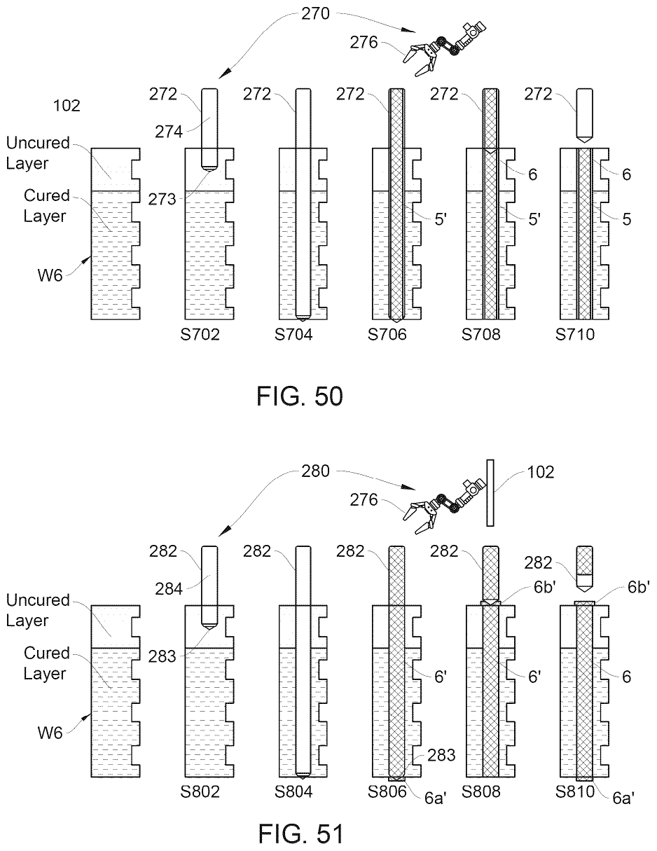

The printing apparatus 100 can process the flexible rod material to insert flexible vertical tension rod members in a wall of a structure to reinforce the structure, as described below with respect to FIGS. 50 and 51.

FIG. 50 depicts an example process flow for a method of inserting a flexible vertical tension rod 5 into a wall W6 of a printed structure, according to an embodiment. As shown in FIG. 50, the printing apparatus 100 can include a tension rod installation mechanism 270 for inserting the flexible vertical tension rod 5 into the wall W6. The tension rod installation mechanism 270 can include, for example, a drill mechanism 272, an armature mechanism 276, and a substrate filling mechanism 278 that are mounted to the housing 102 of the printing apparatus 100. The drill mechanism 272 can include an elongate member having a drill tip 273 configured to drill a hole, and a hollow interior 274 that is configured to receive a segment of tension rod material 5′ therein.

As shown in FIG. 50, in step S702, the drill mechanism 272 can start drilling a vertically extending hole that extends through an uncured top layer and cured/partially cured lower layers of the wall W6. In step S704, the drill mechanism can complete drilling the vertically extending hole. Next, in step S706, the armature mechanism 276 can feed the segment of tension rod material 5′ into the hollow interior 273. Then, in step S708, the drill mechanism 272 can be removed from the wall W6, and the substrate filling mechanism 278 can fill substrate filler material 6 in an interstitial volume between the segment of tension rod material 5′ and the wall W6. In some embodiments, the substrate filling mechanism 278 can include a nozzle in communication with a reservoir containing the substrate filler material 6. In some embodiments, the substrate filler material 6 can be the same material as the print material. However, the substrate filler material 6 can be another material, such as hemp plant materials, soil and earth-based materials, steel and iron dust deposit waste materials, mycelium mushroom materials, epoxy resin materials, wax materials, and clay materials including natural clays, oil-based clays, epoxy clays, and polymer clays.

Finally, in step S710, a portion of the segment of tension rod material 5′ extending above the hole in the wall W6 can be cut, thereby forming the flexible vertical tension rod 5 in the wall W6.

In some embodiments, multiple flexible vertical tension rods 5 can be formed in the wall W6 by the method described above.

FIG. 51 depicts an example process flow for a method of inserting a flexible vertical tension rod 6 that does not require insertion of a substrate into a drilled interstitial volume, according to an embodiment. As shown in FIG. 51, the printing apparatus can include a tension rod installation mechanism 280 for inserting the flexible vertical tension rod 6 into the wall W6. The tension rod installation mechanism 280 can include, for example, a drill mechanism 282 and the armature mechanism 276 that are mounted to the housing 102 of the printing apparatus 100. The drill mechanism 282 can include an elongate threaded insertion member driven by a gear assembly and having a hollow drill tip 283 configured to drill a hole, and a hollow interior 284 and configured to receive a segment of tension rod material 6′ therein.

As shown in FIG. 51, in step S802, the drill mechanism 282 can start drilling a vertically extending hole that extends through an uncured top layer and cured/partially cured lower layers of the wall W6. In step S804, the drill mechanism can complete drilling the vertically extending hole. At the conclusion of step S804, the hollow drill tip 283 can extend slightly past a bottom edge of the wall W6. Next, in step S806, the armature mechanism 276 can feed the segment of tension rod material 7′ into the hollow interior 284 until a bottom end of the segment of tension rod material 7′ protrudes from the hollow drill tip 283 and expands to form a lower flange portion 7a′ having a diameter larger than a diameter of the drilled hole. Then, in step S808, the drill mechanism 282 can be removed from the wall W6, causing an upper end of the segment of tension rod material 6′ to expand and form an upper flange portion 7b′ having a diameter larger than the diameter of the drilled hole. Finally, in step S810, a portion of the segment of tension rod material 7′ extending above the upper flange portion 7b′ can be cut, thereby forming the flexible vertical tension rod 7 in the wall W6. The lower flange portion 7a′ and the upper flange portion 7b′ prevent flexible vertical tension rod 7 from being removed from the wall W6.

In some embodiments, multiple flexible vertical tension rods 6 can be formed in the wall W6 by the method described above.

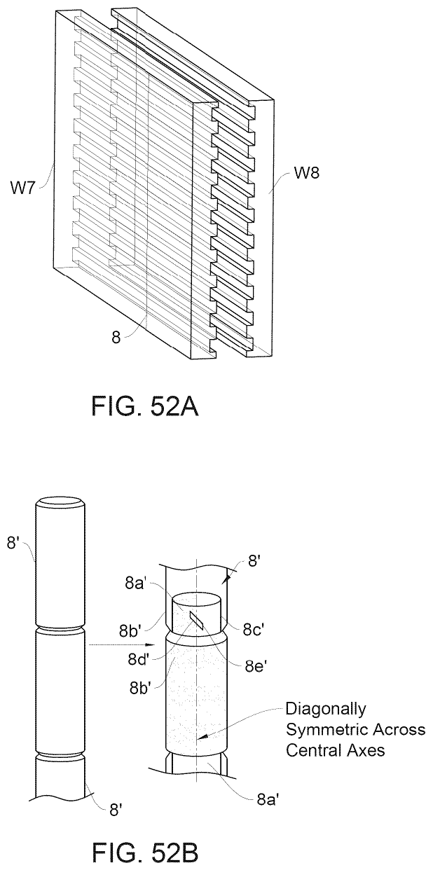

FIGS. 52A and 52B depict a rigid vertical tension rod 8 formed of rigid vertical tension rod segment 8′, each of which is interlocked with another rigid vertical tension rod segment 8′ connected by interlocking elements, according to an embodiment. Referring to FIG. 52A, the printing apparatus can form the rigid vertical tension rod 8 extending through multiple layers of an outer wall W7 in a structure including the outer wall W7 and an inner wall W8. For example, the rigid vertical extension rod segments 8′/rigid vertical tension rod 8 can be formed of steel or metal. However, other suitable materials can be used for the rigid vertical tension rod 8 segments 8′/rigid vertical tension rod 8.

As shown in FIG. 52B, the rigid vertical tension rod 8 can be formed by inserting each rigid vertical tension rod segment 8′ in an uncured layer of the outer wall W7 and, if another rigid vertical tension rod segment 8′ has been inserted below the rigid vertical tension rod segment 8′ in a most recently completed layer of the outer wall W7, interlocking the rigid vertical tension rod segment 8′ in the uncured layer with the other rigid vertical tension rod segment 8′ below.

As shown in FIG. 52B, each rigid vertical tension rod segment 8′ can include an upper portion 8a′, and a lower portion 8b′ having a hollowed-out lower end 8c′. The hollowed-out lower end 8c′ can have an internal diameter that is slightly greater than a diameter of the upper portion 8a′. A first locking element 8d′ can be disposed on an external surface of the upper portion 8a′ and a second locking element 8e′ can be disposed on an internal surface of the hollowed-out lower end 8c′. For example, the first locking element 8d′ can be a protrusion, and the second locking element 8e′ can be a slot shaped to receive the first locking element 8d′ of another rigid vertical tension rod segment 8′ and lock with the first locking element 8d′ of the other rigid vertical tension rod segment 8′. However, the first locking element 8d′ and the second locking element 8e′ are not limited to the described structures.

The hollowed-out lower end 8c′ of one vertical tension rod segment 8′ can receive the upper portion 8a′ of another vertical tension rod segment 8′ disposed below the one vertical tension rod segment 8′, such that the first locking element 8d′ of the other vertical tension rod segment 8′ is received in the second locking element 8e′ of the one vertical tension rod segment 8′. The one rigid vertical tension rod segment 8′ and the other rigid vertical tension rod segment 8′ can be interlocked by twisting the one rigid vertical tension rod segment 8′ with respect to the other vertical tension rod segment 8′, or vice-versa, such that the second locking element 8e′ of the one rigid vertical tension rod segment 8′ and the first locking element 8d′ of the other rigid vertical tension rod segment 8′ lock with each other.

The printing apparatus 100 can further include one or more tension rod segment sensors (e.g., vibroacoustic, magnetic, ultrasonic, or infrared sensors) configured to sense the presence of a rigid vertical tension rod segment 8′, in combination with location tracking mapping, to determine the location of a rigid vertical tension rod segment 8′ in a previously printed layer beneath the layer of the wall W7 that is currently being printed. Based on the determined location of the rigid vertical tension rod segment 8′ in the previously printed layer, the printing apparatus 100 can determine a location at which to insert a rigid vertical tension rod segment 8′ in the layer of the wall W7 that is currently being printed.

Although the embodiment of FIGS. 52A and 52B describe a rigid vertical tension rod 8 inserted in the outer wall W7, it is to be understood that the rigid vertical tension rod 8 can also be installed in the inner wall W8.

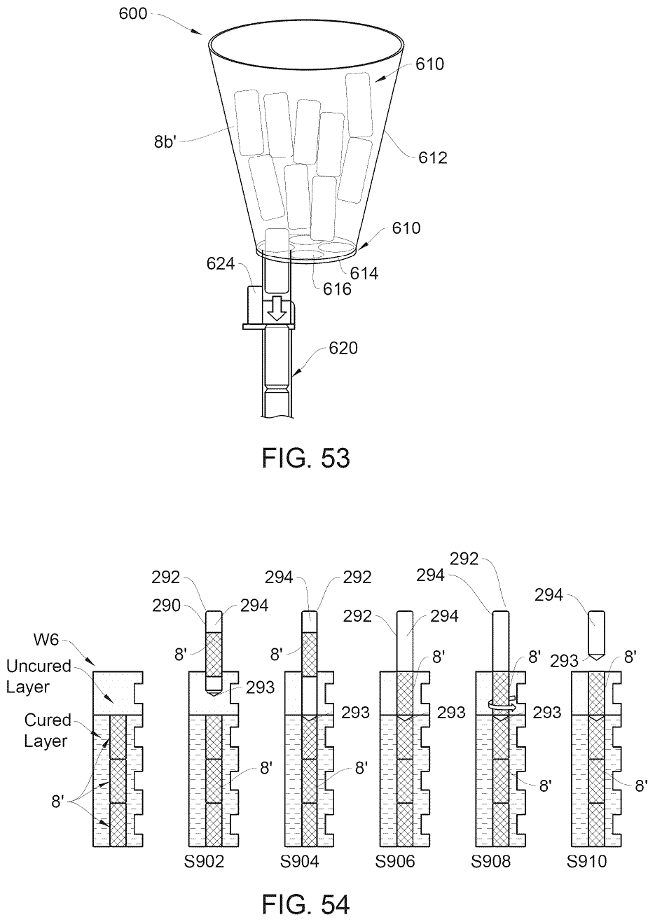

FIG. 53 depicts a tension rod segment feeding mechanism 600, according to an embodiment. As shown in FIG. 53, the tension rod segment feeding mechanism 600 can include a funnel-shaped reservoir 610 configured to hold a plurality of rigid vertical tension rod segments 8′ therein, and a tension rod feed tube 620 configured to receive the rigid vertical tension rod segments 8′ from the funnel-shaped reservoir 610. The funnel-shaped reservoir 610 can be disposed above the tension rod feed tube 620, and can be configured to deliver the tension rod segments 8′ to the tension rod feed tube 620 by a gravity-feed.

The funnel-shaped reservoir 610 can include a sorting and funneling mechanism 612 including a rotatable plate 614 having openings 616 therein. The openings 616 can be configured such that each opening 616 receives a rigid vertical tension rod segment 8′ and feeds the received rigid vertical tension rod segment 8′ into the feed tension rod feed tube 620 when the rotatable plate 614 rotates to position the opening 616 into alignment with the feed tube 620. The tension rod segment feeding mechanism 600 can also include a twisting mechanism (e.g., an armature mechanism) 624, mounted on the tension rod feed tube 620 and configured to twist adjacent rigid vertical tension rod segments 8′ into locking engagement with each other inside the tension rod feed tube 620 to form the rigid vertical tension rod segment 8. The tension rod feed tube 620 can be inserted into one or more uncured layers of a wall to insert the rigid vertical tension rod segments 8′ into the wall to form the rigid vertical tension rod segment 8 therein.

FIG. 54 depicts a cross-section view of a method for inserting a rigid vertical tension rod segment 8′ into an uncured layer of a wall W9 and interlocking the inserted rigid vertical tension rod segment 8′ with another rigid vertical tension rod segment 8′ below, according to an embodiment. As shown in FIG. 54, the printing apparatus 100 can include a tension rod installation mechanism 290 for inserting the rigid vertical tension rod segments 8′ into a wall W9. The tension rod installation mechanism 290 can include, for example, a drill mechanism 292 including an elongate member having a hollow drill tip 293 configured to drill a hole, and a hollow interior 294 that is configured to receive a rigid vertical tension rod segment 8′ therein.

As shown in FIG. 54, in step S902, the drill mechanism 292, which includes a rigid vertical tension rod segment 8′ disposed in the hollow interior 294 thereof, can start drilling a vertically extending hole in the uncured layer of the wall W9. In step S904, the drill mechanism can complete drilling the vertically extending hole such that the vertically extending hole extends through substantially the entire uncured layer of the wall W9. Next, in step S906, the rigid vertical tension rod segment 8′ can be moved toward the hollow drill tip 293 and into engagement with the rigid vertical tension rod segment 8′ formed below in a cured layer of the wall W9. Then, in Step S908, the drill mechanism 282 can twist the rigid vertical tension rod segment 8′ in the uncured layer of the wall W9 to interlock the rigid vertical tension rod segment 8′ in the uncured layer of the wall W9 with the rigid vertical tension rod segment 8′ formed below. Finally, in step S910, the drill mechanism 292 can be removed from the rigid vertical tension rod segment 8′ in the uncured layer of the wall W9.

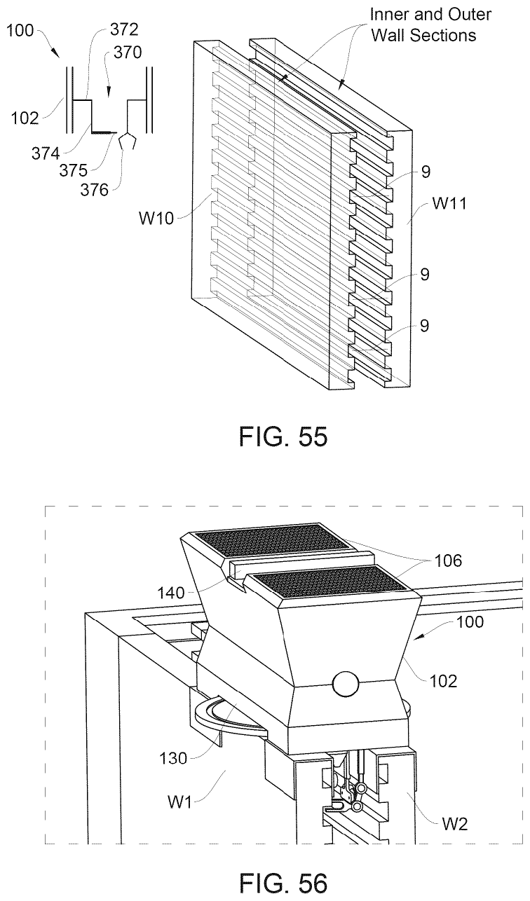

FIG. 55 depicts a method for inserting rigid horizontal tension rods 9 into an outer wall W10 and an inner wall W11 of a structure, according to an embodiment. The rigid horizontal tension rods can be made of steel, metal, or another rigid material.

As shown in FIG. 55, the printing apparatus 100 can include a tension rod installation mechanism 370 mounted to the housing for inserting the rigid horizontal tension rods into a wall W9. The tension rod installation mechanism 370 can include, for example, a drill mechanism 372 including an arm linkage 374 that is extendable, retractable, and pivotable, and a drill member 375 attached to the arm linkage 374 and configured to drill holes in the outer wall W10 and the inner wall W11. The tension rod installation mechanism 370 can further include, for example, an armature mechanism 376.

The drill member 375 can drill respective holes in either cured layers of the outer wall W10 and the inner wall W11 or uncured layers of the outer wall W10 and the inner wall W11. After drilling the holes, the armature mechanism 376 can insert one end of the rigid horizontal tension rods 9 into a layer of the outer wall W10 and can insert another end of the rigid horizontal tension rods 9 into a layer of the inner wall W11 to reinforce the outer wall W10 and the inner wall W11. In some embodiments, the armature mechanism 376 can insert one end of a rigid horizontal tension rod 9 in an uncured portion of the print material formed by the outer front extruder chamber 140 or the outer rear extruder chamber 160, and can insert another end of the rigid horizontal tension rod 9 in an uncured portion of the print material formed by the inner front extruder chamber 150 or the inner rear extruder chamber 170, respectively. Armature mechanism 376 can insert one end of a horizontal tension rod member 9 in a partially cured section of a layer of the outer wall W10, and can insert another end of the horizontal tension rod member 9 in a partially cured section of a layer of the inner wall W11, while the extruder 130 is moving along a path to print a next section of the layer of the outer wall W10 and a next section of the layer of the inner wall W11.

FIG. 56 depicts a profile view of a 3D printing apparatus 100-1 including a power supply 104, according to an embodiment. Referring to FIG. 56, the 3D printing apparatus (“printing apparatus”) 100-1 is similar to the printing apparatus 100 of FIG. 1, except that the printing apparatus 100-1 includes the power supply 104 and photovoltaic cells 106 disposed on the housing 102.

The power supply 104 can be mounted to the printing apparatus 100-1 to supply power to the printing apparatus 100-1 for performing the operations disclosed herein. For example, the power supply 104 can be powered by or recharged by connection to either one or both of an AC current supply and the photovoltaic cells 106. Thus, the power supply 104 can be charged to last for the duration of a print and can be recharged for multiple uses and larger prints.

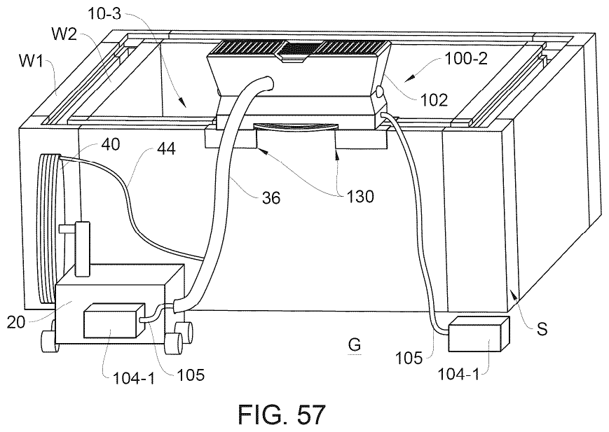

FIG. 57 depicts a profile view of a printing system 10-3 including two alternative locations for a power supply 104-1 for a 3D printing apparatus (“printing apparatus”) 100-2, according to embodiments. The printing system 10-3 is similar to the printing system 10-1 of FIG. 49, except that the printing system 10-3 includes a separate power supply 104-1 supplying power to the printing apparatus 100-2 via a power cable 105.

In FIG. 57 two alternative configurations of the power supply 104-1 and power cable 105 are illustrated. In a first configuration, the power supply 104-1 is mounted on the material supply 20 and the power cable 105 is routed to the printing apparatus 100-2 through a main feed line 36. In a second configuration, the power supply 104-1 is disposed on the ground G and the power cable 105 is routed to the printing apparatus 100-2 separately from the main feed line 36.

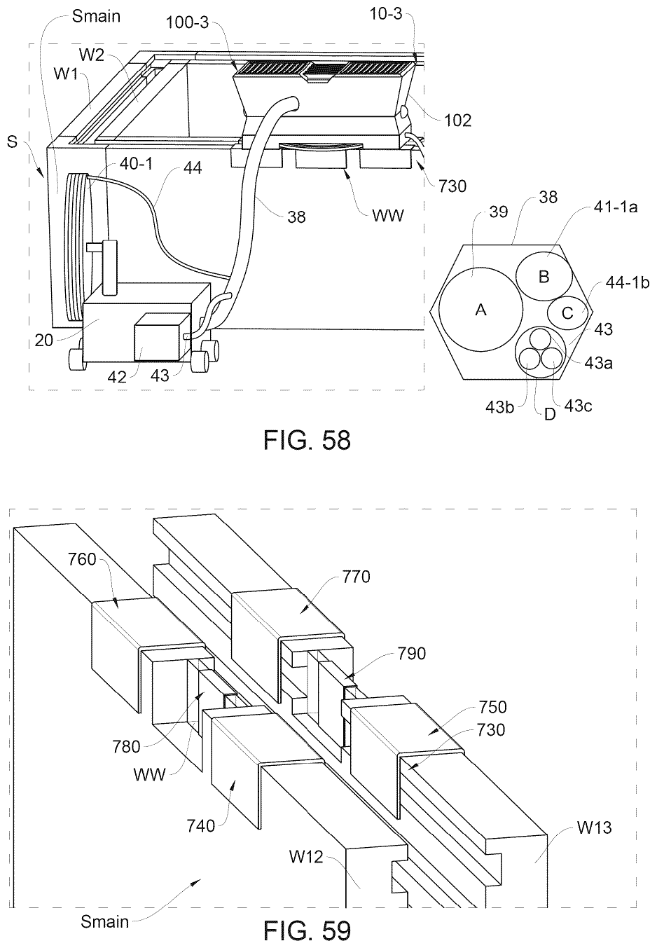

FIG. 58 depicts a printing system 10-4 including a 3D printing apparatus (“printing apparatus”) 100-3 configured to print windows WW in addition to a main structural body Smain of a structure S-1, a window material mixing chamber 42, and a window material feed line 49, according to an embodiment. FIG. 59 depicts a partial view of a printing assembly of the printing apparatus 100-3, illustrating filament extruder chambers 740, 750, 760, 770 and dedicated window extruder chambers 780, 790, according to an embodiment.

In the example shown in FIG. 58, the printing apparatus 100-3 has printed a structure S-1 including the main structural body Smain composed of an outer wall W12 and an inner wall W13. The printing apparatus 100-3 has also printed a window WW in each of the inner and outer walls W12, W13. The printing system 10-4 can include the print material supply 20 for supplying the print material (e.g., structural filament) to the printing apparatus 100-3 via a print material sub-feed line 39, a spool 40-1 holding the routed accessory components AC and configured to supply the routed accessory components AC to the printing apparatus 103 via a routed accessory components feed line 44-1, and a window material supply 42 for supplying the window material to the printing apparatus 103 via the window material feed line 43. For example, in some embodiments, the window material can include multiple window material components, such as cellulose pellets, PVA, and resin. However, the window material can include other components.

As shown in FIG. 58, in some embodiments, the window material feed line of the routed accessory components feed line 44-1 can include a first routed accessory component sub-feed line 44-1a including flexible plumbing, and a second routed accessory component feed line 44-1b including electrical harnessing. The printing system 10-4 can further include a main feed line 38 encasing the print material sub-feed line 39, the first and second routed component sub-feed lines 44-1a and 44-1b, and the window material feed line 43.

In the embodiment illustrated in FIG. 58, the window material supply 42 includes a mixer configured to mix the window material components to form the window material. Thus, the mixed window material can be supplied to the printing apparatus 100-3 via the window material feed line. However, in other embodiments, as shown in FIG. 58, a window material mixer can be disposed on the printing apparatus 100-3 and can receive unmixed window material components from the window material supply through a first window material sub-feed line 43a, a second window material sub-feed line 43b, and a third window material sub-feed line 43c. For example, the first window material sub-feed line 43a can supply cellulose pellets from the window material supply 42 to the mixer on the printing apparatus 100-3, the second window material sub-feed line 43b can supply PVA pellets from the window material supply 42 to the mixer on the printing apparatus 100-3, and the third window material sub-feed line 43c can supply resin pellets from the window material supply 42 to the mixer on the printing apparatus 100-3.

Referring to FIGS. 58 and 59, the printing apparatus 100-3 includes an extruder 730 configured to print the main structural body Smain and the windows WW. More specifically, as shown in FIG. 59, the extruder 730 can include an outer front extruder chamber 740, an inner front extruder chamber 750, an outer rear extruder chamber 760, an inner rear extruder chamber 770, an outer middle extruder chamber 780, and an inner middle extruder chamber 790. The outer front extruder chamber 740 and the outer rear extruder chamber 760 can be configured to receive the print material (e.g., structural filament) from the print material supply 20 and print the outer wall W12 with the print material. The inner front extruder chamber 750 and the inner rear extruder chamber 770 can be configured to receive the print material (e.g., structural filament) from the print material supply 20 and print the inner wall W13 with the print material. The outer middle extruder chamber 780 can be configured to receive the window material from the window material supply 42 and print the window WW in the outer wall W12 using the window material. The inner middle extruder chamber 790 can be configured to receive the window material from the window material supply 42 and print the window WW in the inner wall W13 using the window material.

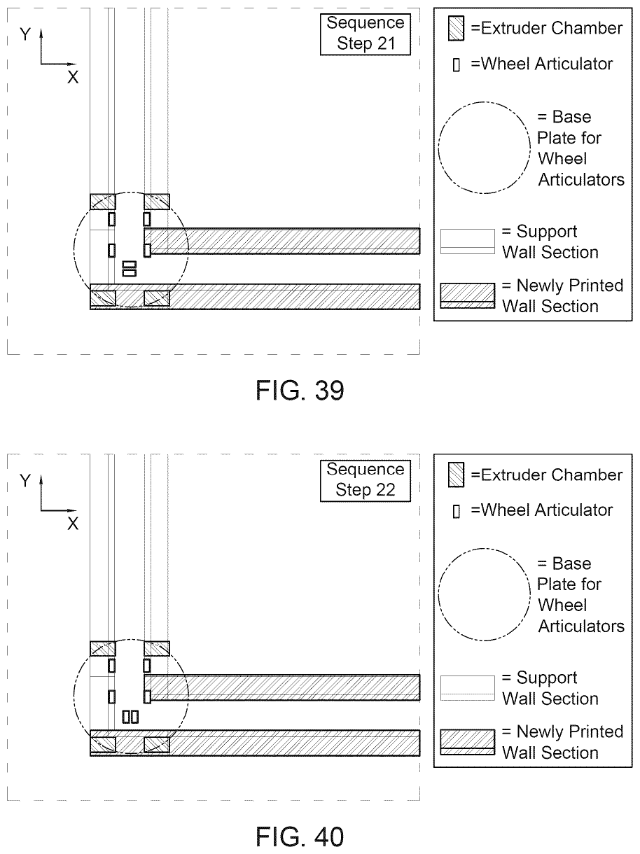

As shown in FIG. 39, the outer middle extruder chamber 780 and the inner middle extruder chamber 790 can have a print thickness that is smaller than the print thickness of the outer front extruder chamber 740, the inner front extruder chamber 750, the outer rear extruder chamber 760, and the inner rear extruder chamber 770. Although the outer middle extruder chamber 780 and the inner middle extruder chamber 790 are shown and described as being configured to print windows, in some implementations the outer middle extruder chamber 780 and the inner middle extruder chamber 790 can be configured to print other fenestrations.

In some embodiments, fenestrations for windows, doors, access ports for conduit, and other openings can be printed by controlling the flow (cessation and initiation) of material to the printing chambers as the printer translates. These fenestrations, once the upper limit is reached and material needs to be deposited above the fenestration, can have lintels or other support structures installed either manually or via the printer through the undercarriage armatures 262 or similar armatures that are positioned in a different spot on the printing apparatus to facilitate installation of lintels.

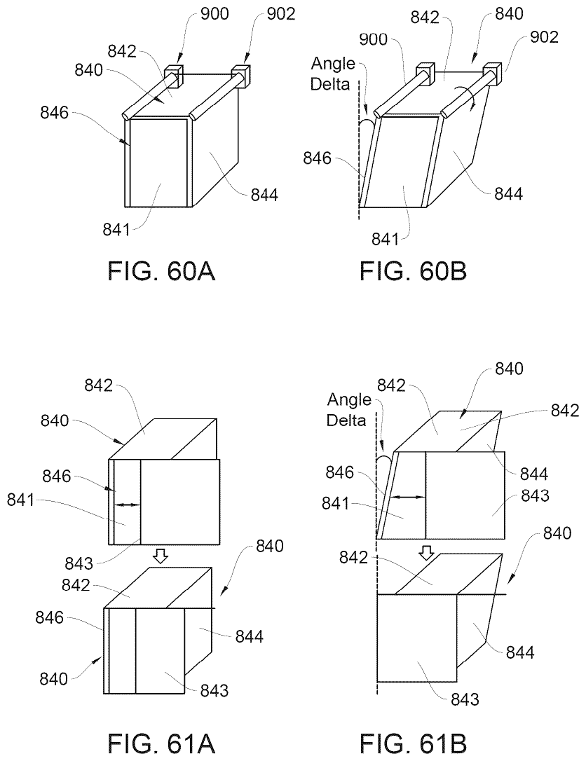

FIGS. 60A and 60B depict an extruder chamber 840 and an angle adjustment mechanism 900 configured to adjust an angle of incline of sidewalls of the extruder chamber 840 with respect to a vertical direction, according to an embodiment. FIG. 61A depicts a profile view of a door of the extruder chamber 840 in open and closed position, when the sidewalls of the extruder chamber are substantially vertical. FIG. 61B depicts a profile view of the door of the extruder chamber 840 in open position and in a closed position, when the sidewalls of the extruder chamber are inclined with respect to the vertical direction.

Referring to FIGS. 60A and 60B, the extruder chamber 840 can include a top wall 842, an inner sidewall 844, an outer side wall 846, and an inner volume 841. The extruder chamber 840 can further include an angle adjustment mechanism including a first pivot arm 900 connected to the top wall 842 and the outer side wall 846, and a second pivot arm 902 connected to the top wall 842 and the inner side wall 844. The first pivot arm 900 can be rotated by a motorized actuator assembly to change the angle of incline (angle delta) of the outer side wall 846 with respect to a perpendicular axis. The second pivot arm 902 can be rotated by a motorized actuator assembly to change the angle of incline (angle delta) delta of the inner side wall 844 with respect to a perpendicular axis. Accordingly, the shape of one or more layers of a printed structure can be varied by changing the angle of incline of the outer side wall 846 and the inner side wall 844.

Referring to FIGS. 61A and 61B, the extruder chamber 840 can include a front door 843 that can be selectively opened and closed to perform various printing operations. The front door 843 can generally correspond to the front door 343 illustrated in FIGS. 7A to 7E. As illustrated in FIGS. 61A and 61B, it can be appreciated that the front door 843 can effectively seal the inner volume 841 regardless of the angle of incline of the outer side wall 846 and the inner side wall 844.

Although not shown, the extruder chamber 840 can also include a rear door and a middle door similar to the rear door 345 and the middle door 347 illustrated in FIGS. 7A to 7E.

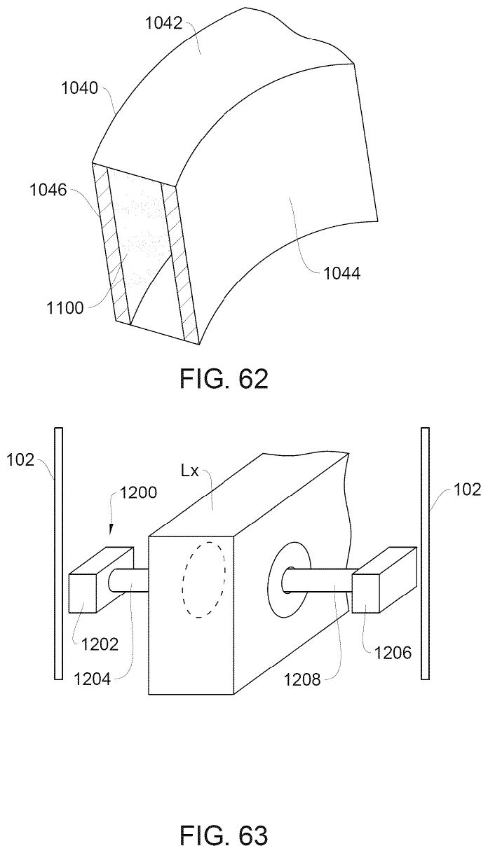

FIG. 62 depicts a profile view of an extruder chamber 1040 having flexible sidewalls 1044, 1046 formed of a shape-memory material, and a chamber shaping device 1100 configured to shape the flexible sidewalls 1044, 1046.

As shown in FIG. 62, the extruder chamber 1040 can have a top wall 1042, a flexible inner sidewall 1044 and a flexible outer sidewall 1046, and an inner volume 1041. The chamber shaping device 1100 can have a sheet-like structure, which can be disposed on an inner surface of the inner sidewall 1044 and an inner surface of the outer sidewall 1046 to conform to the shapes of the flexible inner sidewall 1044 and the flexible outer sidewall 1046.

The chamber shaping device 1100 can include any one or more of a heating device configured to heat the flexible inner sidewall 1044 and the flexible outer sidewall 1046, a cooling device configured to cool the flexible inner sidewall 1044 and the flexible outer sidewall 1046, and an electromagnetic device configured to apply an electromagnetic field to the flexible inner sidewall 1044 and the flexible outer sidewall 1046. When the chamber shaping device is actuated to apply heat, cooling, or the electromagnetic field to the flexible inner sidewall 1044 and the flexible outer sidewall 1046, the shapes of the flexible inner sidewall 1044 and the flexible outer sidewall 1046 change. Thus, the chamber shaping device 1100 can be actuated to control the shapes of the flexible inner sidewall 1044 and the flexible outer sidewall 1046 and thereby determine the shape of a section of a layer of print material printed by the extruder chamber 1040.

FIG. 63 depicts a view of wall bending or shaping device 1200 for bending or shaping a layer Lx of a print structure, according to an embodiment. As shown in FIG. 63, the wall bending or shaping device 1200 can be mounted to the housing 102 of a printing apparatus, and can include a first actuator 1202, a second actuator 1206, a first shaping arm member 1204, and a second shaping arm member 1208. The first and second actuators 1202, 1206 can be configured to selectively move the first and second shaping arm members 1204, 1208, respectively, in any one or more of the X, Y, and Z directions and thereby compress an uncured or partially cured section of the layer Lx between the first and second shaping arm members 1204, 1208 to form the uncured or partially cured section of the layer Lx in a desired shape.

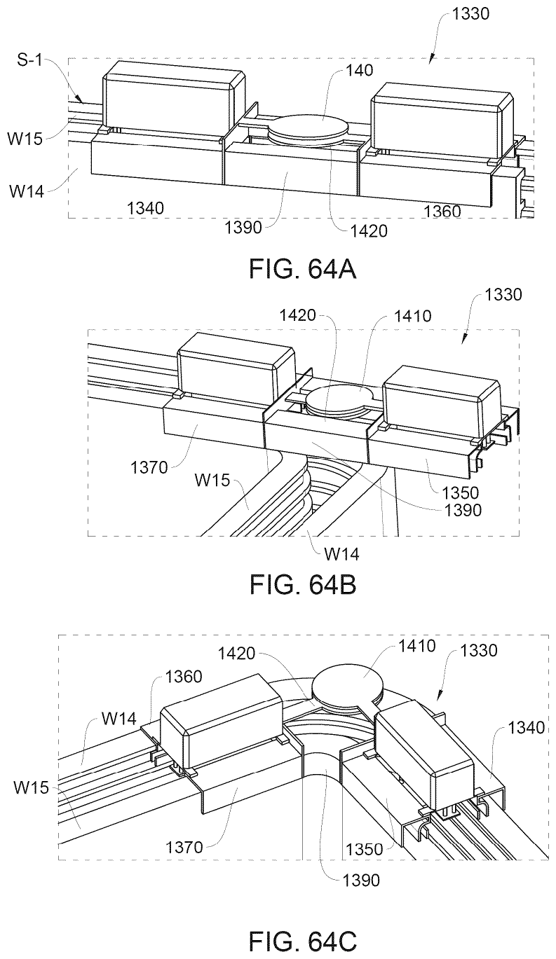

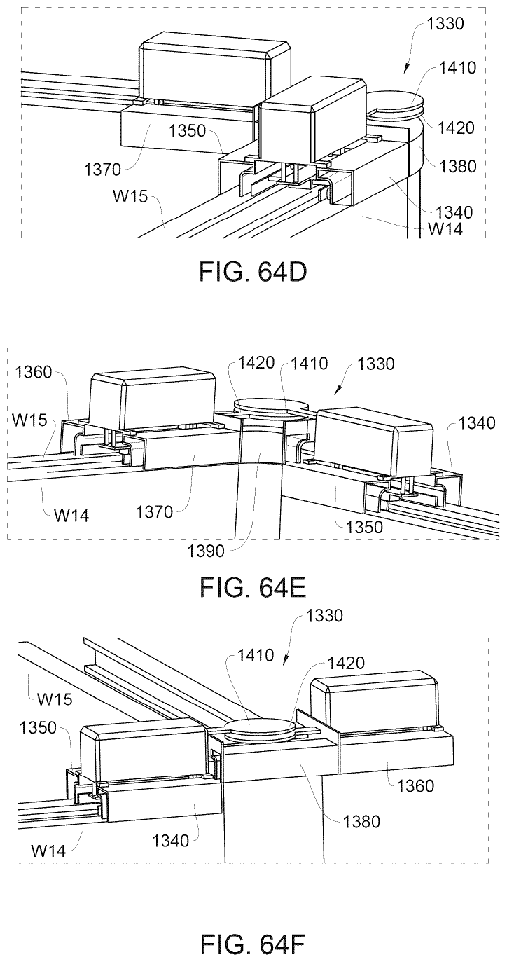

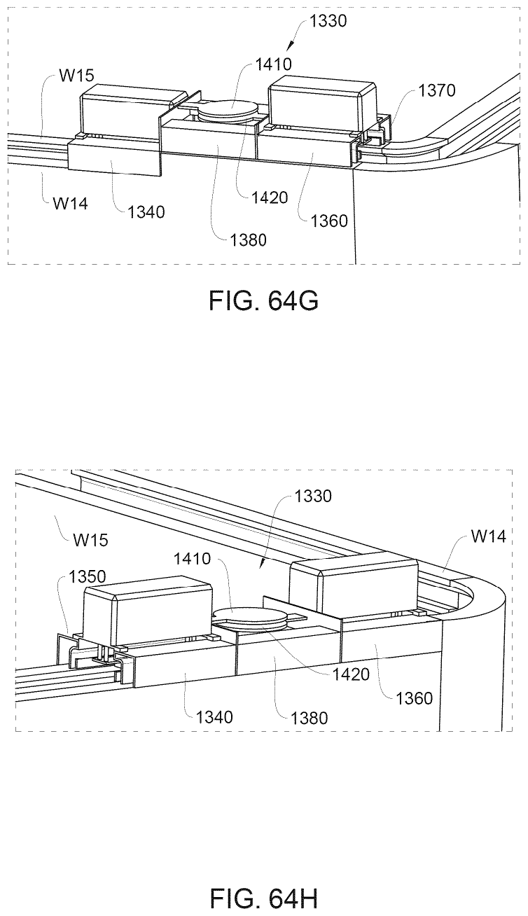

FIGS. 64A to 64H depict a printing assembly of a 3D printing apparatus (“printing apparatus”) printing a corner portion of a structure S-1, according to an embodiment.

Referring to FIGS. 64A to 64H, the printing assembly can include an extruder 1330. The extruder 1330 can include an outer front extruder chamber 1340, an inner front extruder chamber 1350, an outer rear extruder chamber 1360, an inner rear extruder chamber 1370, a flexible outer middle extruder chamber 1380, and a flexible inner middle extruder chamber 1390. The outer front extruder chamber 1340, the outer rear extruder chamber 1360, and the flexible outer middle extruder chamber 1380 are configured to print layers of an outer wall W14 of the structure S-1. The inner front extruder chamber 1340, the inner rear extruder chamber 1360, and the flexible inner middle extruder chamber 1390 are configured to print layers of an inner wall W15 of the structure S-1.

The print assembly can include a first base plate 1410 and a second base plate 1420. The outer front extruder chamber 1340 and the inner front extruder chamber 1350 can be fixed to the first base plate 1410, and the outer rear extruder chamber 1360 and the inner rear extruder chamber 1370 can be fixed to the second base plate 1420. A first end of the flexible outer middle extruder chamber 1380 can be fixed to the outer front extruder chamber 1340, and a second end of the flexible outer middle extruder chamber 1380 can be fixed to the outer rear extruder chamber 1360. A first end of the inner middle extruder chamber 1390 can be fixed to the inner front extruder chamber 1350, and a second end of the inner middle extruder chamber 1390 can be fixed to the inner rear extruder chamber 1370. The outer front extruder chamber 1340 and the outer rear extruder chamber 1360 can be separated from the flexible outer middle extruder chamber 1380 by sliding doors that can be selectively opened and closed to control material flow and maintain chamber integrity. The inner front extruder chamber 1350 and the inner rear extruder chamber 1370 can be separated from the flexible inner middle extruder chamber 1390 by sliding doors that can be selectively opened and closed to control material flow and maintain chamber integrity.

The first base plate 1410 and the second base plate 1420 are rotatably connected to each other, such that the first and second base plates 1410, 1420 can rotate with respect to each other about the vertical axis of the extruder 1330. Rotation of the first base plate 1410 causes the front extruder chamber 1340 and the inner front extruder chamber 1350 to rotate with the first base plate 1410, and rotation of the second base plate 1420 causes the outer rear extruder chamber 1360 and the inner rear extruder chamber 1370 to rotate with the second base plate 1420.

The flexible outer extruder chamber 1380 and the flexible inner middle extruder chamber 1390 are made of a flexible material. For example, flexible outer middle extruder chamber 1380 and the flexible inner middle extruder chamber 1390 can be made of a polymer or a rubber. Rotation of the first base plate 1410 and/or the second base plate 1420 causes the flexible outer middle extruder chamber 1380 and the flexible inner middle extruder chamber 1390 to bend or deform into curved and sharply-bent shapes, thereby enabling the flexible outer middle extruder chamber 1380 and the flexible inner middle extruder chamber 1390 to print the print material in curved or sharply-bent shapes, and particularly to print corner portions of respective walls. In some embodiments, the outer middle extruder chamber 1380 and the flexible inner middle extruder chamber 1390 can have accordion-shaped walls, allowing the outer middle extruder chamber 1380 and the flexible inner middle extruder chamber 1390 to also extend and contract in length.

As shown in FIG. 64A, during straight-wall printing, the outer front extruder chamber 1340, the outer rear extruder chamber 1360, and the flexible outer middle extruder chamber 1380 remain aligned in a substantially straight line to form a continuous extrusion path, and the inner front extruder chamber 1340, the inner rear extruder chamber 1360, and the flexible inner middle extruder chamber 1390 remain aligned in a substantially straight line to form a continuous extrusion path.

As shown in FIG. 64B, to initiate corner printing, the printing apparatus can shift its center of mass toward a rear of the apparatus and advance forward until the front of the outer rear extruder chamber 1360 and the front of the inner rear extruder chamber 1370 reach the ends of the last printed portions of the outer wall W14 and the inner wall W15, respectively. Alternatively, the printing apparatus can hold the outer rear extruder chamber 1360 and the inner rear extruder chamber 1370 fixed in position and allow the outer front extruder chamber 1340 and the inner front extruder chamber 1350 to rotate together about the vertical axis of the extruder 1330, independently with respect to the outer rear extruder chamber 1360 and the inner rear extruder chamber 1370.

Next, as shown in FIG. 64C, at the corners of the inner and outer walls W14 and W15, the outer front extruder chamber 1340 and the inner front extruder chamber 1350 can rotate together about the vertical axis of the extruder 1330 by an angle corresponding to the desired corner geometry, thereby causing the flexible outer middle extruder chamber 1380 and the flexible inner middle extruder chamber 1390 to deform and reposition accordingly. The transitions between the front extruder chambers 1340, 1350 and the flexible middle extruder chambers 1380, 1390, the transitions between the rear extruder chambers 1360, 1370 and the flexible middle extruder chambers 1380, 1390, and the transitions within the flexible middle extruder chambers 1380, 1390 may form a smooth, curved path or a sharply angled path, depending on the corner type and desired structural outcome.

Next, as shown in FIG. 64D, once the extruder 1330 is positioned as described above, the flexible outer middle extruder chamber 1380 and the flexible inner middle extruder chamber 1390 print the corner portion of the outer wall W14 and the corner portion of the inner wall W15, respectively. Additionally, the outer front extruder chamber 1340 and the inner front extruder chamber 1350 initiate printing of the next straight segment of the outer wall W14 and the inner wall W15, respectively.

Thereafter, as shown in FIGS. 64E and 64F, upon completing the corner portions, the flexible outer middle extruder chamber 1380, the flexible inner middle extruder chamber 1390, the outer rear extruder chamber 1360, and the inner rear extruder chamber 1370 can lift above the top surfaces of the outer and inner walls W14, W15, and can rotate about the vertical axis of the extruder 1330 to realign with the outer front extruder chamber 1340 and the inner front extruder chamber 1350 and match the next printing direction.

Next, as shown in FIGS. 64G and 64H, the printing apparatus can then resume forward motion for continued straight-wall printing, scaling the extruder 1330 down to the current layer height of the outer and inner walls W14, W15, once the outer rear extruder chamber 1360 and the inner rear extruder chamber 1370 have cleared the corners of the outer and inner walls W14, W15.

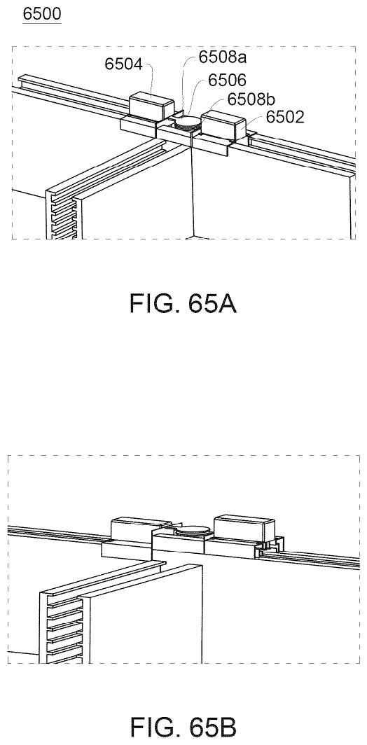

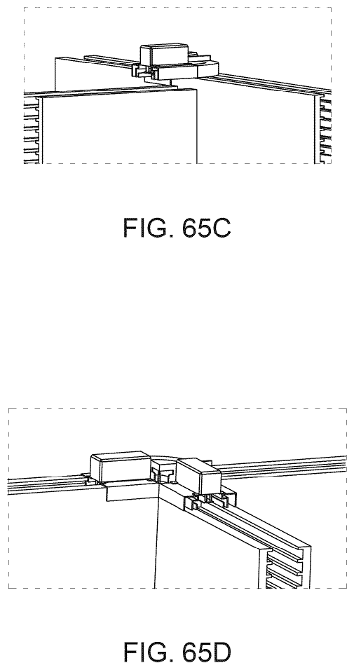

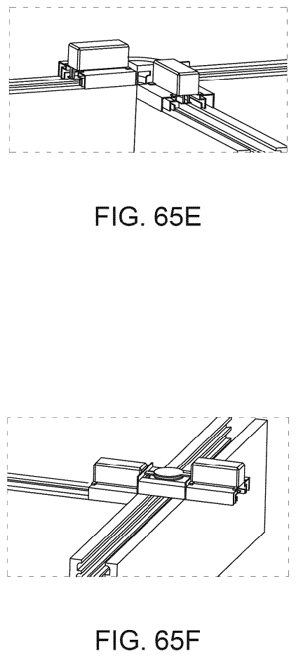

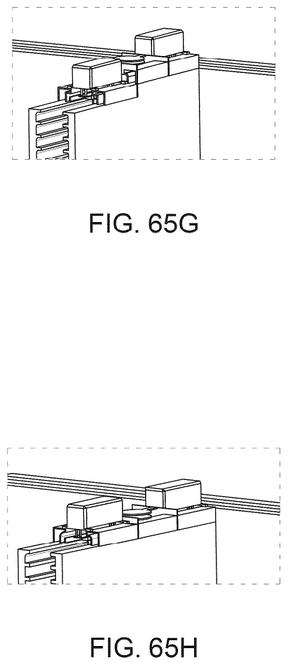

As shown in FIG. 65A, in some embodiments, an apparatus 6500 according to the present teachings can include a front rigid chamber 6502, a rear rigid chamber 6504, and an intermediate section 6506 connecting the two. The intermediate section 6506 may comprise either a flexible segment capable of smooth or angular deformation, or a non-permanent, accordion-style connection permitting controlled extension and directional adjustment between the front and rear chambers. Each chamber is separated from the intermediate section by a sliding door 6508a/6508b, which is configured to control print material flow during operation. To initiate internal wall printing, the apparatus first completes the perimeter of the external wall, facilitated by deposition of material in the inner and outer chambers via routine printing operations, then navigates to the designated starting point of the internal wall path. The apparatus then advances forward until the front edge of the rear chamber aligns with the internal wall starting location.

As shown in FIG. 65B, at this stage, the apparatus lifts both the inner and outer front chambers and the intermediate section vertically, thereby disengaging them from the current layer of the structure.

As shown in FIG. 65C, the middle section then rotates, adjusting the orientation of the front chambers to align with the intended direction of the internal wall path.

As shown in FIG. 65D, the front chambers are subsequently lowered to the appropriate height to initiate printing of the current layer of the internal wall.

As shown in FIG. 65E, following the initial deposition by the front chambers, the rear inner and outer chambers are elevated to align vertically with the middle section, preparing the apparatus for coordinated material extrusion along the internal wall path.

As shown in FIG. 65F, the middle section then rotates once more, bringing the front, middle, and rear chambers into alignment along the axis of the internal wall.

As shown in FIG. 65G, with the chambers aligned, the system advances forward while extruding, continuing to print the internal wall until the rear edge of the rear chamber reaches the terminal point of the internal path.

As shown in FIG. 65H, the middle and rear chambers are lowered to the active printing layer, and the apparatus resumes standard wall extrusion to complete the internal wall segment.

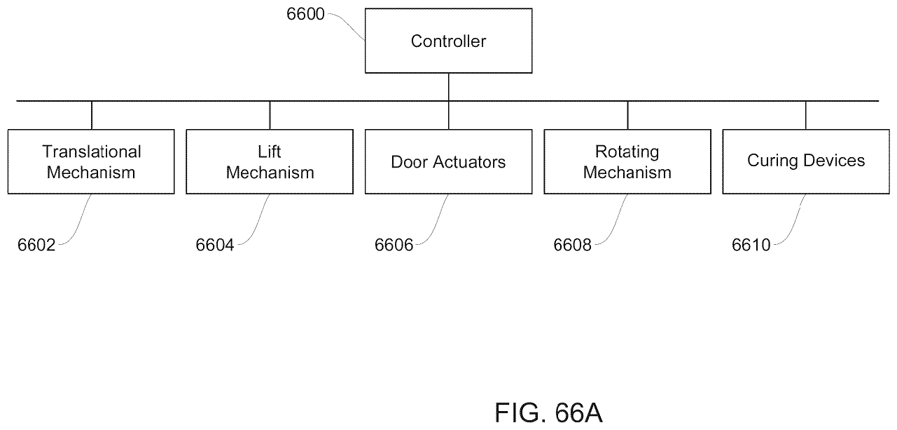

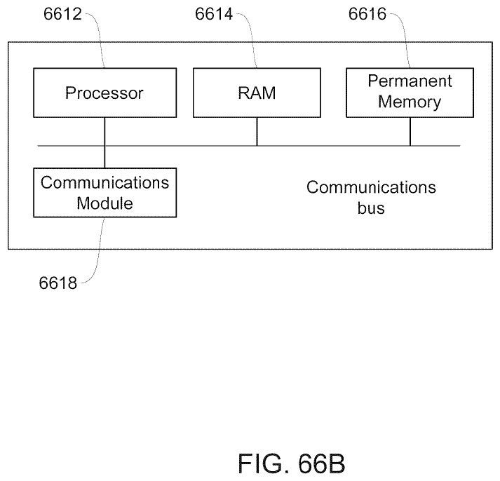

FIG. 66A is a schematic diagram illustrating a controller 6600 that is in communication with a translational mechanism 6602, a lift mechanism 6604, one or more door actuators 6606, a rotating mechanism 6608, and one or more curing devices 6610 for controlling operations thereof. More specifically, the controller 6600 can be programmed to effectuate deposition of the printing material in accordance with a desired pattern. For example, to do so, the controller 6600 can be configured to generate and send appropriate control signals to the components depicted in FIG. 66A to cause their activation/deactivation. For example, the controller 6600 can send control signals to the translational mechanism 6602 to cause the translation of the printing apparatus and also send control signals to one or more of the door actuators 6604 to open the doors so as to allow deposition of a layer of the printing material as the printing apparatus is translated. By way of example, in some implementations, the controller can cause the opening of the requisite extruder doors prior to causing the translation of the printing instrument while in other embodiments, the controller can cause the opening of the requisite extruder doors and the translation of the printing apparatus substantially concurrently. The controller can also send control signals to the one or more curing devices 6610 to activate those devices for curing the printing material, e.g., in a manner discussed above. By way of example, when the curing device includes UV light sources, the controller can send control signals to the UV light sources to cause their activation.

After a predefined length of the translation of the printing apparatus, the controller 6600 can send control signals to stop the translation of the printing apparatus and close the previously opened extruder doors. In some cases, the controller 6600 can then send control signals to cause the translation of the printing apparatus in a reverse direction as well as opening the opposed doors of the extruders to allow the deposition of the printing material as the printing apparatus moves in a reverse direction. Again, after a predefined length of translation in the reverse direction combined with the deposition of the printing material, the controller can send control signals to the translation mechanism to stop its movement and further send control signals to the door actuators to cause closing of the open extruder doors.

After completion of the deposition of printing material in one layer, the controller 6600 can send control signals to the lift mechanism 6604 to cause lifting of the printing apparatus to configure the printing apparatus for deposition of the printing material over a previously printed layer. By way of example, the lift mechanism 6604 can be implemented in a manner discussed above.

As noted above, in various embodiments, a printing device according to the present teachings can include a mechanism for rotating the extruder(s) so as to allow the deposition of the printing material around corners. In such embodiments, the controller 6600 can be also in communication with the rotating mechanism 6608 to trigger the mechanism to rotate the extruder(s) by a predefined angle to allow the deposition of the printing material around corners.

In various embodiments, the controller 6600 can be implemented in hardware, firmware and/or software using known techniques as informed by the present teachings. FIG. 66B illustrates an example of an implementation of the controller 6600, which includes a digital processor 6612 for executing instructions stored in a permanent memory 6616 for deposition of the printing material according to a predefined pattern. In this example, the controller 6600 further includes a random access memory (RAM) 6614, a communications module 6618 for communicating, e.g., for transmitting control signals, with various components of the printing apparatus, and a communications bus that allow the processor to communicate with other components of the communications module 6618.

In use, instructions for printing a desired structure can be stored in the permanent memory 6616. By way of example, such instructions can provide a pattern of deposition of a printing material so as to form the desired structure. In some embodiments, the controller can generate control signals based on the deposition pattern and transmit the control signals to the printing instrument.

Another disclosed implementation is a translational slipform 3D printing device capable of constructing walls of various configurations. This implementation operates through a controlled coordination of fixed and movable formwork structures, precise material flow, and multi-axis locomotion.

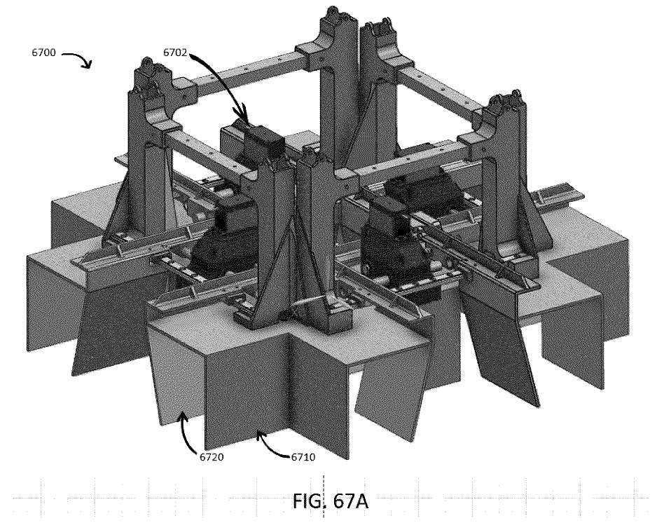

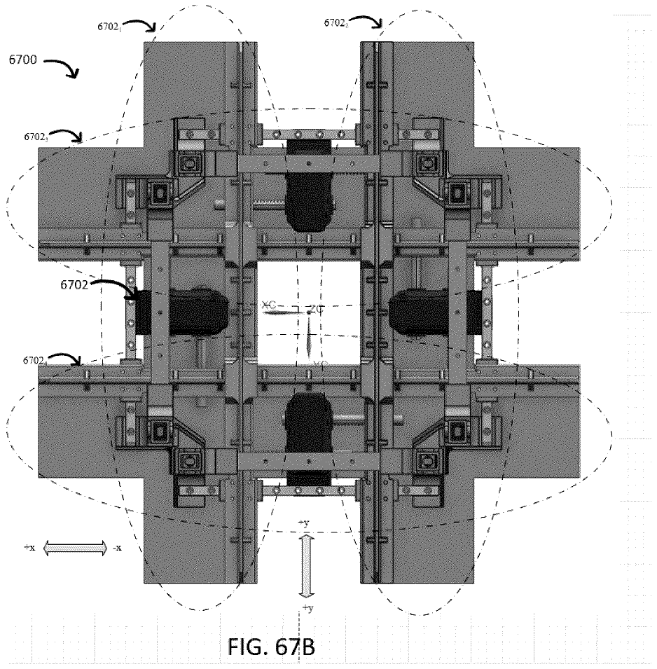

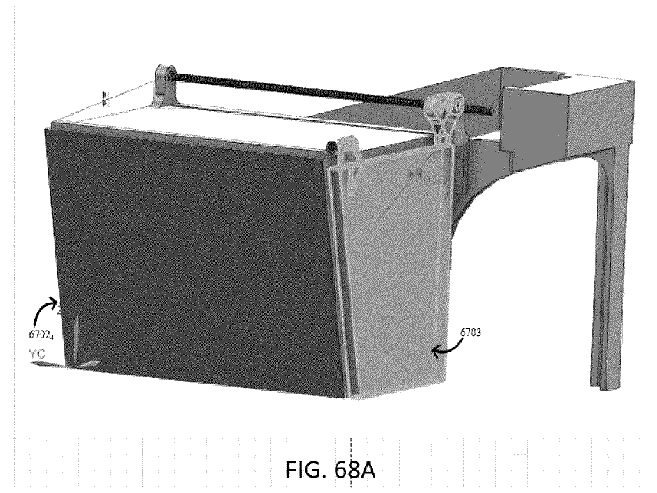

As illustrated in FIG. 67A and FIG. 67B, the printing device 6700 is configured to receive one or more types print material from one or more material supply mechanisms and form a structure from the print material(s). Printing device 6700 includes a formwork system comprising four forms (6702₁, 6702₂, 6702₃ and 6702₄ shown in FIG. 67B) for defining walls (also referred to as “wythes” herein). In masonry construction, a “wythe” refers to a continuous vertical section of masonry, such as a wall, that is one unit thick. Multiple wythes can be built side by side to form a thicker, multi-wythe structure, such as a wall.

Each form is indicated in the drawing by a dotted line in FIG. 67B. Note that the forms overlap one another and are configured and used for printing in pairs as described in detail below. The disclosed implementation illustrated in FIGS. 67A and 67B selectively leverage the four forms (6702₁, 6702₂, 6702₃ and 6702₄) for defining walls that include 2 wythes (W1 and W2) as shown in FIG. 1. Forms 6702_{1 and} 6702₂ are generally used in tandem to form a wythe when the printer 6700 is moving in the +y or −y direction (indicated by arrows in FIG. 67B and forms 6702_{3 and} 6702₄ are generally used in tandem to form a wythe when the printer 6700 is moving in the +x or −x direction (indicated by arrows in FIG. 67B).

Each form 6702₁, 6702₂, 6702₃ and 6702₄ includes outer formwork structures 6710 that define the external surface of the wythe being printed, and dynamic inner formwork structure 6720 that define the inner surface of a wythe being printed. The inner formwork structures are movable with respect to the outer formwork structures to transition between an “engaged/proximal state” for shaping the desired wythe and an “disengaged/remote state” in which they retract to create crucial clearance, as described in detail below.

The disengaged/remote state allows the printer 6700 device to reconfigure itself during corner printing operations, ensuring that the inner formwork avoids contact with the freshly printed inner wythes, as described in greater detail below. The position of the inner formwork structures are each independently caused by movement mechanisms 6702 individually coupled to the inner formwork structures. The movement mechanisms can include servos, motors, or other driving mechanisms. These mechanisms facilitate both horizontal movement between the engaged and disengaged states and vertical movement, allowing the inner formwork to ascend to a “clearance level” above the printed layer or return to a “base level” for active printing, also described in greater detail below. Specialized clearance grooves within the X-direction inner formwork enable the Y-direction inner formwork to move and rise without interference. Alternatively, or in combination the movement described above, the inner formwork structures can each be rotated about the top edge thereof to reduce the angle of the inner formwork structures with respect to the outer formwork structures to allow for clearance when the device scales up a layer.

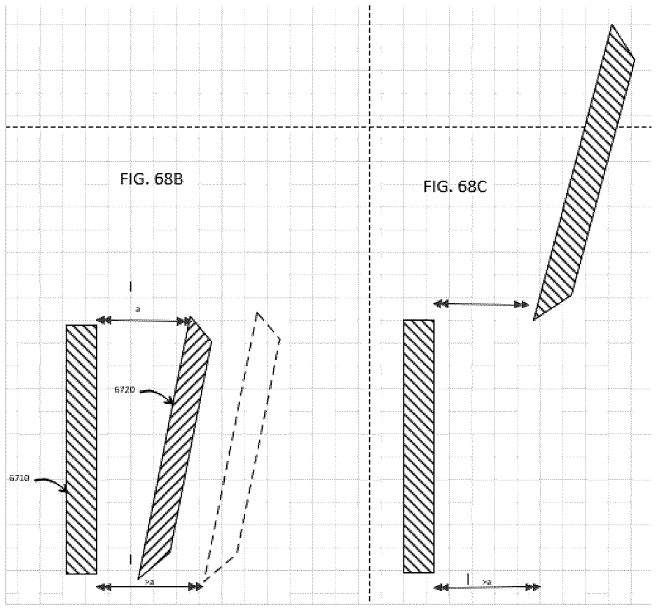

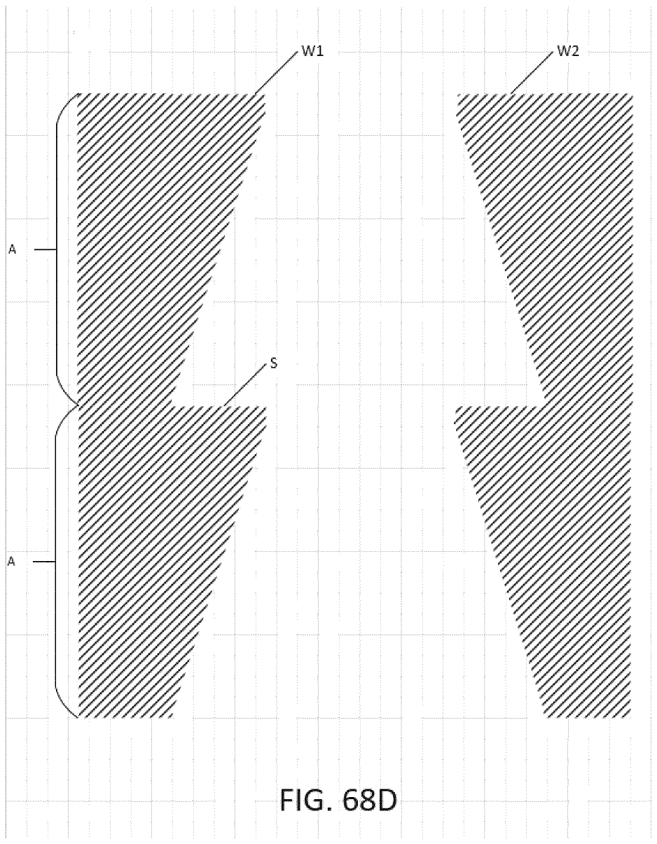

Integrated within chambers defined by the forms are a series of internal doors for directing the flow of printing material. These doors, which can operate via various mechanisms such as swinging hinges, tambour systems, sliding tracks, or motorized pathways, precisely control which sections of the wall receive material. Their “closed” position allows them to redirect material flow at the formwork level, while an “open” position allows material to flow substantially in a substantially unobstructed manner. Effective sealing, using gaskets, compression seals, or magnetic seals, can be provided to prevent any material leakage when these doors are closed, ensuring clean and accurate wall formation. FIG. 68A shows a portion of a chamber defined by a form with a door 6703 mounted on a hinge to be moved between the open and closed position. In FIG. 68A, the door 6703 is shown in a closed position whereby the door obstructs the flow of material through the form.

As shown best in FIGS. 68A and 68B, the cross of each form is trapezoidal in shape (i.e., it defines a four-sided geometric figure (a quadrilateral) that has exactly one pair of parallel sides (the top and bottom in FIG. 68B). This configuration permits wheels or other support elements of the printer 6700 to rest on a top portion of a lower level when printing. Specifically, as shown in FIG. 68D, which shows the cross section of an outer wythe W1 and an inner wythe W2 printed by the printer, with levels of printing, Level A and Level B. It can be seen that the cross sectional shape of the forms results in a substantially horizontal surface/step S being formed on the internal side of each wythe for supporting wheels or other guide mechanisms of the printer 6700. Alternatively, instead of a trapezoidal shape, internal lips can be created via a lip section added onto a rectangular cross-section. Various cross-sectional shapes can be formed on or in the wythes to create an inner lip, ledge, and/or track for the device to ride along. In another implementation, an internal lip/track on the wall is not required. Instead, the printer can grip the wall to locomote, with the wall exerting an inward pressure on the wheels or other guides.

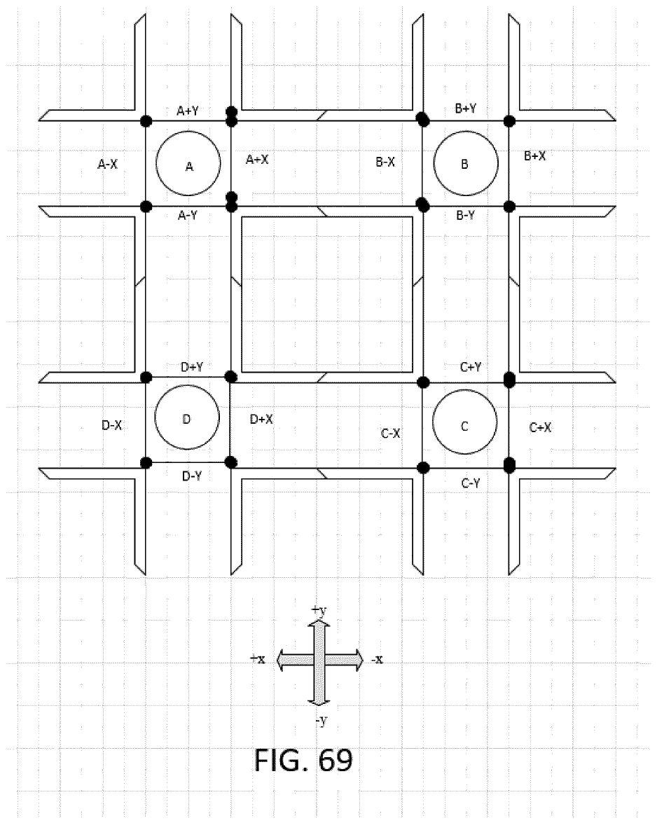

As noted above, in this implementation, the doors are internal to the chambers, which are themselves created by the interplay of the outer formwork structures and the inner formwork structures. As shown in FIG. 69, there are four primary material feed locations, labeled ‘A’, ‘B’, ‘C’, and ‘D’. Surrounding each of these material feed locations are directional doors. For instance, at location ‘A’, there are doors designated ‘A+X’, ‘A−X’, ‘A+Y’, and ‘A−Y’, which control material flow in the corresponding positive/negative X and Y directions relative to that feed point. This arrangement creates a grid-like network of controllable barriers within the formwork. Each of the doors is capable of transitioning between a “closed/engaged” position and an “open/disengaged” position. When closed, a door is positioned at the formwork level, effectively acting as a barrier or guide to redirect material flow. In one example, these doors slide from the Z-direction into place. When open, a door is moved to allow material to flow freely past it without substantially obstructing the flow of material. The movement of the doors can be achieved through various mechanisms, including:
Hinge Style: Doors may swing on hinges to their desired locations.
Tambour Mechanism: Doors can roll out into place.
Sliding Track: Doors can follow a sliding track
Mechanistic Path: More complex movements can be achieved via motors, servos, linear actuators, or hydraulics.

The selective activation (engagement and disengagement) of these doors, in conjunction with the dynamic inner formwork, allows for the precise definition of the forms, or channels, through which print material flows to create wythes.

For example, during printing of a wall while moving in the −X direction printing doors are engaged and disengaged such that an enclosed set of parallel forms in the X-direction 6702₃ and 6702₄ (See FIG. 67B) are created to create the first section of one layer of a wall, having two distinct wythes, in the X-direction. By selectively engaging certain doors to act as internal dividers and disengaging others to allow material flow, in combination with selective control of material flow through the material ports, the device can create multiple, distinct channels or voids within a single printed layer. This capability is fundamental to constructing walls with specific cross-sections, such as those with air gaps for insulation, internal conduits, or multi-layered structural elements, which are effectively different wythes. The precise control over material flow paths, achieved through the selective activation of these internal doors, ensures that the desired formwork geometry for each wythe is maintained as material is deposited.

An example of the operational precision provided by this implementation is a corner printing sequence, which involves a dynamic orchestration of material flow and formwork movement. In such a sequence, initially, material flows from all four locations to establish the first wall layer (constating of two wythes in this example. As the device prints in a specific direction (e.g., −X), some material feeds cease, and doors adjust to allow continuous travel while material sets. Upon reaching the corner, specific material feeds activate, and doors configure to deposit a sharp 90-degree corner layer. Following this, a complex sequence of inner formwork disengagement, inward movement, and vertical repositioning occurs in both X and Y directions, creating necessary clearances. The device then translates, and the formwork returns to its printing height, culminating in the inner formwork re-engaging to prepare for the next printing direction (e.g., +Y). This multi-step process allows the device to seamlessly transition between straight and corner printing.

A specific example of a corner printing process in accordance with disclosed implementations will now be described in detail. Note that, in the following FIGURES, active material ports are designated by a circle. Lack of a circle indicates that the material port is not active. An active material port is a material port through which material is being fed. The active and non-active status of the material ports can be controlled by doors, valves, pump control, or any other mechanism for selectively allowing material to flow through the ports. Also, note that, at the bottom of each FIGURE, a top view representation of the printed wall is provided to demonstrate the result of each step of printing.

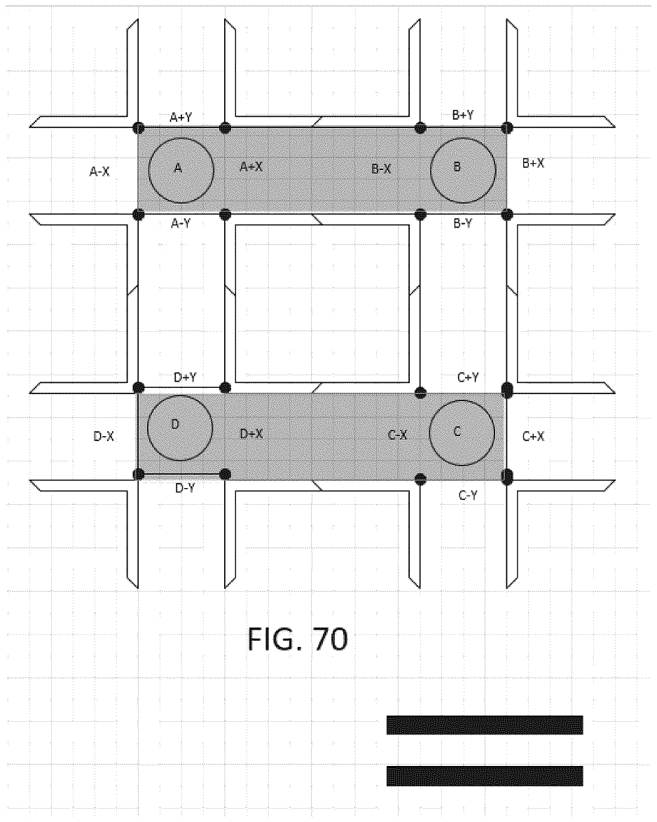

At Step 1, the printer 6700 is configured as shown in FIG. 70 and described below: Print Commencement for −X direction printing
Location A
   Material Feed at A: Active
   Door A+X: Disengaged
   Door A−X: Engaged
   Door A+Y: Engaged
   Door A−Y: Engaged
Location B
   Material Feed at B: Active
   Door B+X: Engaged
   Door B−X: Disengaged
   Door B+Y: Engaged
   Door B−Y: Engaged
Location C
   Material Feed at C: Active
   Door C+X: Engaged
   Door C−X: Disengaged
   Door C+Y: Engaged
   Door C−Y: Engaged
Location D
   Material Feed at D: Active
   Door D+X: Disengaged
   Door D−X: Engaged
   Door D+Y: Engaged
   Door D−Y: Engaged
   Inner form X: Engaged
Inner form X, Vertical Level: Base level
Inner form Y: Engaged
Outer form+Inner form Y, Vertical Level: Base level
Locomotion: Not active

During Step 1, material is flowing into the chambers from all four material feed locations while the printer is in a stationary position. Doors are engaged and disengaged such that an enclosed set of parallel forms in the X-direction (indicated by shading in FIG. 70 are created to create the first section of one layer of the wall in the X-direction (as indicated by a tope view of the wall at the bottom of FIG. 70.

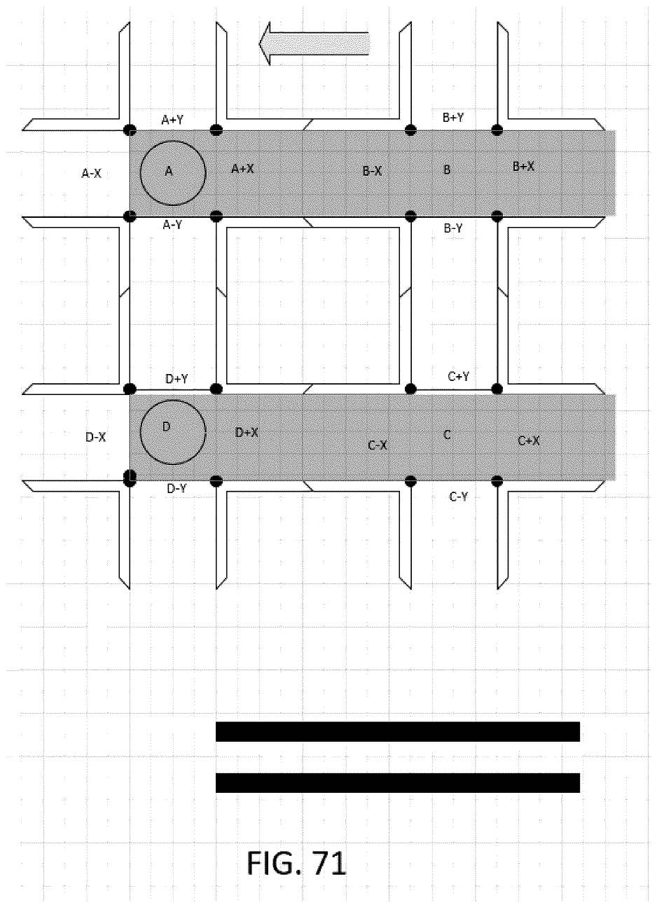

At Step 2, the printer 6700 is configured as shown in FIG. 71 and described below: Step 2: Printing in the −X direction
Location A
   Material Feed at A: Active
   Door A+X: Disengaged
   Door A−X: Engaged
   Door A+Y: Engaged
   Door A−Y: Engaged
Location B
   Material Feed at B: Not active
   Door B+X: Disengaged
   Door B−X: Disengaged
   Door B+Y: Engaged
   Door B−Y: Engaged
Location C
   Material Feed at C: Not active
   Door C+X: Disengaged
   Door C−X: Disengaged
   Door C+Y: Engaged
   Door C−Y: Engaged
Location D
   Material Feed at D: Active
   Door D+X: Disengaged
   Door D−X: Engaged
   Door D+Y: Engaged
   Door D−Y: Engaged
Inner form X: Engaged
Inner form X, Vertical Level: Base level
Inner form Y: Engaged
Outer form+Inner form Y, Vertical Level: Base level
Locomotion: Active, −X direction of travel

During Step 2, material flows into the chambers from the A and D material feed locations and the B+X and C+X doors have opened to allow for the device to travel in the −X direction. As the device travels in the −X direction, the deposited material that is left behind acts as a blockage for material filling the cavities being created in the A and D region, allowing material to continuously fill and set within the chambers.

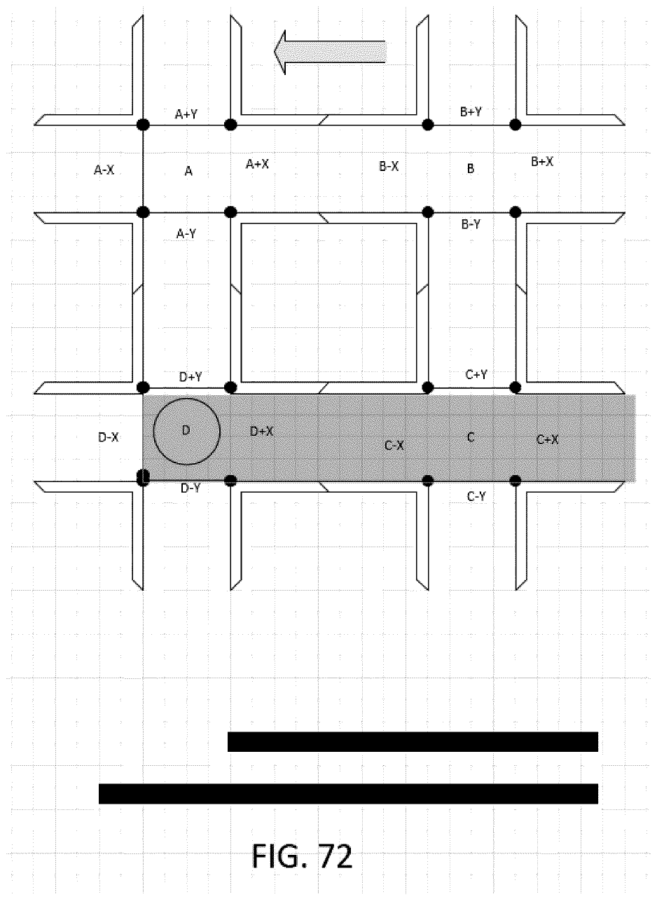

At Step 3, the printer 6700 is configured as shown in FIG. 72 and described below: Step 3: Flow stops in +Y chamber while printing continues.
Location A
   Material Feed at A: Not active
   Door A+X: Disengaged
   Door A−X: Engaged
   Door A+Y: Engaged
   Door A−Y: Engaged
Location B
   Material Feed at B: Not active
   Door B+X: Disengaged
   Door B−X: Disengaged
   Door B+Y: Engaged
   Door B−Y: Engaged
Location C
   Material Feed at C: Not active
   Door C+X: Disengaged
   Door C−X: Disengaged
   Door C+Y: Engaged
   Door C−Y: Engaged
Location D
   Material Feed at D: Active
   Door D+X: Disengaged
   Door D−X: Engaged
   Door D+Y: Engaged
   Door D−Y: Engaged
Inner form X: Engaged
Inner form X, Vertical Level: Base level
Inner form Y: Engaged
Outer form+Inner form Y, Vertical Level: Base level
Locomotion: Active, −X direction of travel

During Step 3, material flow stops at Location A while it continues at location D, allowing the bottom part of the corner to continue to be printed. The device continues to travel and deposits material until the edge of the deposited material on the A-C upper formwork section reaches the B−X door, as shown at the bottom of FIG. 72.

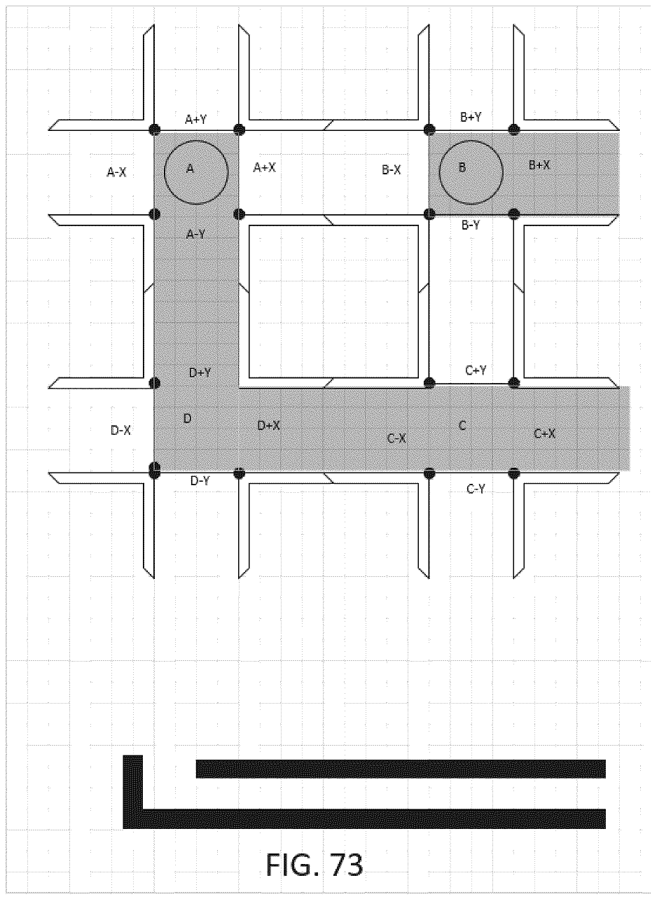

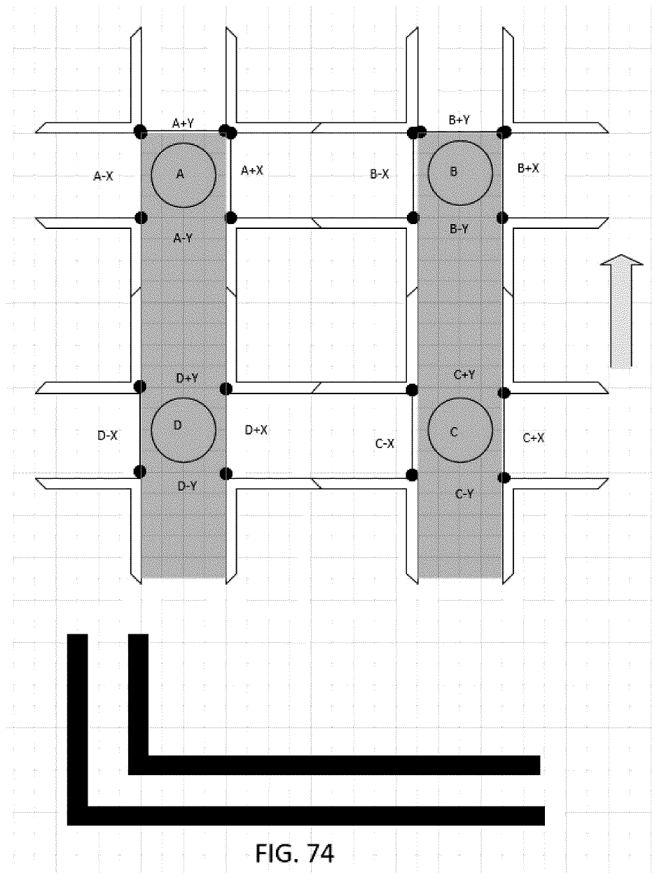

At step 4, the printer 6700 is configured as shown in FIG. 73.
Step 4: Corner reached, and corner printing commences
Location A
   Material Feed at A: Active
   Door A+X: Engaged
   Door A−X: Engaged
   Door A+Y: Engaged
   Door A−Y: Disengaged
Location B
   Material Feed at B: Active
   Door B+X: Disengaged
   Door B−X: Engaged
   Door B+Y: Engaged
   Door B−Y: Engaged
Location C
   Material Feed at C: Not active
   Door C+X: Disengaged
   Door C−X: Disengaged
   Door C+Y: Engaged
   Door C−Y: Engaged
Location D
   Material Feed at D: Not active
   Door D+X: Disengaged
   Door D−X: Engaged
   Door D+Y: Disengaged
   Door D−Y: Engaged
Inner form X: Engaged
Inner form X, Vertical Level: Base level
Inner form Y: Engaged
Outer form+Inner form Y, Vertical Level:: Base level
Locomotion: Not active

During Step 4, material flows into Locations A and B, with appropriate doors engaged and disengaged to ensure that a sharp 90-degree corner layer is deposited.

At Step 5, the printer is configured as shown in FIG. 74.
Location A
   Material Feed at A: Not active
   Door A+X: Disengaged
   Door A−X: Disengaged
   Door A+Y: Disengaged
   Door A−Y: Disengaged
Location B
   Material Feed at B: Not active
   Door B+X: Disengaged
   Door B−X: Disengaged
   Door B+Y: Disengaged
   Door B−Y: Disengaged
Location C
   Material Feed at C: Not active
   Door C+X: Disengaged
   Door C−X: Disengaged
   Door C+Y: Disengaged
   Door C−Y: Disengaged
Location D
   Material Feed at D: Not active
   Door D+X: Disengaged
   Door D−X: Disengaged
   Door D+Y: Disengaged
   Door D−Y: Disengaged
Inner form X: Disengaged
Inner form X, Vertical Level: Base level
Inner form Y: Engaged
Outer form+Inner form Y, Vertical Level: Base level
Locomotion: Not active

In this step, material flow is stopped (i.e. all material ports are not active) and a direction transition sequence begins. First the X direction inner form structures move inward to disengage from the printed material, creating clearance. As shown in FIG. 68B, the inner form structures 6720 of the X direction forms move inward from the position shown in black to the positions shown by the dotted line. Note that the inner form structures move to create a distance between the lower edge of the inner form structures 6720 and the printed material and is at least large enough to permit the Inner form structures to be moved upward without interference by the printed material. Next, the X direction inner form structures are moved upward (in the Z direction) to a position that places the entirety of the inner form structures above the top of the printed material, as shown in FIG. 68C.

At Step 6, the inner form structures in the Y-direction forms move inwards. During this step the Y direction inner form structures move inward to disengage from the printed material, creating clearance. As shown in FIG. 68B, the inner form structures 6720 of the Y direction forms move inward from the position shown in black to the positions shown by the dotted line. Note that the inner form structures move to create a distance between the lower edge of the inner form structures 6720 and the printed material that is as least large enough to permit the inner form structures to be moved upward without interference by the printed material. Next, the Y direction inner form structures are moved upward (in the Z direction) to a position that places the entirety of the inner form structures above the top of the printed material, as shown in FIG. 68C.

At Step 7, all of the inner form structures and the rigid outer formwork move up to Level 2 while the inner form X vertical distance to the outer formwork is kept constant, so this forms effectively moves to Level 3. In step 8, the entire printing device 6700 translates in the +Y direction as shown by the arrow in FIG. 73 During this step, the device translates in the +Y direction given there is now sufficient clearance between the formwork and the previously deposited layer. The device translates to the point where the D−Y door is at the end of the material that was making contact with the A+Y door.

At Step 8 the framework structures return to the printing height. The inner form Y and the outer formwork return to the base level while the inner form X returns to level 2. Subsequently, the Y inner form structure engages to create sufficient clearance for the inner form X to come back to base level. Next, the X inner form structure returns to the base level. Finally, the X inner form structure engages, i.e. moves to the position in which the X Form is defined. All formwork structures now in the appropriate orientation to commence with printing in the +Y direction once appropriate doors engage.

At Step 9 the doors are configured and material flow is directed to allow for +Y printing.
Location A
   Material Feed at A: Active
   Door A+X: Engaged
   Door A−X: Engaged
   Door A+Y: Engaged
   Door A−Y: Disengaged
Location B
   Material Feed at B: Active
   Door B+X: Engaged
   Door B−X: Engaged
   Door B+Y: Engaged
   Door B−Y: Disengaged
Location C
   Material Feed at C: Active
   Door C+X: Engaged
   Door C−X: Engaged
   Door C+Y: Disengaged
   Door C−Y: Disengaged
Location D
   Material Feed at D: Active
   Door D+X: Engaged
   Door D−X: Engaged
   Door D+Y: Disengaged
   Door D−Y: Disengaged
Inner form X: Engaged
Inner form X, Vertical Level: Base level
Inner form Y: Engaged
Inner form Y, Vertical Level: Base level
Locomotion: Not active

During this step, the appropriate doors engage and material flows through all four material input locations to deposit material in the formwork to start the +Y direction printing layer, as shown in FIG. 74.

Now that a corner has been formed, as shown in FIG. 74, printing can continue in the +Y direction with the device configured as shown in FIG. 74.

Separate onboard reservoirs can contain the same or different materials, which can be selectively delivered through ports A, B, C, and D. This selection can be achieved through mechanisms such as a selector nozzle, a turret set of nozzles allowing for material toggling, or coaxial/concentric nozzles that enable layered deposition of distinct materials. Dedicated material transmission lines can be controlled by, for example, motorized ball valves. To prevent cross-contamination, a sophisticated purging system can flush the lines with a purge material, which can be automated and sensor-triggered. Material delivery can be precisely managed by positive displacement pumps and monitored by an array of sensors, including flow meters, pressure transducers, and temperature controls, all governed by, for example, PID control algorithms.

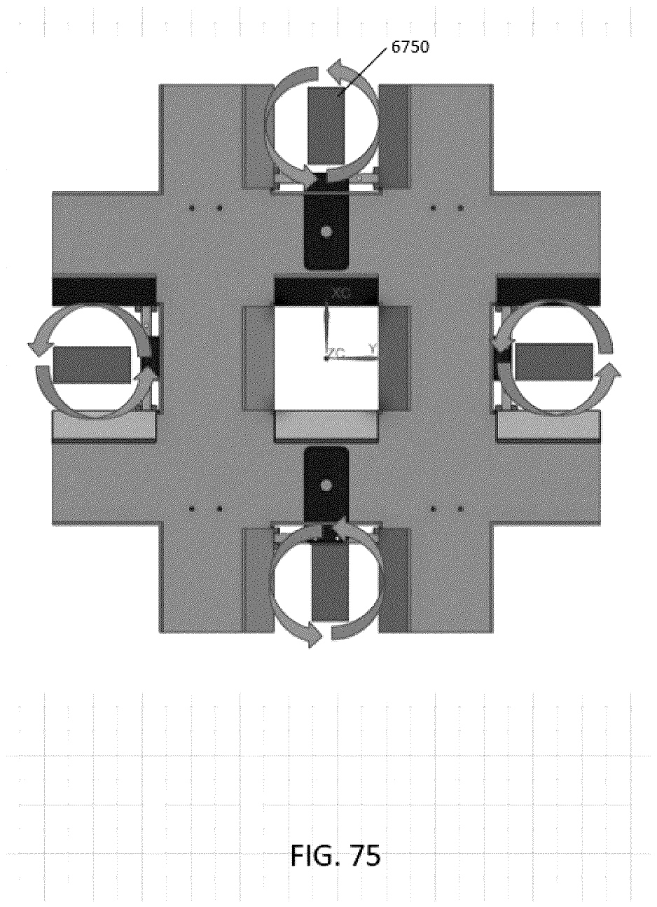

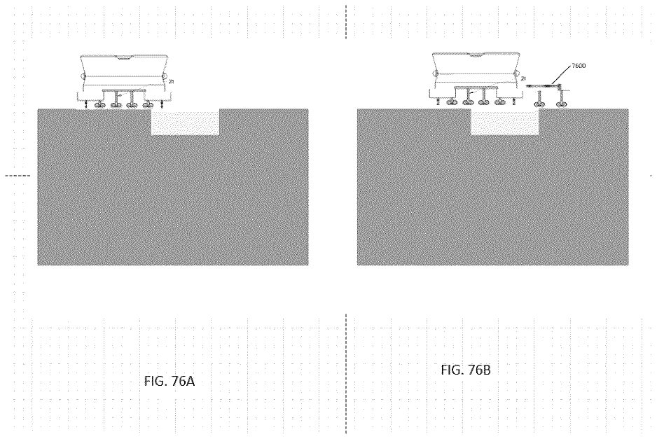

The locomotion system of printer 6700 enables translational movement across the X-Y plane and vertical movement along the Z-axis for layer-by-layer construction (in a manner similar to that described above with respect to other implementations. This movement is achieved through various wheel types (e.g., omnidirectional, mechanism, swerve drive) or track modules, driven by motors with diverse coupling methods. Four example, four individually controlled wheels 6760 capable of rotating along their central axis for X-Y plane translation can be provided as shown in FIG. 75 Control of the locomotion system can leverage advanced algorithms, from open-loop to closed-loop feedback systems utilizing a suite of sensors (encoders, IMU, GPS, LiDAR, cameras) and can incorporate machine learning policies for autonomous operation. Additional wheels can be used to make the device more stable. Various wheels, drive mechanisms and support structures can be applied for stable locomotion. Further, stabilization wheels/support structures could also be disposed on the outside of the forms and/or clamped against the outside of the wythes or otherwise attached to the wythes.

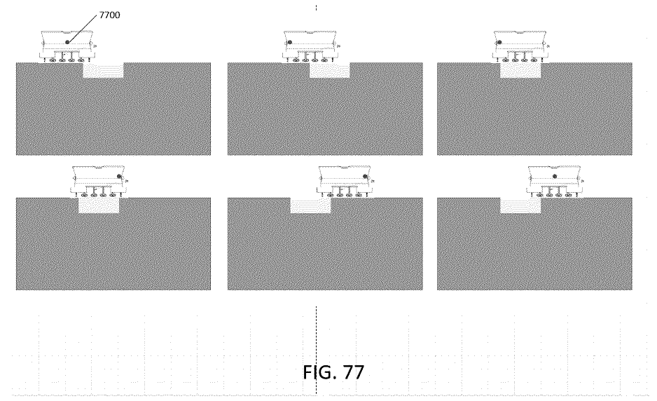

This disclosed implementations also provide sophisticated fenestration printing capabilities, allowing for the creation of openings within walls for windows, doors, vents, and the like. In one example, a track extension mechanism can be provided in printing device 6700. As shown in FIGS. 76A and 76B, the track extension mechanism can include a cantilever support 7600 that is extended from the printer before or during a pass of the printer over a fenestration. Of course, the fenestration can be defined by an area in one more lower levels in which printing was stopped as the printer passed over the area. The track extension mechanism allows the printer to bridge gaps, as shown in FIGS. 76A AND 76B, ensuring continuous support while material flow is paused. Alternatively, a sufficiently long printing device can maintain its center of gravity over printed material even while spanning an opening, optionally with a movable mass 7700 to adjust the center of gravity as shown in FIG. 77. Further, various mechanisms for gyroscopic stabilization can be used to balance the printer.

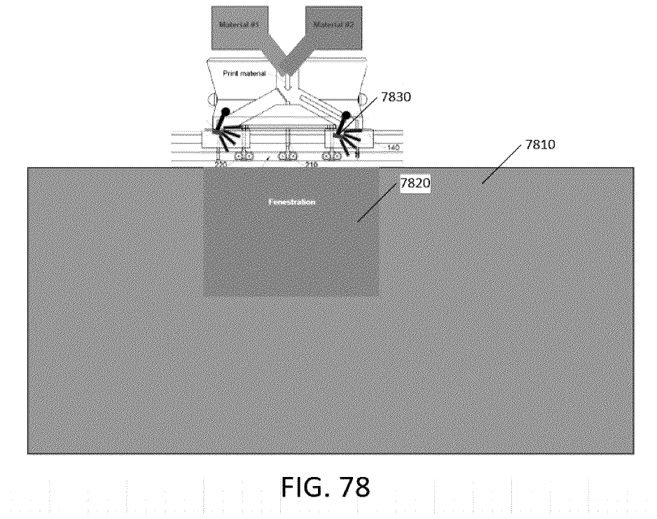

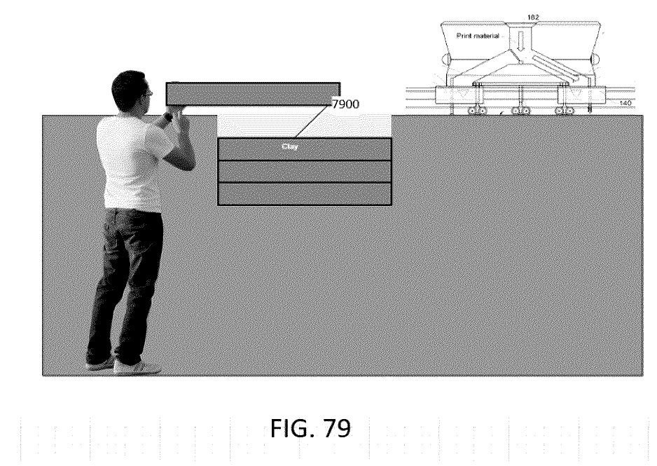

As illustrated in FIG. 78, another example of a method for printing fenestration can include toggling between primary wall material 7810 and a specialized filler material 7820 (e.g., spray polyurethane foam, gypsum) during a printing operation. The filler material 7820 can be used for printing in a selective manner to temporarily fill the fenestration gap, providing structural support until the load-bearing wall material cures. A material purge system, including brushes 7830 or the like, can be provided for use before and after the material transition. Alternatively, manual insertion of modular blocks 7900 or filler material, connected by various mechanical means, can also provide support for printing around fenestrations, as shown in FIG. 79. Another implementation includes a manual or automated jack system that has a lintel on top of it that provides the “track” for the device to move over, raising up to the next layer when the device comes back around to the fenestration at the next layer height. These methods ensure that the device can successfully print over openings, with specific mechanisms for bridging gaps and forming the top layer of the fenestration.

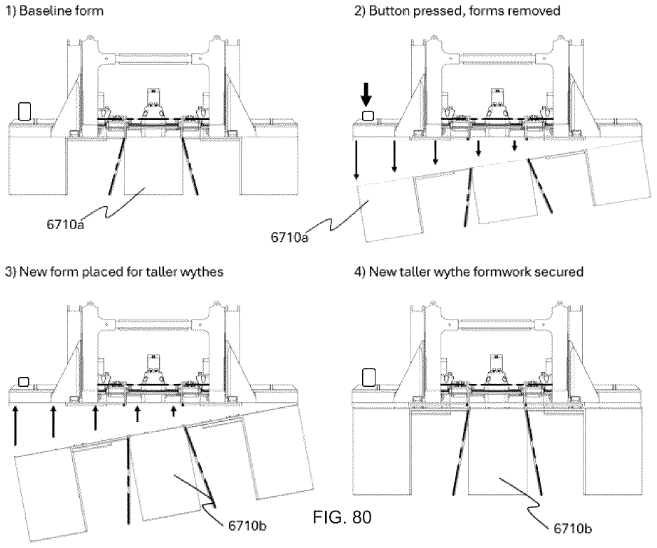

In disclosed implementations, the formwork can be modular. Modular formwork structures can be swapped in via quick-release latches, magnetic couplings, or rail systems, enabling the construction of diverse geometries, including various corner angles and curved wall sections, with specific spline capabilities. For example, as shown in FIG. 80 the formwork structures can be swapped out if the desired wall cross-section changes. For example. A button is clicked that unlatches the forms, allowing an operator to swap a 6″ form height formwork structure 6710a (for an 8″ form height formwork structure 6710b. This can be accomplished manually automatically by a mechanism that swaps formwork structures in and out. These modules can also integrate electrical and data coupling for vibrators, sensors, or other mechanisms. This modularity not only simplifies maintenance but also greatly enhances the design flexibility of the structures. In some cases, these modular pieces can be manually swapped.

Modular formwork pieces can be utilized to achieve desired corner angles, straight wall sections, and varying curves wall sections, with specific and adjustable wall splines possible. In some implementations, the formwork can include mechanisms incorporated therein for vibration, sensing, wall smoothing, material flow, or other actions. Electrical and data coupling may be incorporated into the modules via pogo pins and contact pads, magnetically aligned electrical connectors, docking plates, multi-pin blocks, inductive coupling, optical/infrared links, or via Bluetooth/wireless modules. These formwork modules may be swapped into and out of the device manually via human intervention, swapped via a separate robotic device, or swapped via internal mechanisms and storage systems that hold rigid formwork pieces or assemble modular pieces of formwork within the device.

The printer locomotion described above can be achieved based on an inner set of mechanisms that are coupled to a vertically extending system, enabled through linear actuators, hydraulics, or other means for vertical motion. The locomotion devices can be track systems, wheels, mecanum wheels (a type of omnidirectional wheel that feature angled rollers attached around the circumference), or other devices, with these allowing for translation in the X and Y plane.

One implementation consists of at least 2 wheels that may be any combination of straight wheels, caster wheels, differential drive wheels, ackerman steering wheels, skid-steer wheels, omnidirectional wheels, mecanum wheels, swerve drive wheels, rubber tread wheels, foam wheels, spiked wheels, inflatable wheels, or hybrid wheels with suspension spokes. Other implementations may have continuous track modules driven by a belt or chain, spherical wheels, ball caters, or universal ball drives, or any combination of these locomotion types. These wheels and locomotion methods may be driven by direct drive (motor-to-wheel) control via hub motors that are brushed or brushless, motor shaft coupling via brushed or brushless motor, gear reduction driven via a spur gear drive or planetary gearbox, timing belt driven, roller chain and sprocket driven, shaft and axle driven, differential gear drive driven, or controlled via independent wheel modules via swerve drive modules or independent brushed or brushless motors. Other implementations may have advanced drives via a friction drive, where a roller wheel presses against the driven wheel, a cable or pulley drive, hydraulic or pneumatic driven wheels, or linear actuator driven wheels where the linear motion of the actuator is converted into rotary motion.

Track specific drives may also be implemented via sprocket driven tracks, dual motor track drives, or a central motor and shaft drive. Any combination of wheels and driving methods may be utilized for a particular embodiment of the robotic device described. These drive methods can be controlled via any singular or combination of control methods implemented in the on-board control logic of the robot, which includes open-loop control, where voltage is applied to the drive system with no feedback, closed-loop control where feedback is utilized from sensors to respond to environmental and robotic conditions, with sensors used for this control method including but not limited to encoders (optical or magnetic), current sensors, inertial measurement unit sensors (IMU), gyroscopic sensors, global positioning system (GPS) sensors, Light detection and ranging (LiDAR) sensors, or camera systems. Proportional-integral-derivative (PID) control loops may be implemented in any embodiment to regulate speed and position of the locomotion system, with P, I, and D tuning performed to optimize the controller for any particular embodiment.

Other advanced control methods may be implemented in any particular embodiment as well, with model predictive control and machine learning polices being implemented for autonomous robot control. Model predictive control may be implemented via any appropriate model, which may include a differential-drive kinematics model, which can then be implemented linearly, non-linearly, or via a sample-based approach to control the movement of the device via a real-time loop. Tuning may be performed in real time based on expected and actual movement of the device. Model-free reinforcement learning (RL), imitation learning (IL), or model-based RL may be implemented for the machine learning policy utilized by the robotic device for locomotion applications, or any hybrid approach (machine policy control with reinforcement learning, reinforcement learning with a safety shield for hazard avoidance, a machine policy control implementation with guided reinforcement learning). Communication and command of these drive systems may be implemented in any particular embodiment via direct microcontroller control (i.e., Arduino, STM32), which relies on pulse width modulation (PWM) or universal asynchronous receiver/transmitter (UART) signals sent to drivers. Single Board Computers (i.e., Rasberry Pi, Jetson, etc.) may be utilized for these control applications, with more processing power for machine learning and higher-level navigation embodiments.

Controller area network (CAN) bus or RS-485 may be utilized for device communication with multi-mechanism/sensor systems. Any embodiment may also employ a dedicated operating system to coordinate the drivers, sensors, and autonomous functions implemented in the embodiment.

The described locomotion system can be implemented in such a way to enable translation in the X and Y plane (the translational print directions) along with movement of the entire device in the Z direction to enable scaling of the device between layers. X and Y translational operations may be employed at the same time to allow for curved wall printing and movement along a non-straight path in the X and Y plane. Further, disclosed implementations can include further integration with specialized robotic devices for tasks like window and door installation. These ancillary robots can leverage the same principles of locomotion and control as the primary printer device, allowing for a cohesive and automated construction process.

After extrusion, material can be compacted by a compaction mechanism which can include any set of doors, a compaction armature on the outside of the device, and/or a vibration compaction device.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

1. A translational slipform device for three-dimensional (3D) printing of a structure, the device comprising:
an extruder having at least one chamber for receiving a print material;
a material supply in communication with the at least one chamber via at least one feed line;
a translational mechanism configured to translate the extruder along a printing path;
an outer formwork structure defining an outer perimeter of a wall section to be printed;
an inner formwork structure coupled to the rigid outer formwork structure, the inner formwork structured being configured to move relative to the outer formwork structure between a proximal state, wherein the inner framework structure defines a cross section of a wall element in combination with the outer formwork structure, and a remote state for creating clearance between the inner formwork structure and the cross section of a wall element; and
a plurality of internal doors disposed within the at least one chamber, each internal door configured to transition between an engaged position to direct a flow of the print material and a disengaged position to permit unobstructed flow of the print material.

2. The device of claim 1, wherein the inner formwork structure comprises at least one set of inner formwork structures extending in an X-orientation and at least one set of inner formwork structures extending in a Y-orientation, each set of inner formwork structures being movable between the proximal state and the remote states and wherein the device is configured to selectively activate the plurality of internal doors to define at least two distinct channels for the print material within the at least one chamber, thereby defining at least two wythes as wall elements of the structure when 3D printing is accomplished.

3. The device of claim 1, wherein the plurality of internal doors include at least one of swing hinge doors, tambour doors, sliding track doors, and/or doors actuated by a mechanistic path or any combination thereof.

4. The device of claim 1, further comprising a sealing mechanism associated with each internal door, the sealing mechanism configured to prevent material leakage when the internal door is in the engaged position.

5. The device of claim 1, further comprising at least two separate material reservoirs, and a material selection mechanism configured to selectively direct print material from a selected reservoir to the at least one chamber.

6. The device of claim 5, wherein the material selection mechanism comprises at least one of a selector nozzle, a turret set of nozzles, coaxial nozzles, concentric nozzles, dedicated material transmission lines, and motorized ball valves.

7. The device of claim 5, further comprising a purging system configured to flush material from the at least one feed line, the purging system comprising at least one of hardware, ducting, a purge material, and an automated control system.

8. The device of claim 1, wherein the translational mechanism comprises a locomotion system including at least one of wheels and track modules or a combination thereof.

9. The device of claim 8, wherein the locomotion system comprises at least four individually controlled wheels, each wheel configured to rotate along its central axis to facilitate translational movement in any X-Y plane vector.

10. The device of claim 1, further comprising a control system configured to manage the movement of the inner formwork structures, the activation of the plurality of internal doors, and the operation of the translational mechanism.

11. The device of claim 1, further comprising a plurality of modular formwork structure pieces configured to be interchangeably coupled with the device to form various wall geometries, including corner sections and curved wall sections.

12. The device of claim 1, further comprising a fenestration bridging mechanism configured to span an opening in the structure during printing, the fenestration bridging mechanism comprising at least one of a track extension system, a movable mass for center of gravity control, and/or a material toggling system for depositing a filler material.

13. The device of claim 12, wherein the material toggling system is configured to switch between a primary structural material and a filler material to form a temporary support within a fenestration opening.

14. The device of claim 1, further comprising a stabilization mechanism consisting of at least one of a gyroscopic device, an extendable armature, or a combination thereof.

15. The device of claim 1 further comprising a compaction mechanism configured to compact extruded material.

16. A method of printing a three-dimensional (3D) structure using a translational slipform device including:
an extruder having at least one chamber for receiving a print material;
a material supply in communication with the at least one chamber via multiple feed lines;
a translational mechanism configured to translate the extruder along a printing path;
an outer formwork structure defining an outer perimeter of a wall section to be printed;
an inner formwork structure coupled to the rigid outer formwork structure, the inner formwork structured being configured to move relative to the outer formwork structure between a proximal state, wherein the inner framework structure defines a cross section of a wall element in combination with the outer formwork structure, and a remote state for creating clearance between the inner formwork structure and the cross section of a wall element;
a plurality of internal doors disposed within the at least one chamber, each internal door configured to transition between an engaged position to direct a flow of the print material and a disengaged position to permit unobstructed flow of the print material; and
a locomotion device to cause the translational slip device to move along a predetermined path;
the method comprising:
with the inner formwork structure in the proximal state, configuring a state of the multiple feed lines to connect the material supply to selected portions of the at least one chamber;
configuring a state of the internal doors to direct material within the at least one chamber;
operating the material supply to provide material to the selected portions of the at least one chamber; and
while operating the material supply, activating the locomotion device in a first direction to move the translational slipform device and thereby print a structure along the predetermined path.

17. The method of claim 16, the method further comprising:
stopping the operating and activating steps;
moving the inner formwork structure to the remote state;
activating the locomotion device to move a predetermined distance in a second direction that is orthogonal to the first direction;
moving the inner framework structure to the proximal state;
reconfiguring a state of the multiple feed lines to connect the material supply to selected portions of the at least one chamber;
reconfiguring a state of the internal doors to direct material within the at least one chamber;
operating the material supply to provide material to the selected portions of the at least one chamber; and
while operating the material supply, activating the locomotion device in the second direction to move the translational slipform device and thereby print a structure along the predetermined path.
